(19) United States
(12) Patent Application Publication
(10) Pub. No.: US 2025/0337240 A1
(43) Pub. Date: Oct. 30, 2025

(54) SYSTEM, METHOD, AND INTERFACE FOR GOAL-ALLOCATION OF RESOURCES AND DYNAMIC MONITORING OF PROGRESS

(71) Applicant: Constellation Generation Services, LLC, Baltimore, MD (US)

(72) Inventor: Sanwar Azam Sunny, Kansas City, MO (US)

(21) Appl. No.: 19/263,077

(22) Filed: Jul. 8, 2025

Related U.S. Application Data
(63) Continuation-in-part of application No. 19/193,375, filed on Apr. 29, 2025.
Application No. 19/193,375 is a continuation of application No. 17/961,523, filed on Oct. 6, 2022, now Pat. No. 12,316,115.
Application No. 17/961,523 is a continuation of application No. 17/025,383, filed on Sep. 18, 2020, now Pat. No. 11,469,595.
(60) Provisional application No. 62/902,719, filed on Sep. 19, 2019.

(51) Int. Cl. H02J 3/00; G06Q 30/0201; G06Q 50/06

(52) U.S. Cl. CPC H02J 3/003; G06Q 30/0206; H02J 3/004; G06Q 50/06; H02J 2300/10; H02J 2300/20; H02J 2300/40

(57) ABSTRACT

System, method, and interface for visualized resource allocation and algorithms for the reallocation of resources to achieve a goal. The system analyses an initial state of resource allocation, a cost function for undesirable resources, and a set of potential incremental improvements, each with an associated cost, and determines a step-wise path of applying the incremental improvements to achieve an ultimate resource-allocation goal in an economically feasible way. Simultaneously, a user interface depicts the state of the allocation at the beginning, at the end, and along the path, allowing an intuitive understanding of how the goal will be achieved.

### BACKGROUND

This application is a continuation-in-part of U.S. application Ser. No. 19/193,375, which is a continuation of U.S. application Ser. No. 17/961,523, filed Oct. 6, 2022, now U.S. Pat. No. 12,316,115, which is a continuation of U.S. application Ser. No. 17/025,383, filed Sep. 18, 2020, now U.S. Pat. No. 11,469,595, which claims the benefit of U.S. Provisional Application No. 62/902,719, filed Sep. 19, 2019, herein incorporated by reference in their entireties.

### BACKGROUND

### 1. Field

Broadly, this application relates to the field of resource consumption encoding, classification and computation, and visualization of that activity and resulting outcomes. More particularly, this application includes an interface and algorithm useful for reallocating energy production and consumption among various energy sources to reduce ecologically harmful emissions.

### 2. Related Art

In typical discussions related to resource allocation, politically charged discussions of unseen outcomes and impacts can deter corrective action. Current resource allocation analysis and visualization system present convoluted and difficult to understand presentations that confuse the audience. Previously, discussions of how to reallocate energy production have been mired in an ideologically biased stalemate. As such, what is needed is an objective, mathematically and economically sound technique for both making energy production allocation determinations and visualizing these determinations in such a way as to convey their efficacy to consumers, voters, and governmental officials.

### SUMMARY

It is to be understood that both the following general description and the following detailed description are exemplary and explanatory only and are not restrictive.

Methods, systems, and apparatuses are described for providing for an interface for visualize resource allocation and algorithms for the reallocation of resources to achieve a goal.

In a first embodiment, disclosed is one or more non-transitory computer-readable storage media storing computer-executable instructions that perform a method of resource allocation of resources to achieve a goal and dynamic monitoring of progress, wherein the computer-executable instructions are executed by at least one processing element to perform the steps of receiving source data indicative of an amount of energy from at least one energy source, receiving an indication of an amount of energy used by at least one energy consumption process, determining an amount of energy wasted by the at least one energy consumption process, determining an allocation of the at least one energy source based at least in part on a maximization of used energy and a minimization of wasted energy, and generating a visualization representing an amount of the at least one energy source used, the amount of energy used in the at least one energy consumption process, and the amount of energy wasted in the at least one energy consumption process.

In a second embodiment, disclosed is a method of resource allocation and dynamic monitoring of progress, wherein the method comprises the steps of receiving energy source data indicative of an amount of energy from at least one energy source, receiving energy consumption data indicative of an amount of energy consumed from at least one energy consumption process, determine if the at least one energy source is benign or a harmful, determine an amount of wasted energy in the at least one energy consumption process, determine an allocation of the resources based at least in part on a maximization of inflow from the benign source and a minimization of inflow from the harmful source, generate a first visualization representing the amount of energy received from the at least one energy source, the amount of energy used in the at least one energy consumption process, and the amount of wasted energy in the at least one energy consumption process, and generate a second visualization presenting the allocation of the resources.

In a third embodiment, disclosed is one or more non-transitory computer-readable storage media storing computer-executable instructions that perform a method of resource allocation and dynamic monitoring of progress, wherein the computer-executable instructions are executed by at least one processing element to perform the steps of receiving energy source data indicative of an amount of energy from at least one energy source, receiving energy consumption data indicative of an amount of energy consumed from at least one energy consumption process, determining if the at least one energy source is benign or a harmful, determining an amount of wasted energy in the at least one energy consumption process, determine an allocation of the resources based at least in part on a maximization of inflow from the benign source, a maximization of used energy, a minimization of inflow from the harmful source, and minimization of wasted energy, generate a first visualization representing the amount of energy received from the at least one energy source, the amount of energy used in the at least one energy consumption process, and the amount of energy wasted in the at least one energy consumption process, and generate a second visualization presenting the allocation of the at least one energy source.

This summary is not intended to identify critical or essential features of the disclosure, but merely to summarize certain features and variations thereof. Other details and features will be described in the sections that follow.

### BRIEF DESCRIPTION OF THE DRAWINGS

In order to provide understanding techniques described, the figures provide non-limiting examples in accordance with one or more implementations of the present disclosure, in which:

FIG. 1 shows an hardware platform;

FIG. 2 shows example display of a user device presenting a three-dimensional data visualization in accordance one or more implementations of the present disclosure;

FIGS. 3A-3E show example view of the user interface of FIG. 2;

FIGS. 4-7 show example relational queries;

FIG. 8 shows example graphs of emissions of carbon dioxide over time;

FIG. 9 shows an example of one sector-type category of a user interface;

FIG. 10 shows an example of the same sector-type activity as FIG. 9 of the user interface of FIG. 2 decomposed instead into wasted energy and utilized energy;

FIG. 11 shows an example starting state of resource allocation in a system;

FIG. 12 shows an final state of resource allocation in the system after reallocation;

FIGS. 13A-13B show example flowchart of an example method;

FIGS. 14A-14B show example changes in the solution entities for the exemplary resource allocation process of FIGS. 11 and 12;

FIGS. 15A-15B show example changes in the transformation waste ratios for the exemplary resource allocation process of FIGS. 11 and 12;

FIGS. 16A-16B show example visual illustrations of a process associated with meeting goals for the example resource allocation process of FIGS. 11 and 11;

FIGS. 17A-17B show example marginal abatement cost curves;

FIG. 18 shows an example direct data entry method for accessing the data associated with the cube;

FIGS. 19-27 show example user interfaces for inputting data and displaying outputs of the system;

FIG. 28 shows an example topographical map for presenting data;

FIG. 29 shows an example hybrid visual/numeric user interface for a user's visualization of the goals and progress of the resource allocation process;

FIG. 30 shows example cubes and cubelets for visualizing energy source consumption;

FIG. 31 shows an example user interface providing selections to the user;

FIG. 32 shows an example user interface that can be automatically updated to reflect new goals set by an authorized user;

FIG. 33 shows an example optimization flow;

FIG. 34 shows example components of consumption data;

FIG. 35 shows an example renewable energy supply graph;

FIG. 36 shows an example renewable energy supply graph;

FIG. 37 shows an example renewable energy supply graph;

FIG. 38 shows an example renewable energy supply graph;

FIG. 39 shows an example renewable energy supply graph;

FIG. 40 shows example S-curves;

FIG. 41 shows example;

FIG. 42 shows a flowchart of an example method; and

FIG. 43 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, the methods and systems may take the form of a computer program product on a computer-readable storage medium (non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a computer (e.g., a special purpose computer), or other programmable data processing apparatus to produce a machine, such that the processor-executable instructions which execute on the computer or other programmable data processing apparatus create a device for implementing the functions specified in the flowchart block or blocks.

This detailed description may refer to a given entity performing some action. It should be understood that this language may in some cases mean that a system (e.g., a computer) owned and/or controlled by the given entity is actually performing the action.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The method steps recited throughout this disclosure may be combined, omitted, rearranged, or otherwise reorganized with any of the figures presented herein and are not intend to be limited to the four corners of each sheet presented.

In an embodiment, an interface for visualize resource allocation and algorithms for the reallocation of resources to achieve a goal are described. By visualizing the starting state, the ending state, and the transition between them, stakeholders can more easily grasp the path of a transition to a less ecologically harmful energy source balance. At the same time, the algorithm determines not merely the best final allocation of those energy sources, but an incremental path of the transition that is technologically and economically feasible.

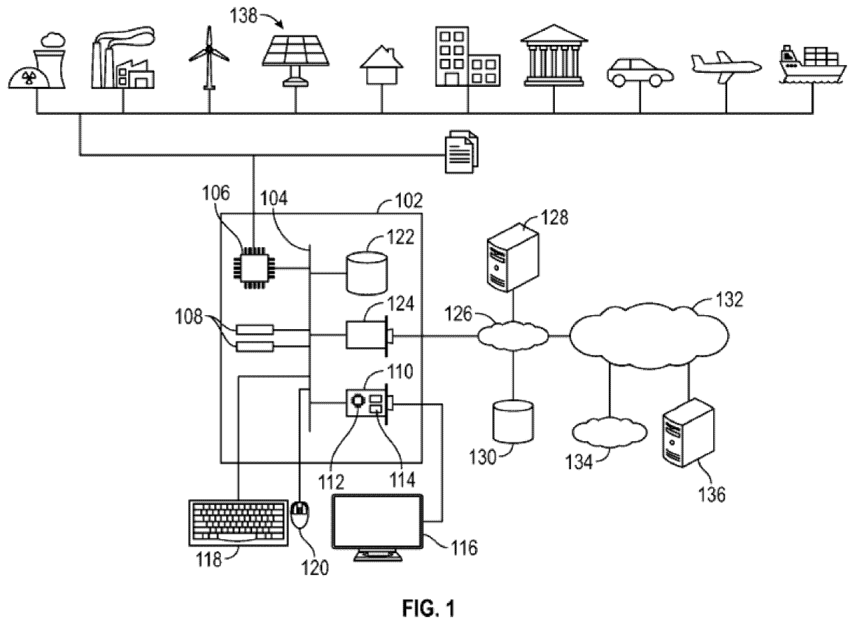

FIG. 1 shows an example hardware platform for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is a processor 112 and GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media and may be internally installed in computer 102 or externally and removeably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

Also depicted in FIG. 1 are a variety of data sources 138 used for classification, assignment of energy sources to an entity and/or region, timescale, etc. by applying appropriate unit conversions (e.g., between Watts, BTU, joules, kWh, volts, gallons, tons, ktoe (kilotonne of oil equivalent), therms, cubic feet, parts per million). Data may be stored in a database accessible over a network or locally. Real-time and/or live data can also be continuously received from a network device or data acquisition machine; similarly, historical or archival data can be accessed from a database, input via document ingestion, or directly entered by a user or another entity on user's behalf. In some exemplary embodiments, the data sources 138 may be energy sources generating energy such as through nuclear, coal, wind, and solar power. The data sources 138 may also be energy consumption through public and private social infrastructure and transportation. In some embodiments, the data sources 138 may be analyzed and displayed along with the analysis as described in embodiments below.

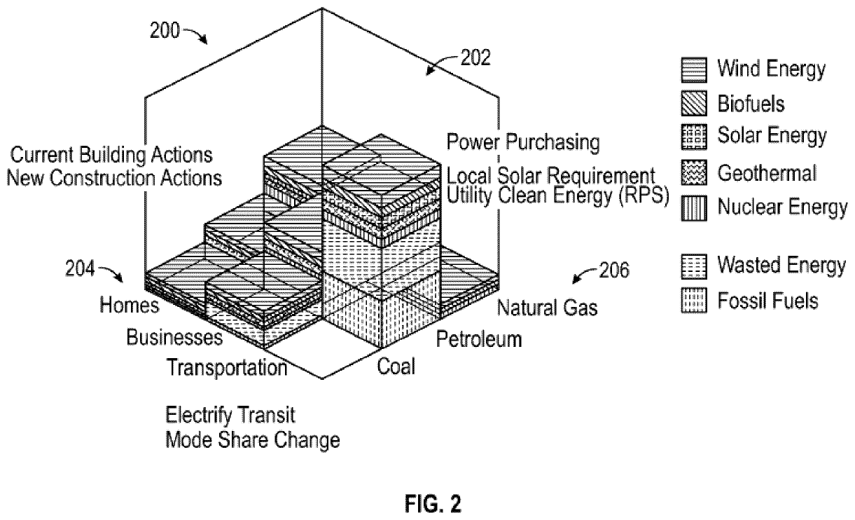

FIG. 2 shows an example display of a user interface in accordance with embodiments of the invention is depicted and referred to generally by reference numeral 200. As shown, the user interface 200 depicts a multidimensional data visualization 202 ideal for analyzing breakdowns of a whole from the data sources 138 along multiple axes simultaneously. As shown, for example, the whole of a city's greenhouse-gas-generating energy consumption is shown, broken down on a first axis, let's say J, by a consuming sector 204 of a carbon-based fuel (for example, “residential,” “business,” and “transportation”) and on a second axis, let's say K, by the particular type of carbon-based fuel 206 (for example, “coal,” “petroleum,” and “natural gas”). Thus, for example, it can readily be seen that little or no coal goes towards powering transportation. Instead, by far the largest share of carbon-based fuel used in transportation is petroleum-based. In some embodiments, the amount of greenhouse gasses generated by each sector-type category can be depicted instead of the amount of energy consumed.

Also shown in the user interface 200 is the amount of energy consumed 208 in each sector-type category that is wasted. The source of the wastage may differ in different categories. The proportional amount may be visualized by the height of the sector-type category along the third axis. For example, the wastage in the transportation-petroleum category may include energy consumed in transporting crude oil to refineries, energy consumed in refining the crude oil into gasoline and diesel fuel, and energy consumed in transporting the fuels to fueling stations. The transportation-petroleum category has relatively low impact from wind, biofuel, solar, geothermal, and nuclear energies. Evaluating the data sources 138 in this way, when determining how best to reduce greenhouse gas emissions, the indirect contributions of each sector-type can be taken into account as well as the direct contributions.

In some embodiments, the first and second axis of the visualization display the data source, or energy sources, coal, petroleum, and natural gas and the energy transitions or consumption processes: homes, business, and transportation, as displayed. In some embodiments the energy sources may be wind, solar, water, or any other method of generating energy and the consumption may be more detailed, or sub-categories, such as airplanes, automobiles, and boats. Further, the sub-categories may be provided in drill-down visualization methods described below.

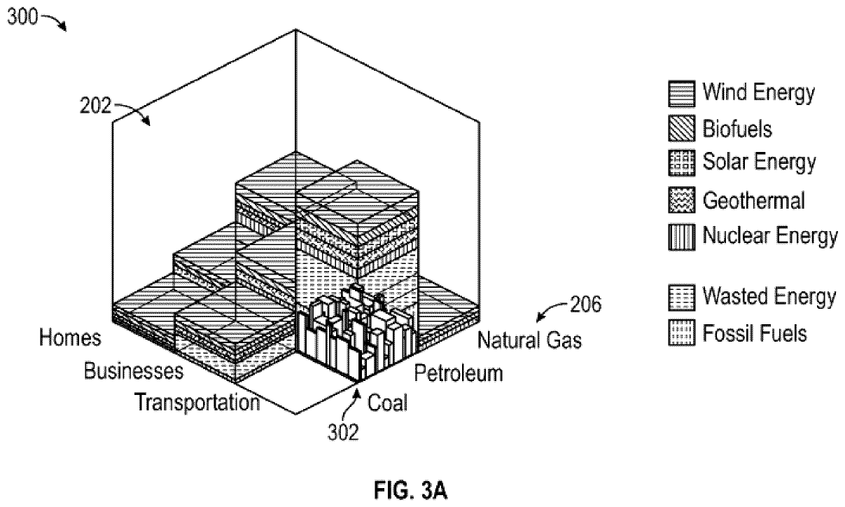

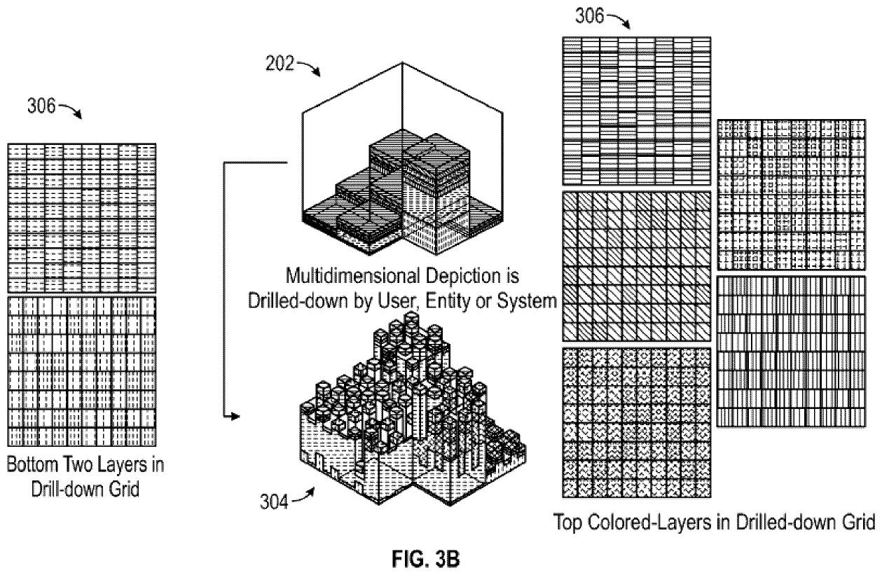

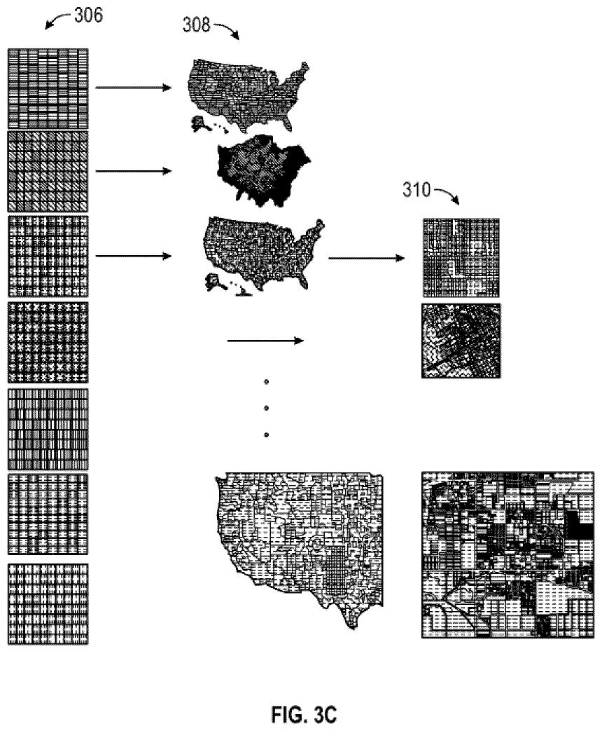

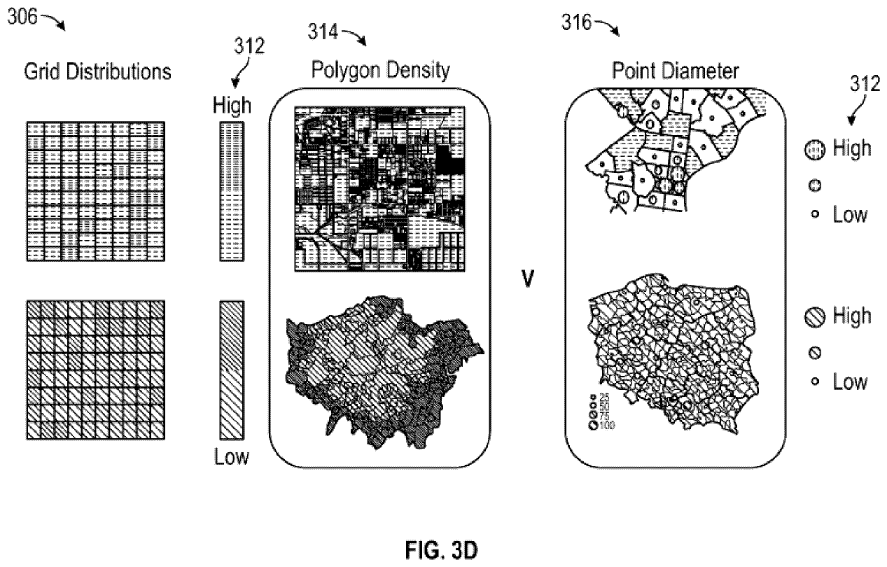

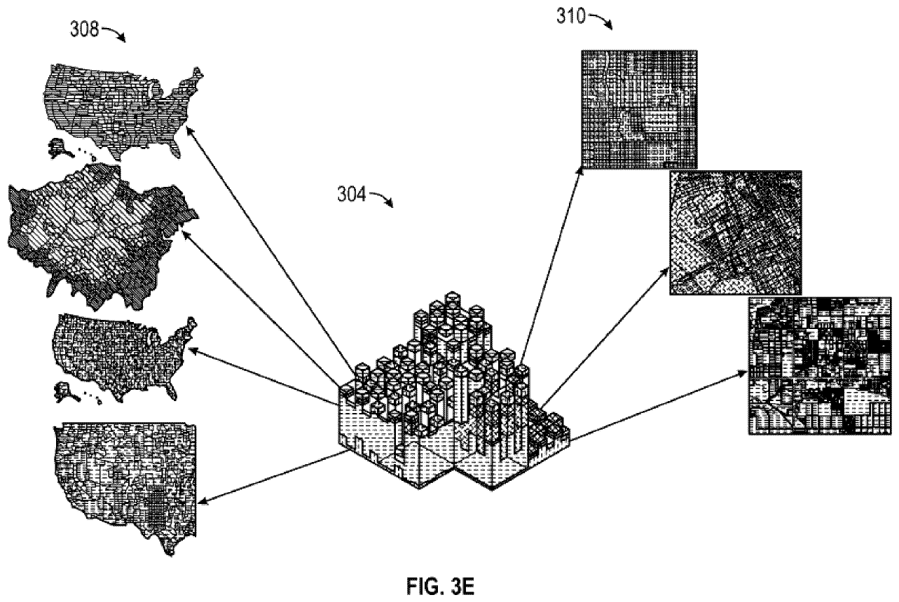

FIG. 3A shows an example second view of the user interface is depicted and referred to generally by reference numeral 300. FIG. 3A shows a drill-down view 302 of a particular sector-type category. For example, the transportation-petroleum category might be further broken down into subcategories, Xⱼ, along the transportation axis into “ships,” “cars,” “motorcycles,” “trains,” “planes,” “trucking,” and so forth, while the petroleum axis might be broken down into, for example, “residual oil,” “motor gasoline,” “jet fuel,” “diesel,” and so forth as Yₖ. Breaking down the axis into further sub-categories, or subsets, allows a user to visualized how each individual resource is consumed on the same data display.

In some embodiments, the breakdown of a particular axis is constant among the various categories and sub-categories of the other axis. Thus, for example, a “home heating oil” category would appear as a sub-category for petroleum even in the intersection with “transportation” where home heating oil is used little or not at all. In other embodiments, drill-down view 302 filters out inapplicable categories such that a “jet fuel” category is present in the drill-down view of the intersection of “transportation” and “petroleum” but not in the drill-down view of the intersection of “home” and “petroleum.” Similarly, in such an environment, “home heating oil” would be a subcategory of petroleum in the drill-down view of its intersection with “home” but not in the drill-down view of its intersection with “transportation.” Drill-downs are possible for a particular sector-type category, across an entire sector or category, or within a particular layer. This can be represented using relational algebra syntax as described below.

After classification of resource type Yₖ, time, t, usage location, p and entity S, the visual can be decomposed into more granular representations according to some standardized attribute (i.e. after conversion to the same or comparable physical units), such as distributions in terms of quantity, amount or density, as depicted in FIG. 3B. The standardization allows for relative comparison such that a user may easily visualize the usage and waste of the resources for each resource/energy consumption process. FIG. 3B depicts the cube visualization on the user interface 200 from above along with a drilled-down visualization 304. As shown, the top-view of the bottom layers of each individual layer can be converted to a two-dimensional x-y grid, where the values are laid across a spectrum 306. As shown in FIGS. 3B-3E, the spectrum 306 may be provide texture. It should also be contemplated that the spectrum 306 may be a color spectrum, such as with lighter colors signifying lower values, and darker colors as higher values. The representation may also present textures, shading, lines, dots, or any other method of displaying various sections. For example, shades of color may be equivalent to height in the z-direction in the three-dimensional representation. The spectrum 306 may present a two-dimensional data visualization that may be easier to understand when many inputs are compared. Thus, the exemplary spectrum 306 provides a quick and easily understandable magnitude to the visualizations for a particular cross section of the graph.

Given three tables T₁, T₂, T₃ corresponding to “residential home” (J=1), “commercial and industrial business” (J=2) and transportation (J=3) sectors, with each table containing information about consumption (in a given sector) of different types of energy source Yₖ (synonymous to A_{i . . . N} and B_{i . . . M}) distributed over geographic regions, p (for countries, states, cities, zipcodes) and time. t (for years, months, days, seconds), relational algebra operations can be used to represent and various input information from T₁, T₂, T₃ for use in interface visualization, and/or optimization algorithm introduced later.

The system can aggregate J=1,2,3 sheets to make a treemap (302) where only environmentally harmful energy sources are shown. By eliminating unnecessary data columns using the operation of projection, filtering for this data can be performed:

$${\prod }_{K , Y , J = 1} ( {T}_{1} ) \qquad ( 1 )$$

$${\prod }_{K , Y , J = 2} ( {T}_{2} )$$

$${\prod }_{K , Y , J = 3} ( {T}_{3} )$$

where Tⱼ is the table corresponding to the sheet J=1. Now, renaming the column “J=j” to “J” for all j=1,2,3:

$${P}_{J / J = 1} ( {T}_{1} ) \qquad ( 2 )$$

$${P}_{J / J = 2} ( {T}_{2} )$$

$${P}_{J / J = 3} ( {T}_{3} )$$

Finally, a new table is created with columns “K”, “Y”, “J”, etc. and whose rows are obtained by summing “J” values of corresponding rows of T₁, T₂, T₃ (note that rows of T₁, T₂, T₃ differ only in the “J”th column):

$$T = {\sum }_{J} ( {T}_{1} , {T}_{2} , {T}_{3} ) \qquad ( 3 )$$

Here Σ_{J} (T₁, T₂, T₃) denotes the row-wise summation table of T₁, T₂, T₃.

The system can aggregate J=1,2,3 for a particular geographic region, p or a time interval, t. For this, T₁, T₂, T₃ depend on an asset R (e.g., facility, home/building, vehicle, solution, load, etc.), considered earlier as dots on map (e.g., point diameter 316), or shape boundary (e.g., polygons 314) and time t, where t is given in one of the formats: “year”, “year” /“month”, “year” /“month” /“day” or “year” /“month” /“day” /“HH: MM: SS”. Therefore, the above mentioned aggregation may be performed at the level of each geographic region represented by the topographical map 308 and for every moment/interval of time.

The above-described aggregation may be performed for p=NYC and on the day t=2019 Mar. 21. Steps (1) and (2) may be repeated for tables T₁(R, t), T₂(R, t), T₃(R, t), where R runs through all assets whose geographic coordinates gis(x, y) are in p=NYC. Finally, the following summation operation is performed:

$${T}_{1} ( R , t ) := {\sum }_{J} ( {T}_{1} ( R , t ) , {T}_{2} ( R , t ) , {T}_{3} ( R , t ) ) , \qquad ( 4 )$$

and then one more summation over all assets R that are in p=NYC:

$${T}_{1} ( R , t ) := {\sum }_{J} ( \{ {T}_{1} ( R , t ) : R is such that gis ( R ) ∈ p \} ) . \qquad ( 5 )$$

In the last formula, the summation operation is applied to tables T(R, t) along the column J. The resulting tables may be aggregated for p=NYC over a time interval, say from t₁=2019 Jan. 1 to t₂=2019 Jun. 30. The system then sums tables (5) (for appropriate t's, where t runs through all days between t₁ and t₂.):

$$T ( p \vert {t}_{1} , {t}_{2} \vert ) := {\sum }_{J} ( \{ {T}_{1} ( p , t ) : {t}_{1} \leq t \leq {t}_{2} \} ) . \qquad ( 6 )$$

The system can search by extent or text identifier of a region, such as any given p (say New York City). In order to do this aggregation just at the level of one city or region p, the earlier steps can be repeated for T₁(R), T₂(R), T₃(R) for all assets R whose coordinates gis(x,y) belong top across different energy types, as shown in the drill down visualization 304. Here Tⱼ(R) is the table of the asset R corresponding to the sector j=1,2,3; one can obtain it by summing Tj(R,t) which was introduced earlier, over −∞<t<+∞ where t can vary from the first to the last time record.

$${T}_{1} ( R ) = {\sum }_{J = 1 , 1 , ... , 9} ( \{ {T}_{1} ( R , t ) : - ∞ < t < ∞ \} ) , \qquad ( 7 )$$

$${T}_{2} ( R ) = {\sum }_{J = 2 , 1 , ... , 8 , 17} ( \{ {T}_{2} ( R , t ) : - ∞ < t < ∞ \} ) ,$$

$${T}_{3} ( R ) = {\sum }_{J = 3 , 1 , ... , 8} ( \{ {T}_{3} ( R , t ) : - ∞ < t < ∞ \} ) ,$$

where Σ_{il, . . . , id}({T₁(R, t): −∞<t<∞}) denotes the table obtained from tables Tj (R, t) by summing them column-wise along columns i_{l, . . . ,}i_{d}.

Applying steps (1) and (2) to T₁(R), T₂(R), T₃(R) the system obtains a table T(R):=Σ_{J}(T)₁(R), T₂(R), T₃(R)), which is the analogue of (3) for an individual asset R, which can be vehicles, factories, power plants, buildings etc. Finally, performing the summation operation over all assets R whose coordinates gis(x, y) are in p:

$$T ( p ) = {\sum }_{J} ( \{ T ( R ) : R is such that gis ( R ) ∈ p \} ) . \qquad ( 8 )$$

To filter and conduct an aggregation from 1 for a given t (say t=2007), the system takes tables Tⱼ(R,t), j=1,2,3, and aggregates the result over all R, and not confined to just one p:

$$T ( t ) := {\sum }_{J} ( \{ T ( R , t ) : R \} ) . \qquad ( 9 )$$

To aggregate for all regions p, for a time internal, such as from t₁=2010 to t₂=2020, it will be done similar to [t₁, t₂] and for a given city/region p, aggregated over all p:

$$T ( \vert {t}_{1} , {t}_{2} \vert ) := {\sum }_{J} ( \{ T ( t ) : {t}_{1} \leq t \leq {t}_{2} \} ) . \qquad ( 10 )$$

Within these, it is also possible filter only for a given sub-category, X=4 (cooking) and fuel type, Y=21 (K=B=2; kerosene) at J=2, but from t₁=2010 to t₂=2015. The row Y=21 (kerosene) of tables T₂(R, t) allows extraction of only this row using selection operation:

$${σ}_{y = 21} ( {T}_{2} ( R , t ) ) . \qquad ( 11 )$$

The table T₂(R, t) has only one row (and same columns as before) and given the specific interest in the column X=4 (cooking) the system removes other columns via projection operation:

$${\prod }_{K , Y , X = 4} ( {T}_{2} ( R , t ) ) . \qquad ( 12 )$$

The only place where tables T₂(R, t) differ (for different R and t) is the value in the column X=4 (in the unique row Y=21). To make aggregation over R:

$${T}_{2} ( t ) := {\sum }_{X = 4} ( \{ {T}_{2} ( R , t ) : R \} ) , \qquad ( 13 )$$

where summation is along column X=4 (in (9) this was column J). To extract information over a time period [t₁, t₂], the system performs the following operation:

$${T}_{2} ( \vert {t}_{1} , {t}_{2} \vert ) := {\sum }_{X = 4} ( \{ {T}_{2} ( R , t ) : {t}_{1} \leq t \leq {t}_{2} \} ) , \qquad ( 14 )$$

where the summation is along column X=4.

As shown in FIG. 3C, the arbitrary positioning of the grid of FIG. 3B could be overlaid on more understandable geospatial grids, such as on topographical maps 308, or neighborhood blocks 310. Users can filter by type, such as flow types (input, output, total, wasted, or remaining), transformation flows (input, output, wasted, or consumed); or per-user flows of any type. For example, the country can be broken down into states, cities, counties, or even further. Each of these locations may be analyzed based on resource consumption in each category as described above. Using notation from relational algebra, we can consider tables which store these values in and conducting operations to extract necessary information.

Any identified entity and its data attributes can be further explained or visualized in multiple different ways. For example, the visualization may be provided in the grid distributions as described above or either as polygons of a predetermined shape, or as the diameter of a sphere, circle, or other shape which is centered at the centroid of a uniquely identified location or entity, as shown in FIG. 3D. The grid distributions, or spectrum 306 may be shown with a relative low-high indicator 312. In some embodiments, the low-high indicator may be colored to show the difference from low to high. Further, the grid may be broken down into more defined polygons 314. Further still, the relative magnitude of each region may be represented by a relative size of a shape, for example the size of the circles in the point diameter map 316. Any shapes and combination of shapes, textures, colors, and maps may be contemplated for visualization of data.

As shown in FIG. 3E, embodiments of the invention may store polylines, features, feature-sets and feature-collections for each item, data point or element, searchable by extents. The user interface 200, as shown in FIG. 3E, depicts the drilled-down visualization 304 along with the topographical maps 308 and the more reduced geographical data set down to neighborhood blocks 310. This could be stored in multiple framework, datatypes, vectors, and languages such as JSON etc. This enables the user and other entities, such as regulators or solution providers, to more efficiently locate consumption patterns and evaluate deployment, or allocation of resources, to meet targets and goals, according to optimization principles discussed here, or other methodologies.

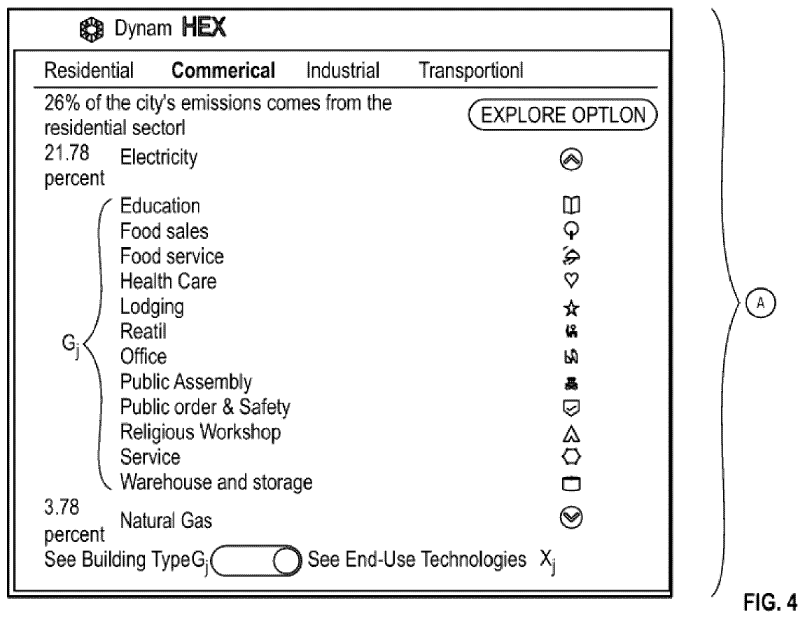

Exemplary queries are described below. FIGS. 4-7 show example embodiments of the queries described below. FIG. 4 shows an example of at least part of an interface where different J sectors are divided into Gⱼ subsectors, with options to switch to Xⱼ end-use types. These filters invoke the queries where different Yₖ energy types can be used to estimate emissions and their proportions (percentages) as shown in Query 3 and Query 4 below.

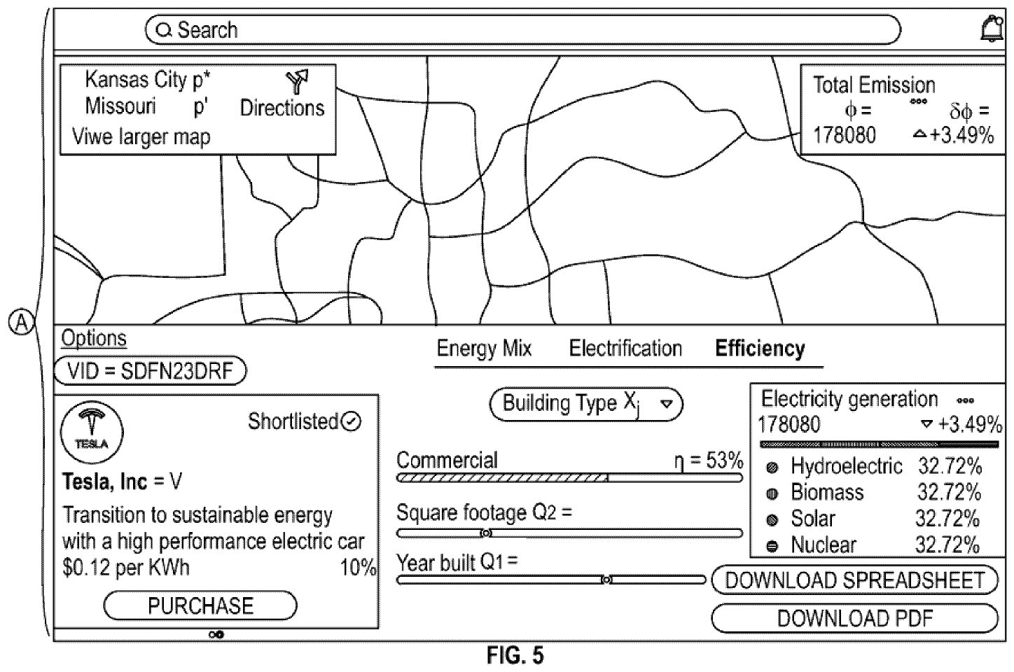

FIG. 5 shows an example of at least part of an interface where geospatial data details are visualized for a given city or location, p and given time t. The interface helps user select a set of R's for any given restrictions, such as Q (Query 1), η (Query 2) by using emissions factors (Query 6).

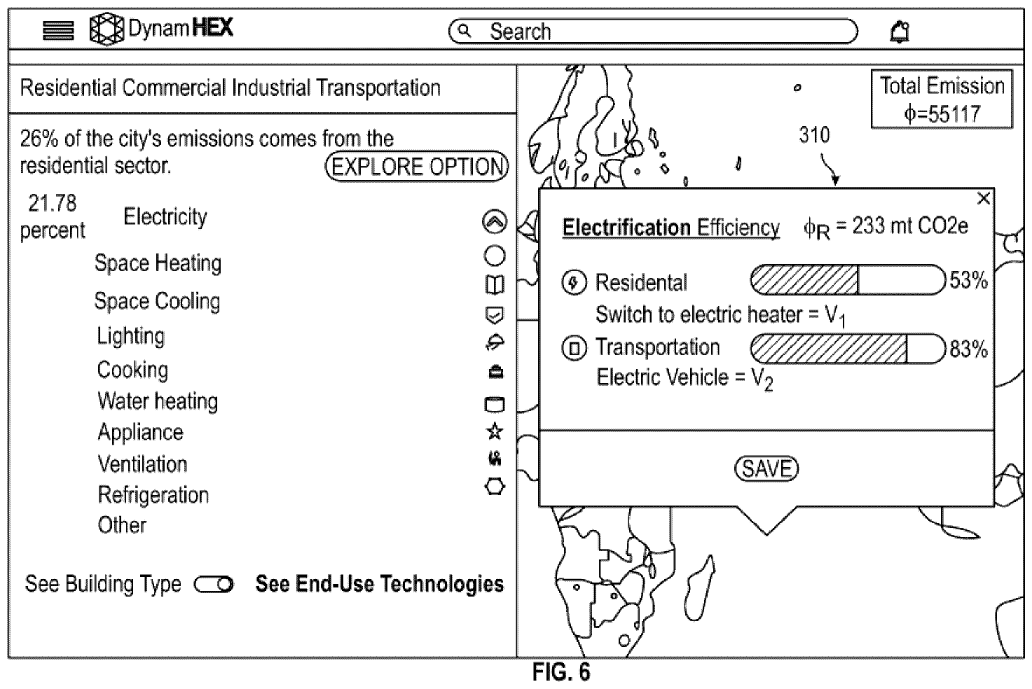

FIG. 6 shows how different elements of the geospatial map can visualize different data entities for each R (shown in Query 5 and Query 8 below).

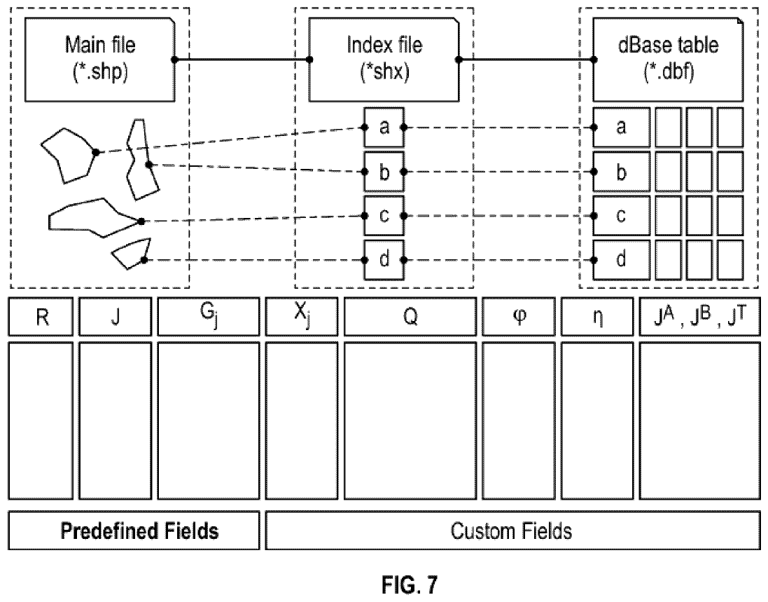

FIG. 7 depicts tabular formats of storing geospatial information at the R^{th} level and aggregating to the regional p^{th} level.

### Query 1

The queries descried above and below, are shown in FIGS. 4-7 described above. The system can extract a set of assets R (e.g., facilities, homes/buildings, vehicles, solutions, loads, etc.) from the table J1 (residential sector) that are built in the year Q1=Q1_{b} (say Q1_{b}=1977) and have square footage between Q2ₘᵢₙ and Q2ₘₐₓ (say Q2ₘᵢₙ=1200 and Q2ₘₐₓ=1300). By applying the operation of selection of rows with a specified year and square footage:

$${σ}_{Qmin \leq Q 2 \leq Q 2 max} {σ}_{Q 1 = Q 1 b} ( J 1 ) . \qquad ( 15 )$$

The table J1 now contains only those rows with year Q1_{b} and whose square footage is between Q2min and Q2max. If a user uses the system to extract only the ID numbers of those assets, this can be done by projecting everything on the corresponding column:

$${\prod }_{R} ( J 1 ) . \qquad ( 16 )$$

Given a table of unique identifiers (IDs) of these assets—the number of which is given by the number of rows in this new table of IDs, such as:

J1

| | | | all other |
|---|---|---|---|
| R | Q1 | Q2 | columns |
| R1 | 1960 | 1494 | . . . |
| R2 | 1965 | 1076 | . . . |
| R3 | 1977 | 1243 | . . . |
| R4 | 1977 | 1802 | . . . |

After applying the first selection (e.g., assets with an appropriate year) we obtain:

$${σ}_{Q 1 = 1977} ( J 1 )$$

| | | | all other |
|---|---|---|---|
| R | Q1 | Q2 | columns |
| R3 | 1977 | 1243 | . . . |
| R4 | 1977 | 1802 | . . . |

Applying the second selection operation, we are left with one row only:

$${σ}_{1200 \leq Q 2 \leq 1300} {σ}_{Q 1 = 1977} ( J 1 )$$

| | | | all other |
|---|---|---|---|
| R | Q1 | Q2 | columns |
| R3 | 1977 | 1243 | . . . |

Finally we project to the column of IDs:

$${\prod }_{R} {σ}_{1200 \leq Q 2 \leq 1300} {σ}_{Q 1 = 1977} ( J 1 )$$

There is only one asset that meets the two requirements. Any set of parameters can have similar operations conducted, under different conditions and requirements, both on the interface as well as intermediate steps before visualization.

### Query 2

Similarly to the above relational query 1, the system can also filter out assets (e.g. in the residential sector J1) whose aggregate efficiency factor η is at least 0.6 by applying the selection operation to the corresponding column:

$${σ}_{η ≧ 0.6} ( J 1 ) \qquad ( 17 )$$

After this operation the table J1 contains only those assets whose efficiency factor satisfies η≥0.6, as shown:

J1

| | | all other |
|---|---|---|
| R | η | columns |
| R1 | 0.34 | . . . |
| R2 | 0.91 | . . . |
| R3 | 0.45 | . . . |
| R4 | 0.65 | . . . |

only R2 and R4 satisfy the condition η≥0.6. Thus, applying further queries to this table, the resulting table is:

$${σ}_{η ≧ 0.6} ( J 1 )$$

| | | all other |
|---|---|---|
| R | η | columns |
| R2 | 0.91 | . . . |
| R4 | 0.65 | . . . |

### Query 3

The system can compute by summing emissions Φ, for specific Xⱼ by extracting rows with Xⱼ=1 in a given J and return the total emission Φ_{J,Xj=1}, and then represent this as a fraction of J or total Js. This is achieved by computing a fraction of Φ_{J,Xj=1} and Φ_{y} and a fraction of Q_{J,Xj=1} and Σ_{J} Φ_{J} in the following ways: For each asset R (e.g., facility, home/building, vehicle, solution, load, etc.), the system can associate the corresponding aggregate emission Φ(R) and store it in the corresponding column. To compute the total emissions of all assets in the residential sector J1 that have a non-zero consumption through sub-sector Xⱼ, the system selects those rows in the table J₁ that have 1 in the column Xⱼ and computes the sum of values in the column ϕ of the modified table:

$${SUM}_{ϕ} ( {σ}_{Xj = 1} ( J 1 ) ) , \qquad ( 18 )$$

where SUM_{c}(T) is the relational algebra operation of the summation of the values in the corresponding column C of the table T. To compute the ratio of emissions from assets in J1 that have nontrivial Xⱼ consumption to the total emission in J1, the system may perform the query:

$$\frac{{SUM}_{ϕ} ( {σ}_{Xj = 1} ( J 1 ) )}{{SUM}_{ϕ} ( J 1 )} , \qquad ( 19 )$$

as well as the ratio of the above numerator to the total emission across all sectors,

$$\frac{{SUM}_{ϕ} ( {σ}_{Xj = 1} ( J 1 ) )}{{SUM}_{ϕ} ( J 1 ) + {SUM}_{ϕ} ( J 2 ) + {SUM}_{ϕ} ( J 3 ) + {SUM}_{ϕ} ( J 4 )} , \qquad ( 20 )$$

Using a particular example, the system operator functions as follows:

J1

| | | | all other |
|---|---|---|---|
| R | Xⱼ | Φ | columns |
| R1 | 0 | 230 | . . . |
| R2 | 0 | 120 | . . . |
| R3 | 1 | 430 | . . . |
| R4 | 1 | 279 | . . . |

430+279=709, since only R3 and R4 have Xi=1, where the ratio equals 66%

$$\frac{430 + 279}{230 + 120 + 430 + 279} = \frac{730}{1059} \approx 0.66 . \qquad ( 21 )$$

Given total emissions in other sectors, the ratio is computed analogously.

As an example, the impact of emissions Φ=Φ(t) may be modeled onto the concentration of Λ=Λ(t) of CO₂ in the atmosphere. As such, Φ(t) may comprise, at any given movement of time t, the speed of the change of the carbon concentration, wherein

$$\frac{d Λ ( t )}{dt} = Φ ( t ) .$$

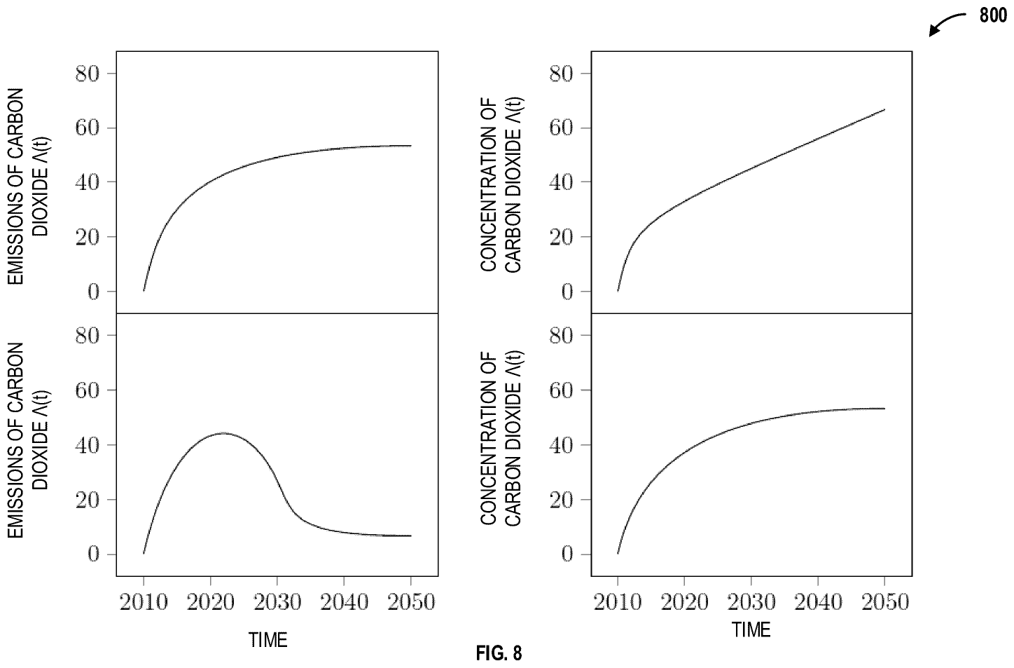

As an example, at a reference moment of time to, the carbon concentration may comprise Λ(t), t>t₀. Thus, the function Λ may be expressed as

$$Λ ( t ) = {Λ}_{0} + {\int }_{{t}_{0}}^{t} Φ ( s ) ds ,$$

wherein Φ may be continuously differentiable. In an example, based on a numerical integration of the function Φ, approximate values for Λ(t), t>t₀ may be determined. Λ(t₀)=Λ₀ may comprise the concentration of CO₂ at t₀. The function Λ(t) may be utilized to calculate the carbon concentration at any time t>t₀. As an example, as shown in FIG. 8, even if emissions stabilize, the concentration of CO₂ may continue to increase. Given a collection V of different solutions/policies (e.g., V₁, V₂, V₃, V₄, V₅), it can be distinguished between solutions that increase emissions, solutions that have no changes, or solutions that reduce emissions. For example, solutions may comprise implementations associated with one or more resources (e.g., energy sources or non-energy sources). As an example, there is no difference between solutions ν ∈ V that bring emissions having positive Φᵥ>0 and solutions that reduce emissions having negative Φᵥ<0. Emissions from each solution may be time-dependent, such that Φᵥ(t) for ν ∈ V, wherein the total emissions may be expressed as

$$Φ ( t ) = {\sum }_{v ∈ V} {Φ}_{v} ( t ) ,$$

and thus,

$$\frac{d Λ}{dt} ( t ) = Φ ( t ) = {\sum }_{v ∈ V} {Φ}_{v} ( t ) .$$

To obtain a solution Λ(t), t>t0, individual components Φᵥ(t) that contribute to Φ(t) may be integrated separately, resulting in

$$Λ ( t ) = {Λ}_{0} + {\int }_{{t}_{0}}^{t} Φ ( s ) d s = {Λ}_{0} + {\sum }_{v ∈ V} {\int }_{{t}_{0}}^{t} {Φ}_{v} ( s ) d s ,$$

wherein the sum over ν ∈ V may be replaced with an integral form.

### Query 4

The system may compute the total emissions of all assets (e.g., facilities, homes/buildings, vehicles, solutions, loads, etc.) in a specific subsector or subtype Gⱼ (say G=Duplex, Single—family, etc.) of the residential sector J1. By first extracting all rows with G=Gⱼ using selection operation, the system can compute the sum of values in the column Φ of the new table:

$$S U {M}_{ϕ} ( {σ}_{G = G j} ( J 1 ) ) , \qquad ( 22 )$$

The system further computes the fraction of emissions of assets from the subsector Gⱼ relative to the total emission in J1,

$$\frac{S U {M}_{ϕ} ( {σ}_{G = Gj} ( J 1 ) )}{S U {M}_{ϕ} ( J 1 )} , \qquad ( 23 )$$

and relative to the total emission across all sectors J1, J2, J3, J4,

$$\frac{{SUM}_{ϕ} ( {σ}_{G = G j} ( J 1 ) )}{S U {M}_{ϕ} ( J 1 ) + S U {M}_{ϕ} ( J 2 ) + {SUM}_{ϕ} ( J 3 ) + S U {M}_{ϕ} ( J 4 )} , \qquad ( 24 )$$

As an example:

J1

| | | | all other |
|---|---|---|---|
| R | G | Φ | columns |
| R1 | Single-family | 130 | . . . |
| R2 | Duplex | 340 | . . . |
| R3 | Duplex | 503 | . . . |
| R4 | Single-family | 189 | . . . |

where Gⱼ is equal to Duplex, hence 340+503=843 since only R2 and R3 are Duplexes, while the ratio (23) equals 73%

$$\frac{340 + 540}{130 + 340 + 503 + 189} = \frac{843}{1162} \approx 0 \text{.73} . \qquad ( 25 )$$

### Query 5

The system can further compute emissions of an asset (e.g., facility, home/building, vehicle, solution, load, etc.) in each given energy subtype Yₖ and subsector X. For each asset R there is a table describing its consumptions at each fixed sublevels Yₖ and Xₖ, where the emissions of all assets in the subsector Xⱼ (of the residential sector J1) that are consuming energy subtype Yₖ can be computed.

First, the system calculates (k, j)-emissions of a given asset R and calls the table with Γ_{K} which contains carbon contents and emissions factors of each energy subtypes of the energy type K, with two columns—energy subtypes and carbon content or emission factor per emission type. This process assumes one factor per type of emission, whereas many types of emissions might be present. These tables are used to compute (k, j)-emissions of R via the formula

$${Φ}_{k , j} ( R ) := {SUM}_{Xj} ( {σ}_{F = Y k} ( J 1 ( R ) ) \cdot {SUM}_{Γ} ( {σ}_{F = Y k} ( {Γ}_{K} ) ) ,$$

where SUM_{c} simply means the system extracts the element (in the column C) of each of the two tables containing one row only. The computed (k, j)-emission of R is denoted by Φ_{k,j}(R). Thus the total emission from consumption of the energy subtype Yₖ in the subsector Xⱼ is computed via the formula:

$${Φ}_{k , j} ( R ) := {\sum }_{R} {Φ}_{k , j} ( R ) , \qquad ( 26 )$$

where the summation is performed over all assets R in the sector J1. The proportion of this quantity in the total emission in the sector J1:

$$\frac{{ϕ}_{k , j}}{S U {M}_{ϕ} ( J 1 )} , \qquad ( 27 )$$

The system may filter only those assets R in the sector J1 that contribute to the (k, j)-emission (26) by first extracting the essential information from the tables J1(R) for all different assets R:

$$J 1 {( R )}_{k , j} {:=}_{R X j} ( {σ}_{F = Y k} ( J 1 ( R ) ) ) , \qquad ( 28 )$$

The new table J1(R)ₖⱼ contains only one row (corresponding to Yₖ) and two columns, R containing information about the asset, and Xj containing the value of the (k, j)-consumption, where combining all the resulting tables gives:

$$J {1}_{k , j} := {⋃}_{R} J 1 {( R )}_{k , j} , \qquad ( 29 )$$

where the union is over the set of all assets in J1. J1_{k,j} is a long table of (k, j)-consumptions of assets in J1, where applying the operation of natural join to J1 and J1ₖⱼ:

$$J {1}^{} J {1}_{k , j} , \qquad ( 30 )$$

Gives a table has an extra column Xⱼ containing information about (k, j)-consumptions, from where we can remove those assets in J1 that have trivial (k, j)-consumption,

$${σ}_{X j > 0} ( J {1}^{} J {1}_{k , j} ) , \qquad ( 31 )$$

and just extract the list of those assets in J1 with positive (k, j)-consumption,

$${\prod }_{R} ( {σ}_{X j > 0} ( J {1}^{} J {1}_{k , j} ) ) , \qquad ( 32 )$$

In short, working with table J1 and selecting only those rows (R) for which the corresponding (k, j)th entry of the consumption table J1(R) is positive:

$${σ}_{R : {SUM}_{Xj} ( {σ}_{F = Y k} ( J 1 ( R ) ) ) > 0} ( J 1 ) \qquad ( 33 )$$

### Query 6

In order to obtain the table of assets (e.g., facilities, homes/buildings, vehicles, solutions, loads, etc.) in a given sector (e.g., J1) together with their localized (k, j)-emissions, the system may exploit the table J1_{k,j} of (k, j)-consumptions and modify its second (Xⱼ) column by multiplying it with the carbon content:

$${\prod }_{R , Xj \cdot {SUM}_{Γ} ( {σ}_{F = Yk} ( {Γ}_{K} ) ) > 0} ( J {1}_{k , j} ) \qquad ( 34 )$$

If carbon contents are constant values and do not vary by sector, location or time, they may have fixed denotions, like Γₖ for the carbon content or emissions factor in the energy subtype Yₖ, which can be simplified as:

$${ϕ}_{k , j} := {\prod }_{R , Xj \cdot Γ k} ( J {1}_{k , j} ) , \qquad ( 35 )$$

### Query 7

The system can further compute the fractions of emissions in a given sector (e.g,. J1) relative to the total emission in all 4 sectors:

$$\frac{S U {M}_{ϕ} ( J 1 )}{S U {M}_{ϕ} ( J 1 ) + S U {M}_{ϕ} ( J 2 ) + S U {M}_{ϕ} ( J 3 ) + S U {M}_{ϕ} ( J 4 )} , \qquad ( 36 )$$

If the values of emissions in sectors were SUM_{Φ}(J1)=1290, SUM_{Φ}(J2)=2120, SUM_{Φ}(J3)=3400 and SUM_{Φ}(J4)=1780, then the ratio for J1 would be 15%

$$\frac{1290}{1290 + 2120 + 3400 + 1780} = \frac{1290}{8590} \approx 0.15 . \qquad ( 37 )$$

### Query 8

Knowing for each asset R (e.g., facility, home/building, vehicle, solution, load, etc.) the emissions Φ as well as the energy consumption by Xⱼ and Yₖ, the system can aggregate based on the ownership of the assets, let's say S individual person (J=1) or individual company or organization (J=2). Getting S-level ϕ_{S} by aggregating ϕ_{R} in the selected p and t. The system will extract all R's belonging to each unique person or organization and compute the total emission of this entity and compare it to the total emission in this J and this city, p in any given time t.

The system can thus compute emissions of assets belonging to each entity. For simplicity, only assets confined to one city/region p is considered in this example, but this operation can be done across every city. For the assets may be associated with one or more types of entities (e.g., U producers, P government, J consumers and V number of climate solutions). Given that there is a table S encoding the relation between unique assets R and unique individuals S (ID number). If the system wants to solve the above computation for the individual with the ID number i, it filters all assets in S belonging to i:

$${S}_{i} : = {σ}_{I = i} ( S ) , \qquad ( 38 )$$

Then, the natural join operation of Sᵢ with J1:

$${S}_{i}^{} {Φ}_{k , j} , \qquad ( 39 )$$

where Φ_{k,j} is the table of emissions in J1. By joining rows from Sᵢ (corresponding to assets R) with the corresponding rows in Φ_{k,j}. The summed emissions in the resulting table to compute an entity's emissions in a given city/region, p over time, t is given by:

$${Φ}_{k , j} ( i ) := {SUM}_{{X}_{j}} ( {S}_{i}^{} {ϕ}_{k , j} ) , \qquad ( 40 )$$

The system can also compare the computed entity's emissions to the total emissions in J1 sector by computing the respective fraction:

$$\frac{{Φ}_{k , j} ( i )}{S U {M}_{ϕ} ( J 1 )} , \qquad ( 41 )$$

In some embodiments, the width of a particular category or subcategory on one axis may be proportional to the total amount of that category or subcategory relative to the other sub-categories. For example, if petroleum makes up 50% of fossil fuel usage, natural gas makes up 40% and coal makes up 10%, then the width of the petroleum bar on the type axis may be five times that of the coal bar, and so forth. The same bar scaling techniques can be applied on the sector axis, such that the bar for businesses is twice the depth of the bar for residential if business use accounts for twice as much fossil fuel consumption as residential use. In other embodiments, bars have equal widths and depths. In still other embodiments, bars of fixed and variable width and depth may be combined. For example, bars of fixed depth may be combined with bars of variable width, or bars of fixed with and depth at the top level may be combined with bars of variable width and depth at the drill-down level. Other combinations are also contemplated as being within the scope of the invention.

In some embodiments, user interface 200 is operable to track trends over time as well as evaluate the data at a particular point in time such as the present. For example, user interface 200 may include a slider to adjust the point in time for which the data is displayed. Alternatively or in addition, user interface 200 may animate to display trends in the data over time. This can be done via Queries 1-8 and FIGS. 4-7 described above. In some embodiments, the animation may display the current view (the full view or the drill-down view) as it changes over time. In other embodiment, the animation process resets the view to the full view. The user interface 200 may also display future projections. User interface 200 may also animate in other ways. For example, the viewing angle may rotate around the z-axis so as to better display, for example, sector-type categories or subcategories that would be obscured by other categories or subcategories. In still other embodiments, various greenhouse gas reduction strategies and models (as further discussed below) can be animated. For example, given a model for reducing the greenhouse gas emissions from a particular sector, the animation may show the projected future breakdown of the energy use in that category by non-carbon-based energy sources as time progresses.

In particular, user interface 200 may be used to generate or examine a greenhouse-gas mitigation strategy. In some embodiments, various sources of power may be colored differently. For example, carbon-based fuels may be dark grey or black, with wasted energy colored grey. By contrast, alternative, non-greenhouse-gas generating fuels may be green, or otherwise brightly colored. Thus, in such embodiments, as the energy mix becomes less carbon-dependent, user interface 200 will transition from black and grey to bright and multicolored.

The user interface 200 may show trends past, present, and future based inputs into the system and how the trends may react and changed based on the inputs. An algorithm for optimizing resource allocation and usage is described below.

### Example Implementation of the Algorithm

As mentioned previously, embodiments of the invention can be employed to generate or examine a greenhouse-gas mitigation strategy. Described below are two linear programming implementations of how such a model can be generated. The two programming implementations described below describe methods of receiving inputs of source data from benign and harmful energy sources, determining energy used and energy wasted by transfer processes. Further, the programming implementations provide methods of allocating the resources to minimize the harmful energy sources and maximize the benign energy sources. Further, the resource data from the inputs, the energy used and wasted in the transfer processes, and the optimization data and allocation data may be provided in the visualizations depicted in the figures.

Consider a system where input sources, Z(t) could be distributed into two main groups, either through discrete categorization (binary groups) or ranked according to a continuous value of ecological or environmental value creating or value destroying. Notation for describing the modelling process is given below.

A(t) is the total amount of resources coming from an ecologically benign source (e.g., a renewable energy source) in any given time or period, and B(t) is the total amount of resources coming from an ecologically harmful source (e.g., a non-renewable energy source) in any given time or period. Then Z(t)=A(t)+B(t). T broadly represents transformations of resources. T(t) is any transformation step that takes the intermediate source of resource before converting the resource to different form, TA(t) is the inflow of a given transformation step T(t) that takes the intermediate source of resource from an ecologically benign source A(t) before converting the resource to different form, and T^{B}(t) is the inflow of a given transformation step T(t) that takes the intermediate source of resource from an ecologically harmful source B(t) before converting the resource to different form. Then, following from the above, T(t)=T^{A}(t)+T^{B}(t).

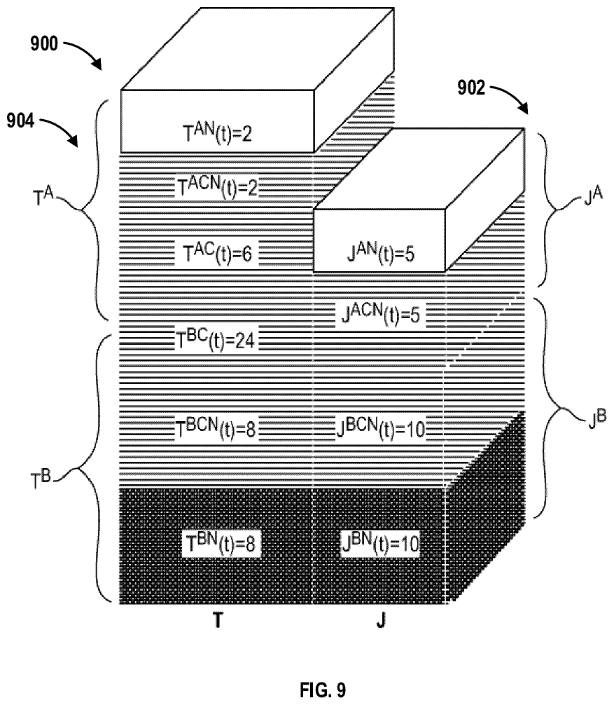

Next, J broadly describes the inflow of resources. J^{T}^{⁽ⁱ⁾}(t) is any inflow of resources transformed by step T(t) and then consumed by the i^{th} end-user J. As an example, J^{T}^{⁽ⁱ⁾}(t) represents the amount of T transformed resources consumed by J1. J^{A}^{⁽ⁱ⁾}(t) and J^{B}^{⁽ⁱ⁾}(t) is any inflow of resources consumed by the i^{th} end-user J, of form A, derived from A(t), and of form B, derived from B(t), respectively, such that J⁽ⁱ⁾(t)=J^{A}^{⁽ⁱ⁾}(t)+J^{B}^{⁽ⁱ⁾}(t)+J^{T}^{⁽ⁱ⁾}(t). FIG. 9 depicts one sector-type category 800 of user interface 200 decomposed into inflows 802 and transformations 804. As such, FIG. 9 depicts the relative relationship of the inflow from a benign source J^{A}, the inflow from a harmful source J^{B}, the transition of the inflow from the benign source T^{A}, and the transition of the inflow from the harmful source T^{B}.

J can broadly be decomposed into N and M. N⁽ⁱ⁾(t) is any inflow of resources that is unconsumed or wasted by the i^{th} end-user J, and thus, not directly used. As an example, N⁽¹⁾(t) represents the amount of resources unused by J⁽¹⁾. M⁽ⁱ⁾(t) is any inflow of resources, that represents total resource inputs used by the i^{th} end-user J, and thus, directly used. As an example, M⁽¹⁾(t) represents the amount of resources used by J⁽¹⁾.

Turning now to process efficiency, let η⁽ⁱ⁾(t) be thus the ratio of wasted or unconsumed resource inflow (e.g., N⁽ⁱ⁾(t)) to the total inflow of J⁽ⁱ⁾(t) (e.g., N⁽ⁱ⁾(t)+M⁽ⁱ⁾(t) by the i^{th} end user: η⁽ⁱ⁾=N⁽ⁱ⁾(t)/(N⁽ⁱ⁾(t)+M⁽ⁱ⁾(t)). Let T^{C}(t) is any outflow of T(t) transformation step that is wasted during the transformation process. Then μ_{T} is thus the ratio of the wasted outflow T^{C}(t) for the transformation step to the total outflow T(t): μ_{T} =T^{C}(t)/T(t). For notational convenience, let E(t) be the total outflow that represents total resources that are used or consumed during total process, including

$${M}^{( i )} ( t ) : E ( t ) = {\sum }_{i}^{n} {M}^{( i )} = {M}^{( 1 )} ( t ) + {M}^{( 2 )} ( t ) ;$$

Where i=1, 2, . . . n. For one example, this description uses n=2; however, any value of n is contemplated. Similar to E, let C represent the total outflow that represents total resources that are wasted or unconsumed during total process (including N⁽ⁱ⁾(t) and

$${T}^{C} ( t ) : C ( t ) = {\sum }_{i}^{n} {N}^{( i )} + {T}^{C} ( t ) .$$

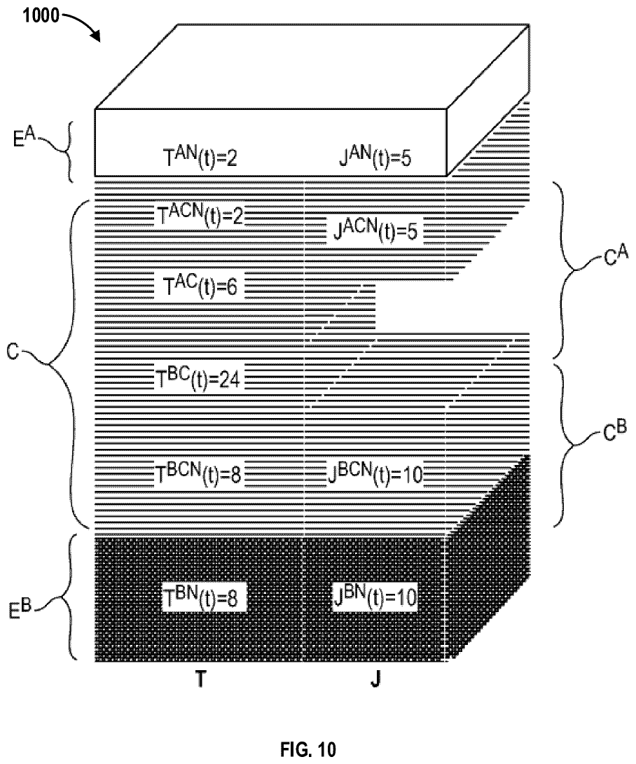

FIG. 10 depicts the same sector-type category 1000 as FIG. 9 of user interface 200 decomposed instead into wasted energy C, utilized energy of the benign source EA, and utilized energy from the harmful source E^{B}.

Now let T^{AC}(t) be the proportion of any wasted outflow during the transformation process of step T(t) that is attributed to origin from an ecologically benign source, A(t) and let T^{BC}(t) be the proportion of any wasted outflow during the transformation process of step T(t) that is attributed to origin from an environmentally harmful source, B(t). This gives T^{AN}(t)+T^{BCN}(t)=(1−η)*(p^{T}(B)*J^{T})+(1−μ)*η*T^{A}. T^{AC}(i) is the outflow of resources from the transformed step T(t) by J⁽ⁱ⁾ attributed to environmentally benign source, A(t), so T^{AC}(t)=p^{T}(A)*T^{C}, and T^{BC}^{⁽ⁱ⁾}(t) is the outflow of resources from the transformed step T(t) by J⁽ⁱ⁾ attributed to environmentally harmful source, B(t), so T^{BC}(t)=p^{T}(B)*T^{C}.

This leads to J^{AN}^{⁽ⁱ⁾}(t) being any inflow of resources originating from an environmentally benign resource, A(t), transformed by step T(t) and then consumed by the i^{th} end-user J. As an example, J^{T,A}^{⁽¹⁾}(t) represents the amount of T transformed resources of source A(t), consumed by J¹: J^{T,A}^{⁽ⁱ⁾}(t)={T^{A}(t)/T(t)}*J^{T}^{⁽ⁱ⁾}(t). Similarly, J^{BN}^{⁽ⁱ⁾}(t) is any inflow of resources originating from an environmentally harmful resource, B(t), transformed by step T(t) and then consumed by the i^{th} end-user J. As an example, J^{T,B}^{⁽ⁱ⁾}(t) represents the amount of T transformed resources of source B(t), consumed by J⁽¹⁾: J^{T,B}^{⁽ⁱ⁾}(t)={T^{B}(t)/T(t)}*J^{T}^{⁽ⁱ⁾}(t).

Broadly, Φ represents a quantification function for the environmental harmfulness of each unit of resource consumption (e.g., impact of emissions) and P represents economic value or cost associated with a resource source converted from the quantified value produced by Φ. Hence P(A(t)) represents the economic value or cost converted from the quantified factors Φ(A(t)) for the total resource inflow A(t), and P(B(t)) represents the economic value or cost converted from the quantified factors Φ(B(t)) for the total resource inflow B(t). P(E(t)) and P(C(t)) is thus the combined economic value or cost converted from the quantified source factors, P(A(t)) and P(B(t)). For Φ(E(t)) and Φ(C(t)), the algorithm can thus represent and compute in terms of sourced Φ(A(t)) and Φ(B(t)) without regards to the economic value or cost function P. Now Φ(A(t)) represents the quantification factor for the environmental harmfulness of each unit of resource consumption of environmentally benign type A(t), such that Φ(A(t)) can be approximated by 0. Φ(B(t)) represents the quantification factor for the environmental harmfulness of each unit of resource consumption of type B(t), such that Φ(B(t))>0. For simplification, some embodiments may assume a fixed value for Φ(B(t)) such as 2.

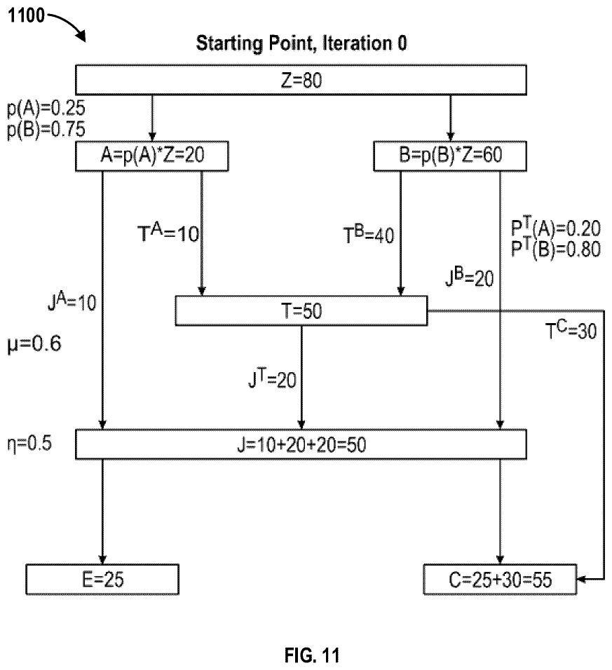

Turning to an exemplary embodiments depicted in FIG. 11, let a system have an overall quantity of throughput flow of Z (for concreteness, say 80 units), which can be of multiple types, (e.g., A and B) that collectively add up to Z (for example 60 units of B and 20 units of A). In particular, let p(A) and p(B) be the portion of Z which are made up of A and B respectively. Now, at least a portion of these flows from A and B go to a transformation step T, portions of which are represented by T^{A} and T^{B} that add up to T. Similar to p, let p^{T}(A) and p^{T}(B) be the proportions of T represented T^{A} and T^{B}.

The transformation step T has an efficiency factor, μ, where it separates the wasted portion, T^{C}=μ^{T}, to C, from the remaining portion (J^{T}) which is used and consumed along with direct A and B flow types, called J^{A} and J^{B} respectively (which add up to J). As above, let p^{J}(A) and p^{J}(B), proportions of J represented J^{A} and J^{B}. This, in turn, gives T^{C}=T^{AC}+T^{BC} where T^{AC}=p^{T}(A)*T^{C} and T^{BC}=p^{T}(B)*T^{C}. T^{A}, T^{B}, J^{A} and J^{B}, collectively add up to total A and B, respectively, and thus to total system flow Z.

Finally, the J consumption stage has its own efficiency factor η, where it separates the actual used-portion to E, and the remaining wasted portion to C. In terms of T and J, first T^{A}=T^{AN}+T^{ACN}+T^{AC} and T^{B}=T^{BN}+T^{BCN}+T^{BC}, since T=T^{A}+T^{B} (where T^{ACN}=(1−η)*(p^{T}(A)*J^{T}) and T^{BCN}=(1−η)*(p^{T}(B)*J^{T}) and T^{AN}=(1−η)*η*T^{A} and T^{BN}=(1−μ)*η*T^{B})). Next, J^{A}=J^{AN} (η*J^{A})+J^{ACN} (1−η*J^{A}) and J^{B}=J^{BN} (η*J^{B})+J^{BN} (1−η*J^{B}) (where J=J^{A}+J^{B}+J^{T}); and finally J^{T}=(1−μ)*T=J^{TA}+J^{TB} (where J^{TA}=(1−μ)*T^{A} and J^{TB}=(1−μ)* T^{B}).

The total Z could thus be visualized, and/or simplified in various reorganized terms, such as A, B, E, C or J and T-or a combination thereof. This described matrix system can then be enumerated within our example, with real values and terms. Then, the system can be optimized, where A and E should be maximized while B and C is minimized. After many iterations of the system with the above in mind, we can exit the optimization program when this above optimal has been achieved. Visually, over time t, the system should behave in this manner and user interface 200 should reflect the transition from ecologically harmful sources B to ecologically benign sources A based on the costing of quantification function Φ.

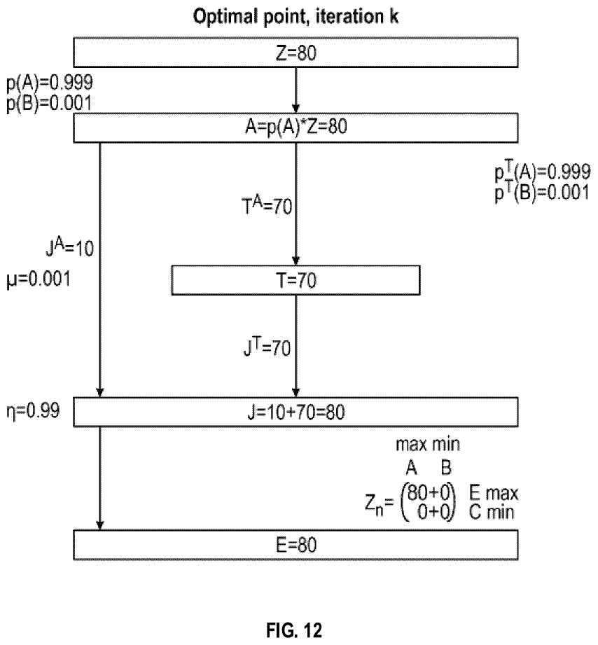

A concrete example of the above process is depicted in FIGS. 11-12. For the example of FIGS. 11-12, let Φ^{A} be 0 and Φ^{B} be 2 units of pollution, and assume that the costing function P gives $1.5 per unit of pollution. FIG. 11 shows the starting state of the example above where B of 60 units, so Φ is 120 units and P is $180. This amount can be used to “purchase” items, v (representing reallocations and transformations of energy sources in different ways), thereby changes the system parameters in meeting the desired conditions (i.e., p(A) and p^{T}(A) goes to 1, which implies p(B) and p^{T}(B) goes to 0, and η goes to 1, such that μ goes to 0). We can introduce, a set of v where, for each i^{th} v, we have a numeric condition that can satisfy required changes. For example, we might have v such that

$${v}^{( i )} = 1 ; Δ η = {η}^{( 1 )} - {η}^{( 0 )} = 0.1 ; so {η}_{1} = 0 \text{.60}$$

$${v}^{( i )} = 4 , Δ η = {η}^{( 1 )} - {η}^{( 0 )} = 0.15 , so {η}_{1} = 0 \text{.65} ;$$

$$Δ {p}^{T} ( A ) = 0.20 , {{p}^{T} ( A )}^{( 1 )} - {{p}^{T} ( A )}^{( 0 )} = 0.2 so {{p}^{T} ( A )}^{( 1 )} = 0.4 implying {{p}^{T} ( B )}^{( 1 )} = 0.60$$

$${v}^{( i )} = 3 , Δ μ = {μ}^{( 1 )} - {μ}^{( 0 )} = - 0.2 , so {μ}^{( 1 )} = 0.4 ; and$$

$$Δ p ( A ) = 0.15 , {p ( A )}^{( 1 )} - {p ( A )}^{( 0 )} = 0.15 so {p ( A )}^{( 1 )} = 0.4 implying {p ( B )}^{( 1 )} = 0.60 .$$

This process can be iterated, computing the imputed pollution cost P(B(t)) at each iteration until p(B) such that P(B(t)), at each iteration, different techniques for selecting the v⁽ⁱ⁾ to “purchase” using P(B(t)) are contemplated. For example, the v⁽ⁱ⁾ with the least cost could be selected. As another example, the v⁽ⁱ⁾ with the maximum reduction of Φ (i.e. maximized Φ⁽¹⁾−Φ⁽⁰⁾ or highest total pollution reduction) could be selected. Alternative, a hybrid of these methods could be used, such as maximizing (Φ⁽¹⁾−Φ⁽⁰⁾)/P(v). (i.e., maximizing pollution reduction per cost). After a number k of iterations, the system might result in the state depicted in FIG. 12. There, as can be seen, p(B) and μ have been minimized resulting in both B and C being approximately 0.

Thus, in summary, the exemplary embodiment of the system above can visualize (using user interface 200) how the initial conditions could evolve through iterations of parameterized changes and end at the optimal state, where due to step-wise increases of p(A), B and J^{B} are eliminated and due to step-wise increases of p^{T}(A), we eliminate T^{B}, thereby achieving the goal of maximizing ecologically benign energy sources A while minimizing ecologically harmful energy sources B. Next, due to step-wise decreases of μ, we eliminate T^{C}, one component of C, and due to step-wise increases of η, we eliminate the remaining component of C, thereby meeting our goal of minimizing wasted energy and maximizing energy utilization.

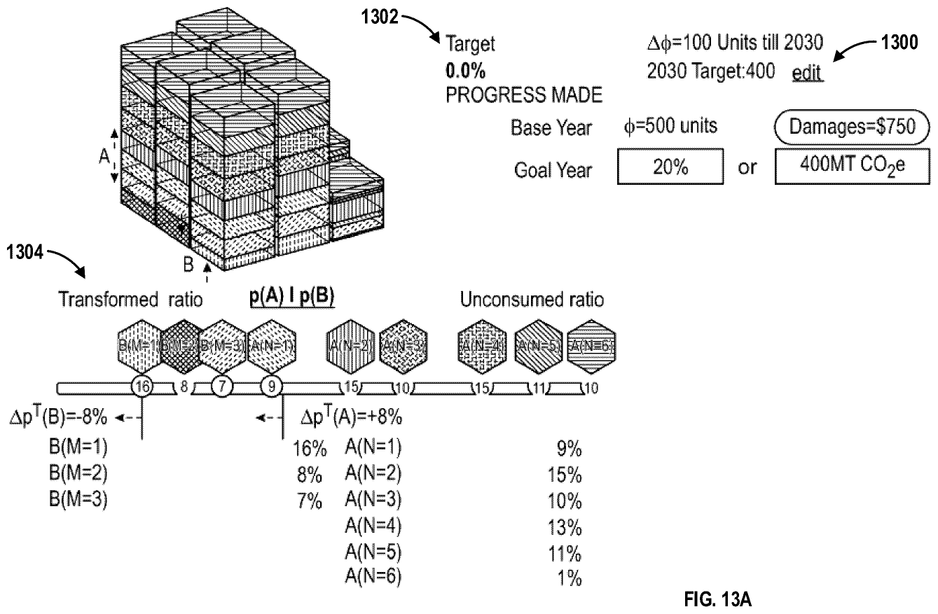

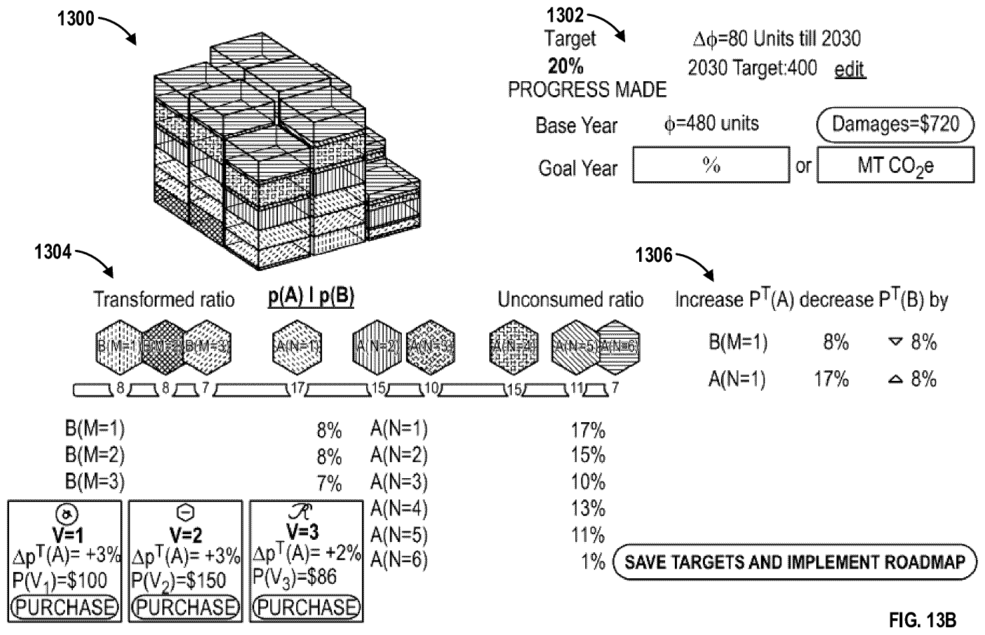

FIGS. 13A-16B depict an exemplary user interface 1300 of the above process visually. Initially, at FIG. 13A the goal of reducing the current pollution Φ of 500 units, by a target of ΔΦ of 100 units (to 400 total units) by 2030 depicted at evaluation 1302. This required ΔΦ is stored in the database for the specific user. Based on the generation of Φ units of pollution due to the consumption of M B's; a user can interactively enter change parameters (e.g., consumption of a particular B⁽ⁱ⁾) by moving the dials of the interface at input 1304, using a hardware device, like a computer mouse; or by using a touch-screen interface of a mobile device, tablet or kiosk monitor or via terminal line code and application programming interface syntax. From their initial positions, B (M=1) and A (N=1) are adjusted by a user or other entity, to direct changes in Δp^{T}(A), Δp^{T}(A) to the system's optimization model.

Following this parameter input, the system stores the changes (within a predetermined margin of error) into the database, and indicated to the user that the reduction in pollution was ΔΦ=20 units, meaning that 20% progress has been made if the indicated change is implemented, as depicted in FIG. 13B.

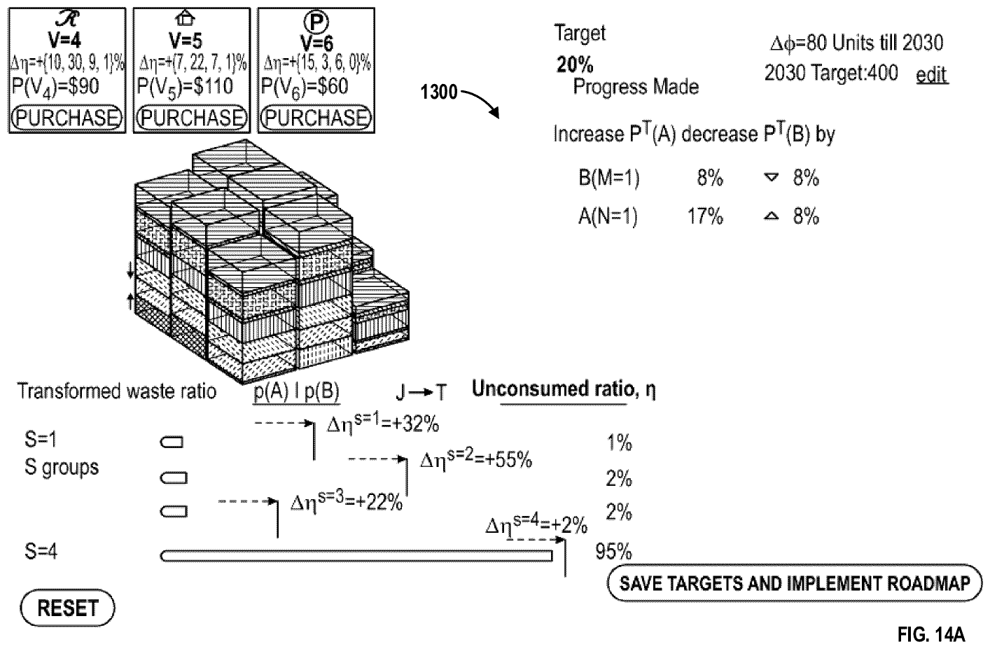

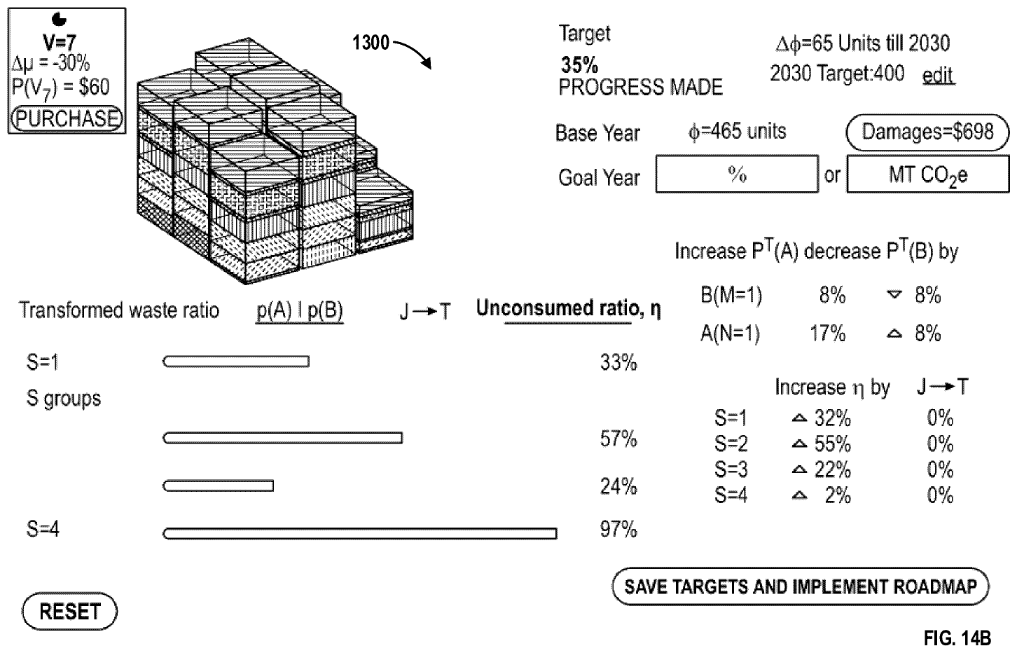

Next, as shown in FIGS. 14A-14B, is a solution evaluation visualization 1300 for each of the four solution entities, the corresponding i can be changed, such that, each do will now be stored in the database. After the change, which is displayed to the user, the progress metric is updated, communicating to the user or other entity, that an additional reduction in pollution of ΔΦ=15 units have been eliminated due to changes in the do matrix, as shown in FIG. 14B.

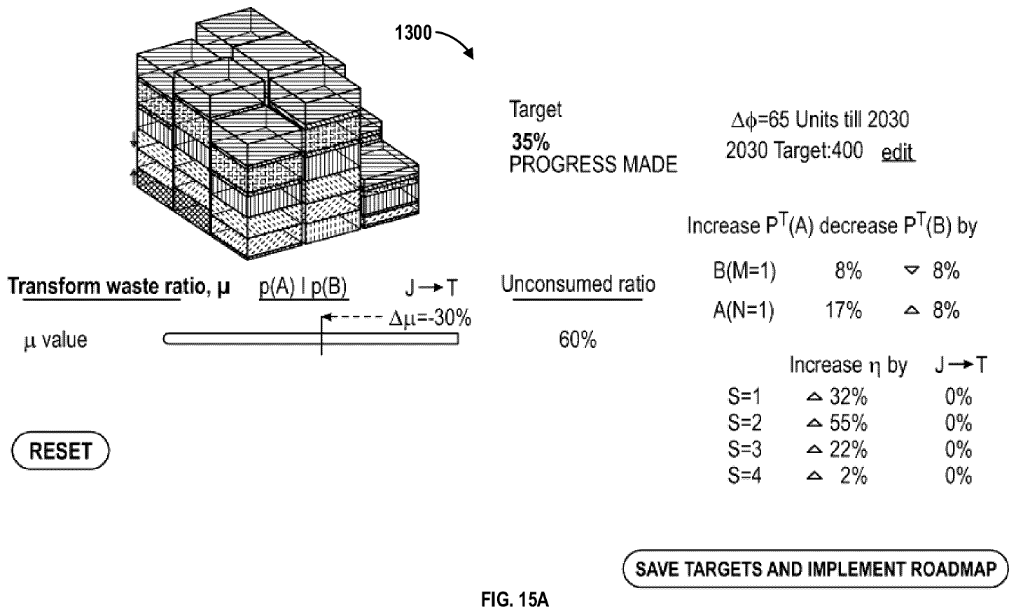

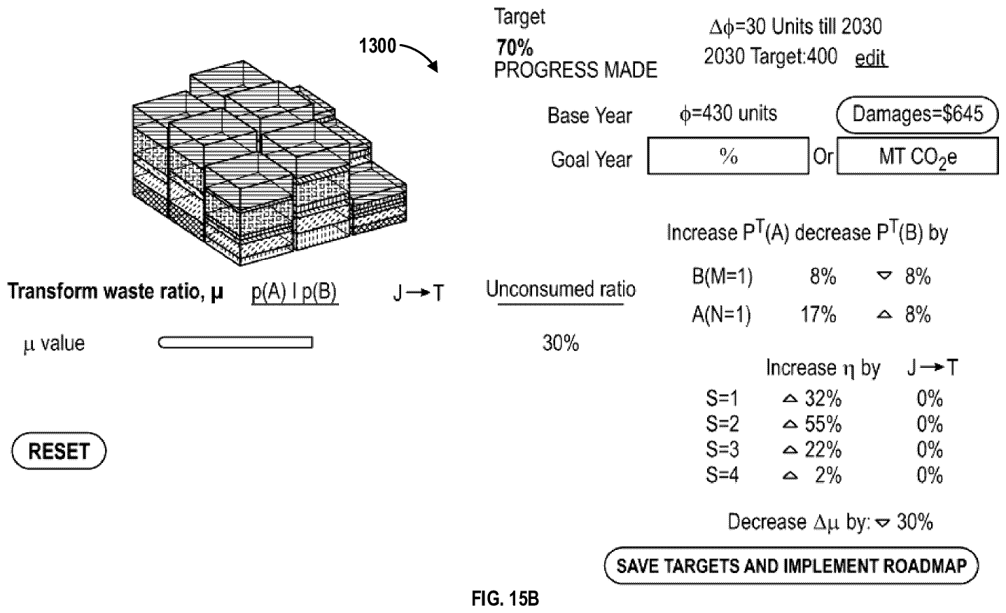

Further, as depicted in FIG. 15A, the user can also reduce Δμ, as shown, by 30% which is equated to a further reduction in pollution of ΔΦ=35 units. Thus, as depicted in other words, there remain only 30 units of Φ that to be eliminated, and the last dμ step had reduced 35 units of Φ, as shown in FIG. 15B. As shown in the changes, these are stored as targets for each solution entity when they see their individual, separated cube interfaces and analytics, such that the total changes are also specific to the nuanced context of each solution entity or user.

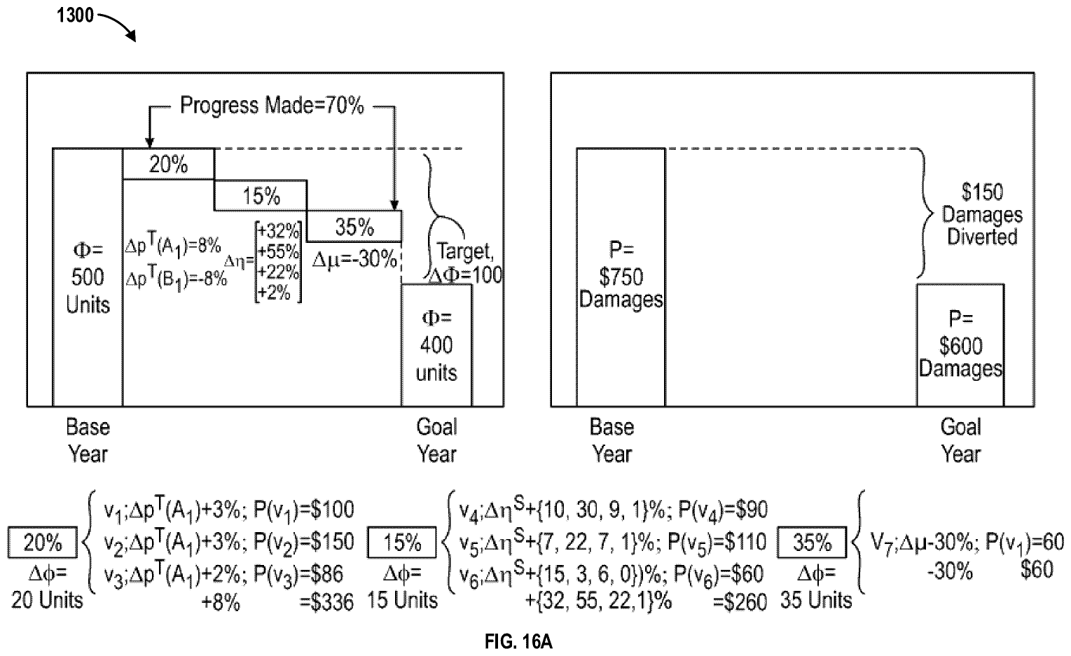

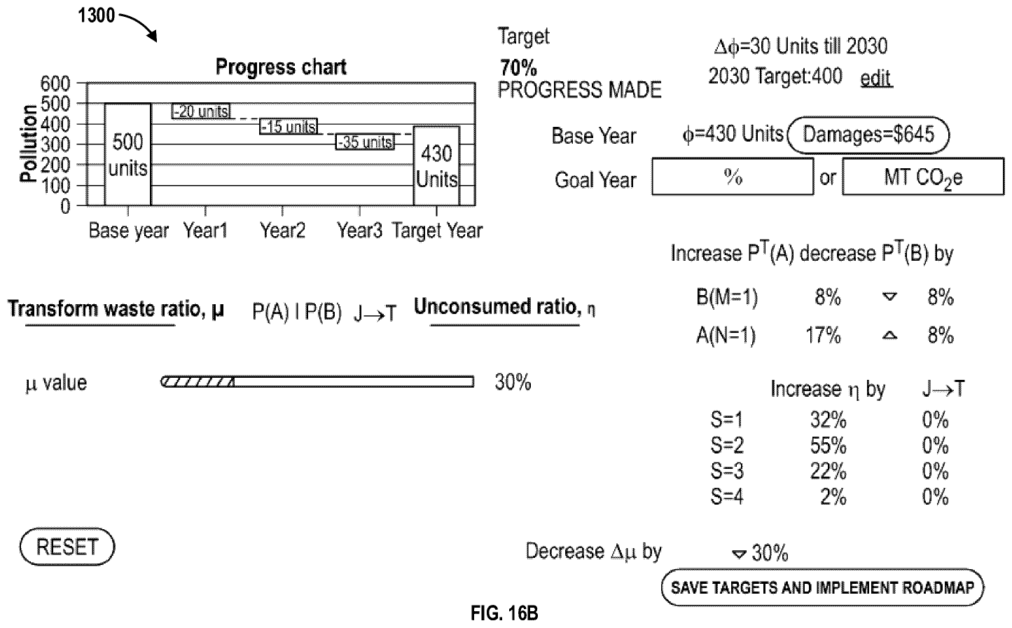

As can be seen in FIGS. 16A-16B, due to the above changes and storing of initial vs. final values stored in the database, a chart can be generated for the user to view the starting Φ value, and how the changes can lead to reductions in Φ, knowing there is a goal of 100 units of Φ by a certain year or in a particular timeframe.

Each of these reductions in Φ is associated with or derived from changes in more granularparameters, such as Δp^{J}(A), Δp^{J}(B), Δp^{T}(A), Δp^{T}(B), Δp(A), Δp(B), Δη, and Δμ, etc., which is provided by different solutions. Each solution v may be associated with a cost, P(v), representing a monetary cost to implement individual solution v. This cost could be evaluated by the user by simply viewing the graph or chart, not only in terms of t, but in terms of P(Φ(t)) which can be a constant or a variable. Instead of doing $750 of damages by consuming 500 units, the user can instead invest the $656 required to purchase a number of solutions v⁽ⁱ⁾; thereby making 75% progress to reaching its 2030goal of 400 units.

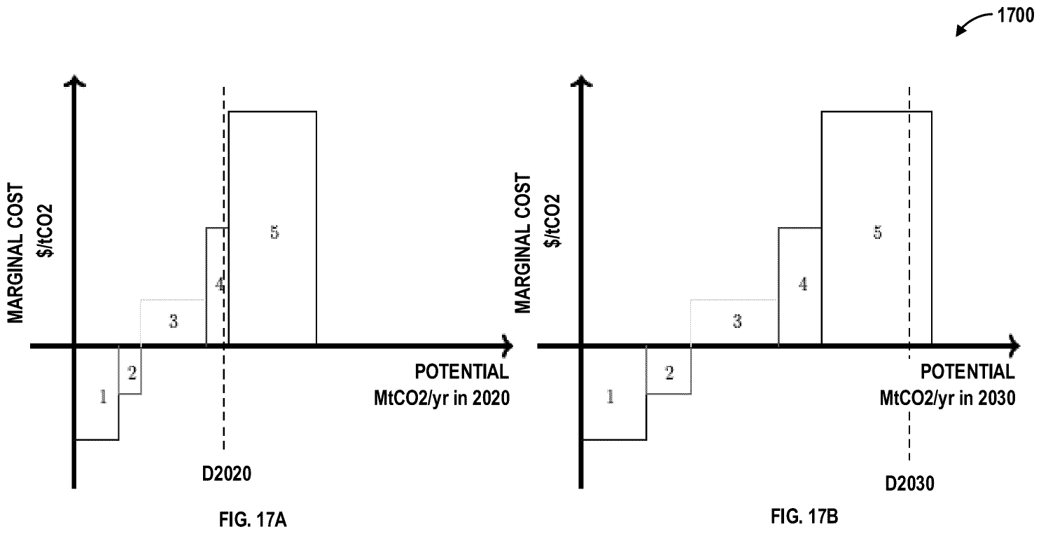

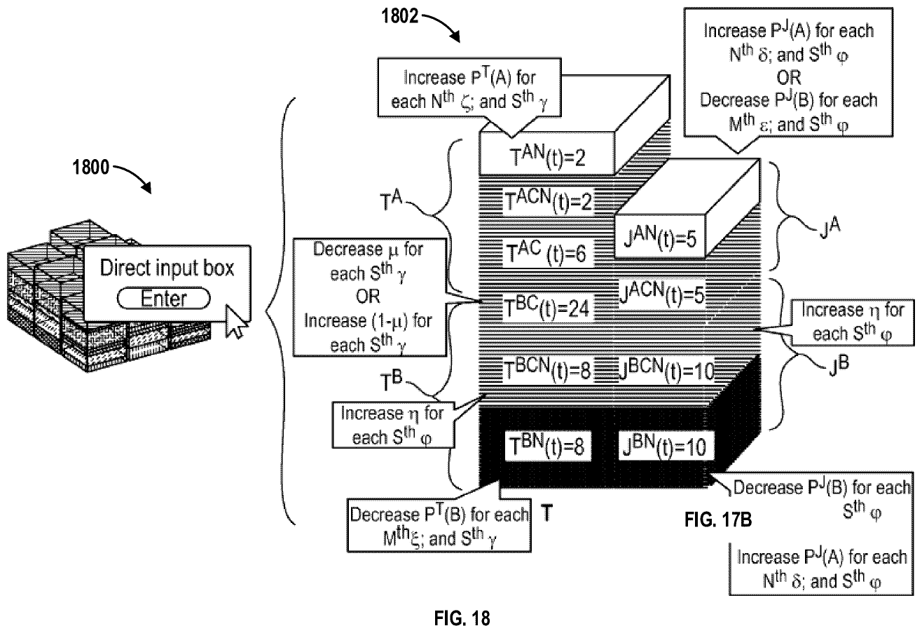

Each user can thus evaluate their costs, total P(v) for all v⁽ⁱ⁾, and their benefits, which are total Sv(t) savings over time, in addition to the $150 in damages ($750-$600) they would have incurred, had they not made the changes to reduce Φ by 100 units by adopting the chosen v⁽ⁱ⁾. As shown in FIG. 16B, users can also move from the real-time cube view, to a more temporal progress view with real-time changes as interface dials are manipulated by the user or an entity on their behalf. As interface dials are changed, a set of v's can be automatically visualized on the interface, clicking which can show how the visuals and values will change depending on v-level parameters. As an example, as shown in FIGS. 17A-17B, marginal abatement cost curves show that costs per CO₂ may increase as time progresses.

Similar to the user interface manipulations from FIGS. 13A-13B, 14A-14B, and 15A-15B, the analytical cube 1802 can be directly accessed via the user interface generally referred to by numeral 1800, as depicted in FIG. 18. An exemplary inflow and transition process is shown in the visualization 1304 similar to FIGS. 9-10. From the perspective of other entities, such as each v solution entity, the animated cube of any user (or group of users) can be viewed to determine the corresponding information such as parameters changed by that user, and of which type, and what is the corresponding cost (P(v)) to purchase, or savings created, Sv(t), or pollution/social and environmental costs reduces, in terms of P(B(t)) or Φ(B(t)), respectively.

This information may be stored in a database and made available to the user in the user interface as shown before. This interface may function like a bidding system, or marketplace, introducing different entities as buyers, sellers or intermediaries, like rating organizations, financial institutions, corporations or governmental agencies—programmatically asking user S to lower 1 or social costs, P(B(t)) by adopting certain v's which meet cost, P(v) or savings, Sv(t) thresholds. Such a user interface may additionally aggregate and visualize the incoming or stored data, set or suggest change targets, and load potential solutions or options the user has available to meet a particular target through any stored or accessed v-level change parameters Δp^{J}(A), Δp^{J}(B), Δp^{T}(A), Δp^{T}(B), Δp(A), Δp(B), Δη, and Δμ, etc.

Details of each solution v⁽ⁱ⁾ stored in the database may be depicted, such as the level of the change parameters (Δp^{J}(A), Δp^{J}(B), Δp^{T}(A), Δp^{T}(B), Δp(A), Δp(B), Δη, and Δμ, etc.), the cost to purchase, P(v), the expected savings over time ΔSv(t), the estimated reduction in pollution, ΔΦ (or conversely, “progress made” or subsequently, the estimated reduction in economic harm or pollution cost P(t), by the a particular user in a given time period t).

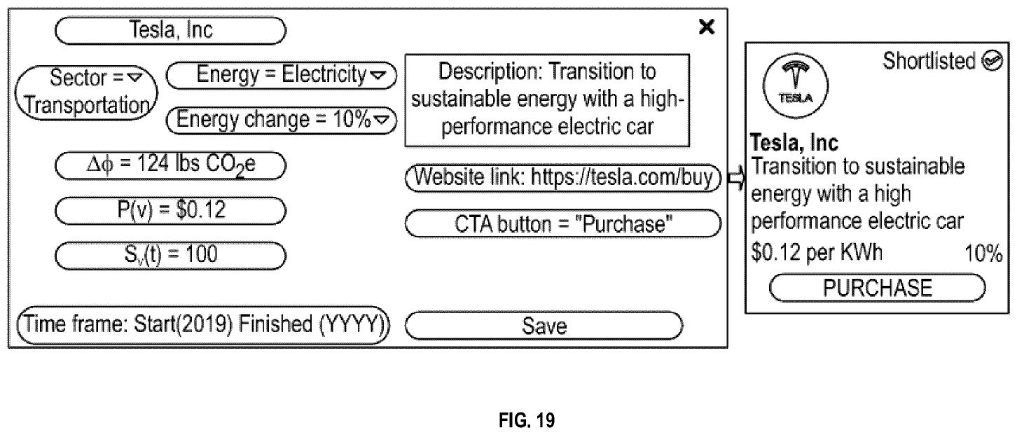

FIG. 19 depicts a simple interface on how each of the v-solution data parameters may be inputted into the system by a user or set of users.

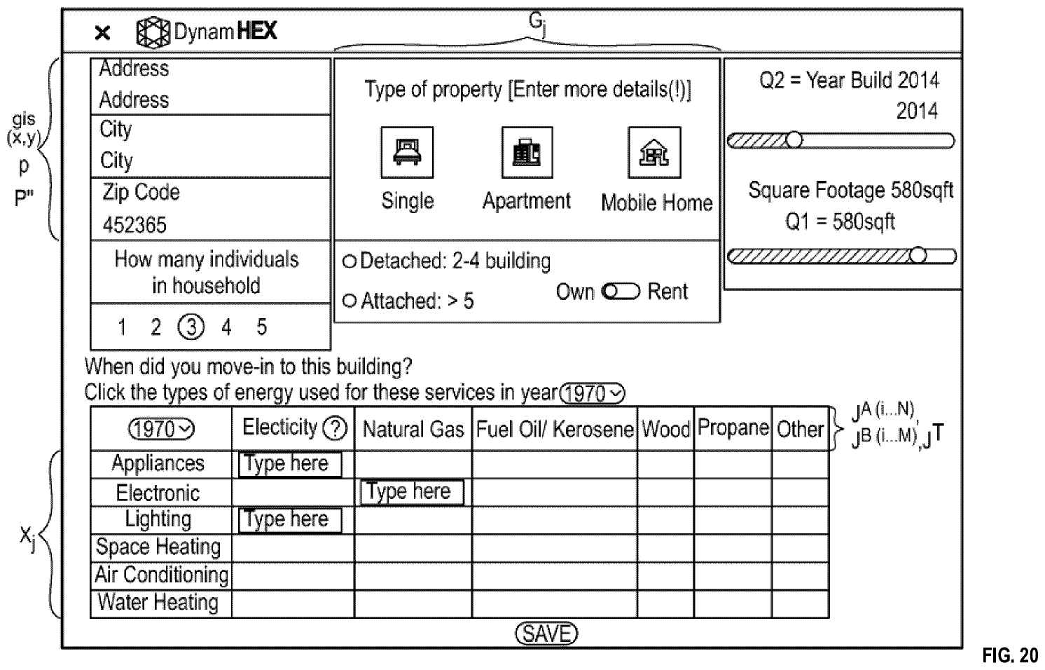

FIG. 20 depicts an interface on how each of the R-level data in a given region, p can be entered by S entities and encodes attributes such as Q, Xⱼ, Gⱼ, Yₖ, t etc. which can be used for filtering geospatially.

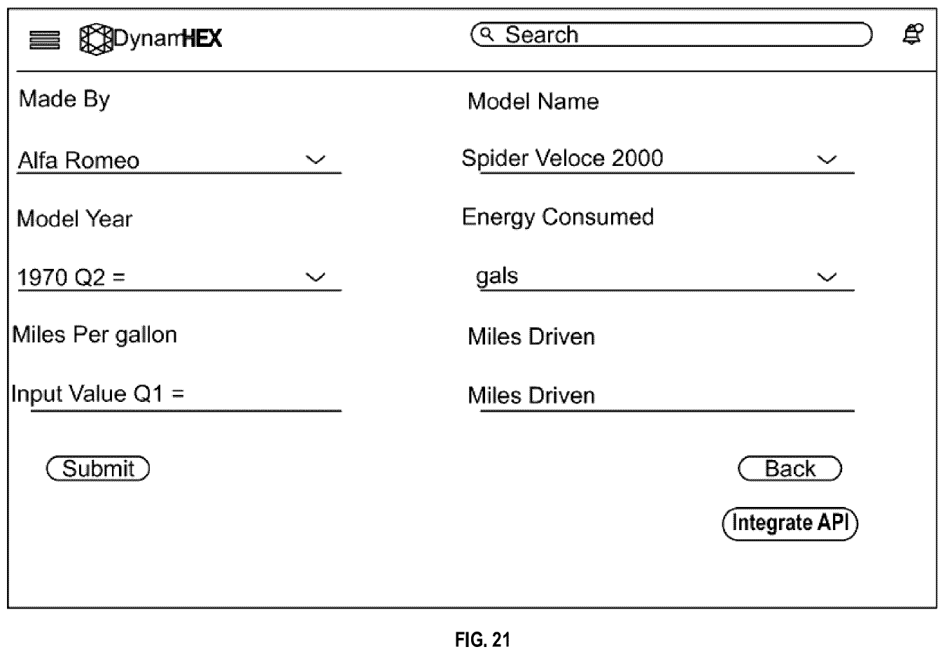

FIG. 21 depicts an interface to input other J sector R level data (such as J=transportation, R=passenger vehicle) for any given t.

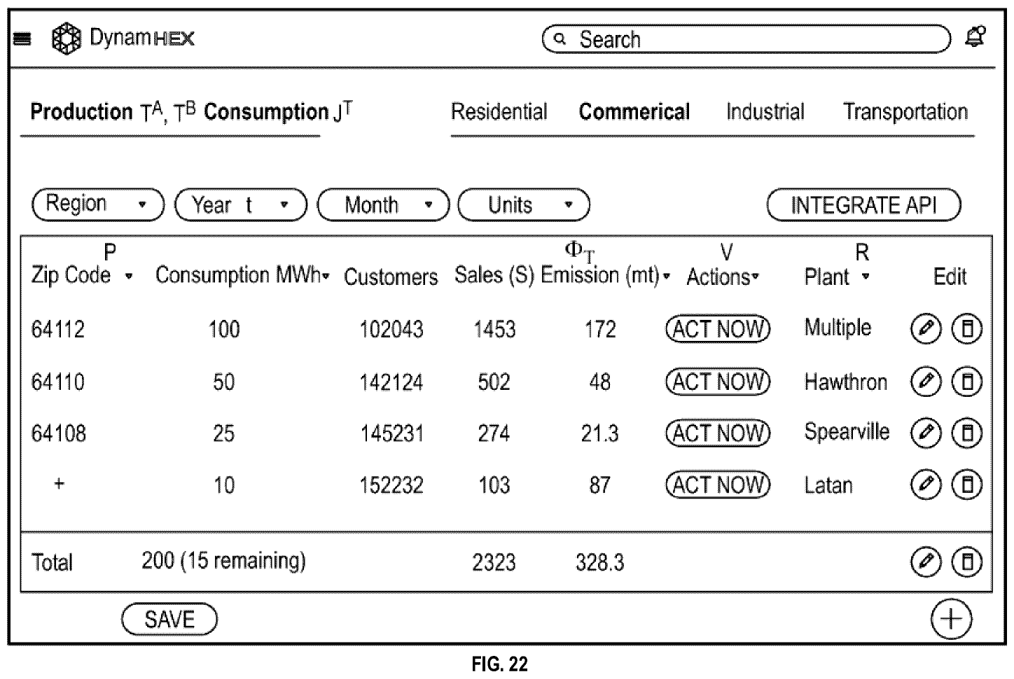

FIG. 22 depicts an interface to input data on transformation T of an energy source (T^{A}, T^{B}) as well as the sector and location of the consumption, J^{T} over time t. Same interface can be used compute emissions, as well as enter v solutions through “Act now” button.

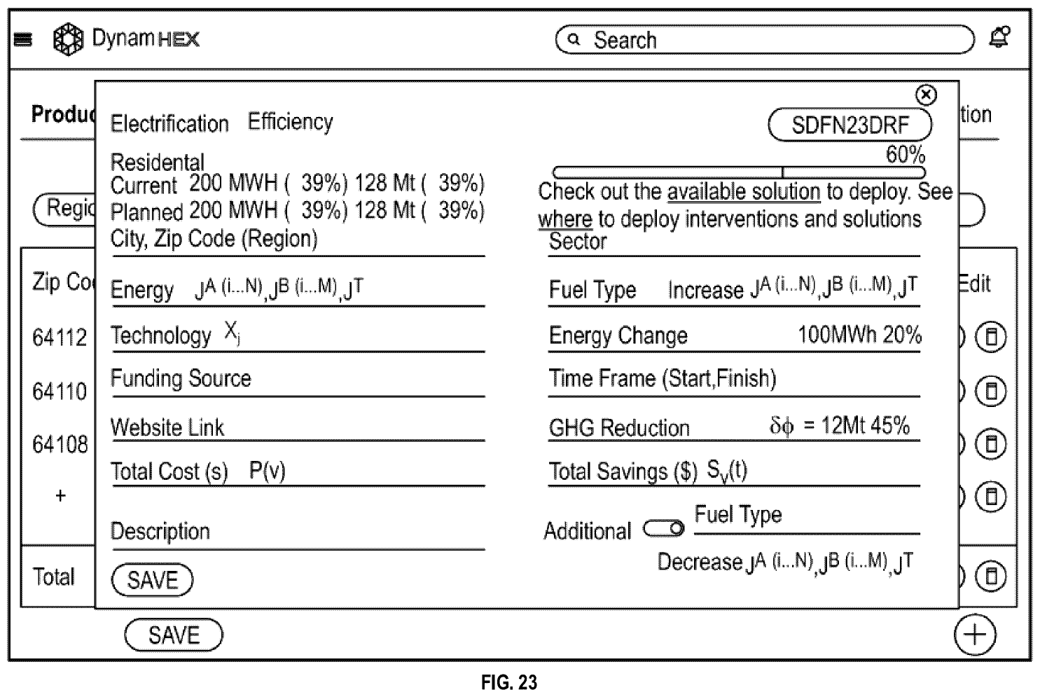

FIG. 23 depicts a further interface on the act now button, which is similar to v-solution entry interface, listing Δp^{J}(A), Δp^{J}(B), Δp^{T}(A), Δp^{T}(B), Δp(A), Δp(B), Δη, and Δμ as well as P(v), ΔΦ and ΔSv(t) for the algorithm inputs and storing outputs.

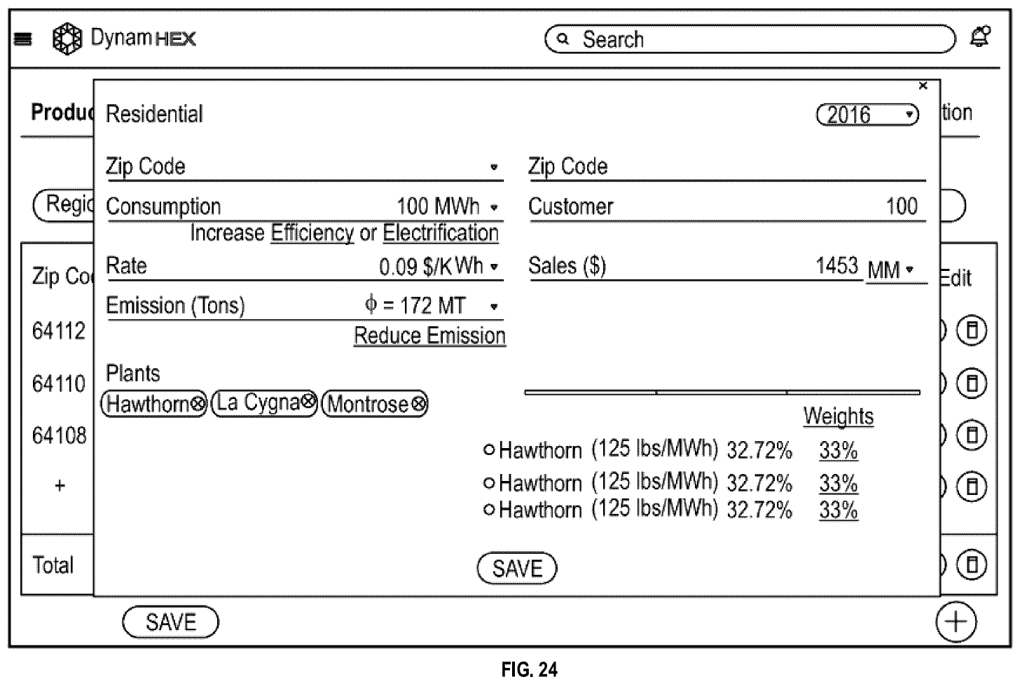

FIG. 24 depicts the input of each region p, denoting which plant or plants, R provide energy source, the cost and price of said energy and the emissions for that energy, for a given time t. Instead of p level regional data, S level entity data entry is also possible.

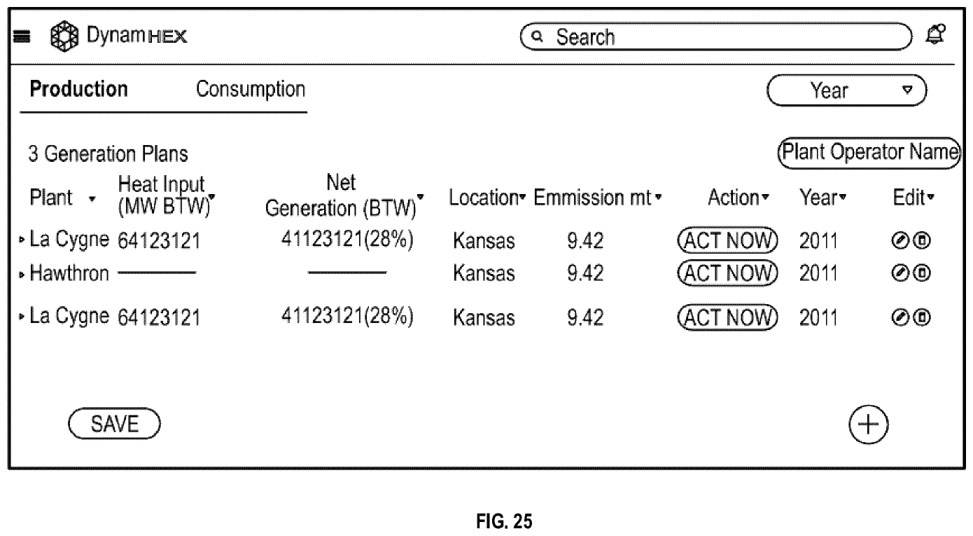

FIG. 25 depicts the input of plants R, denoting which location p, it provides energy to and the emissions as a result for a given time t.

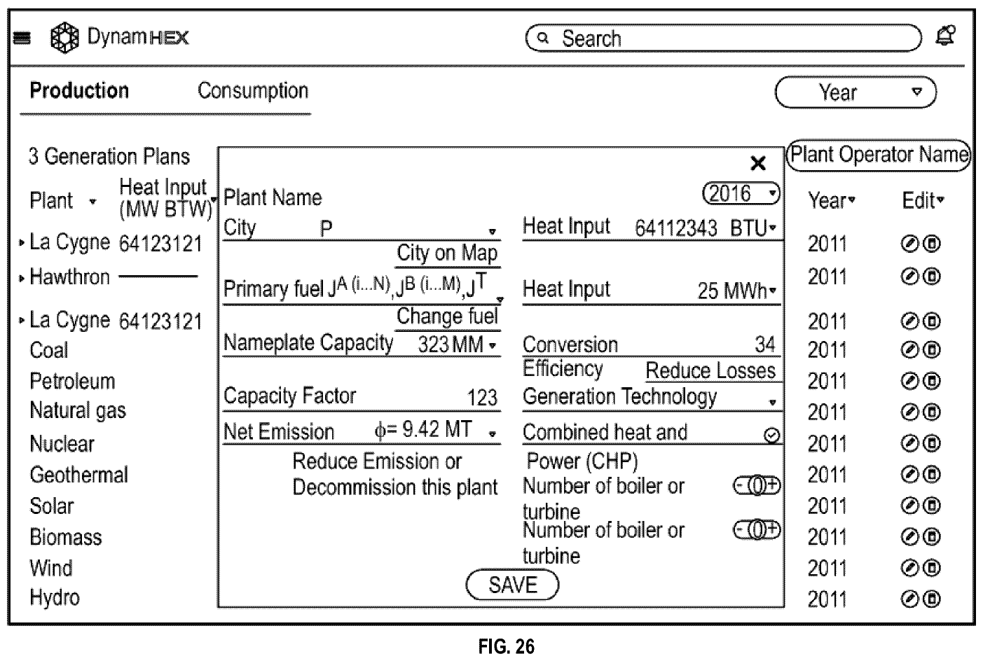

FIG. 26 depicts the input of each plant R, by energy source, efficiency and emissions for any given region p, and time t.

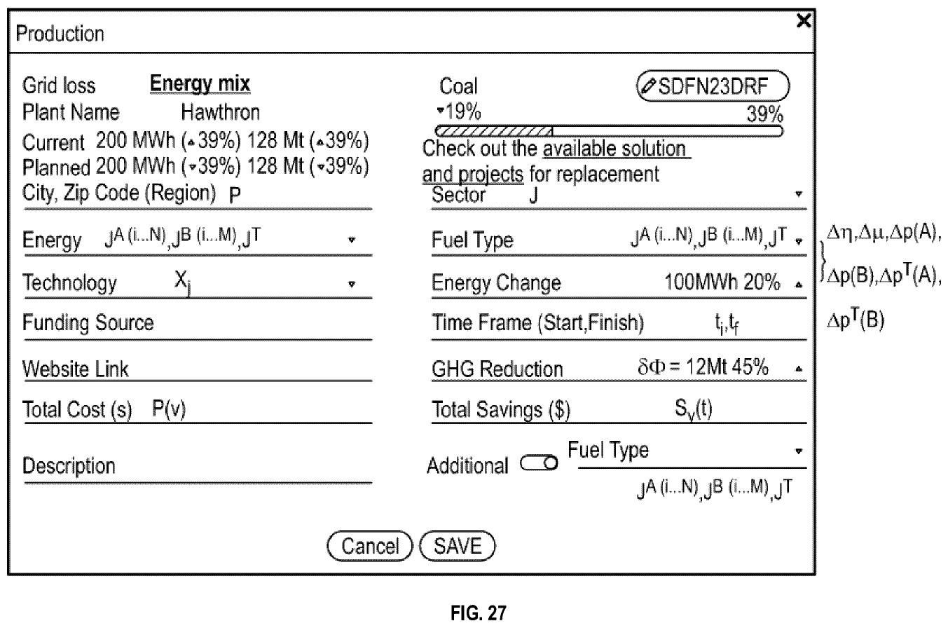

FIG. 27 depicts v-solution entry interface, listing Δp^{J}(A), Δp^{J}(B), Δp^{T}(A), Δp^{T}(B), Δp(A), Δp(B), Δη, and Δμ for the algorithm inputs, including solution purchase parameter like P(v), ΔΦ and ΔSv(t) etc.

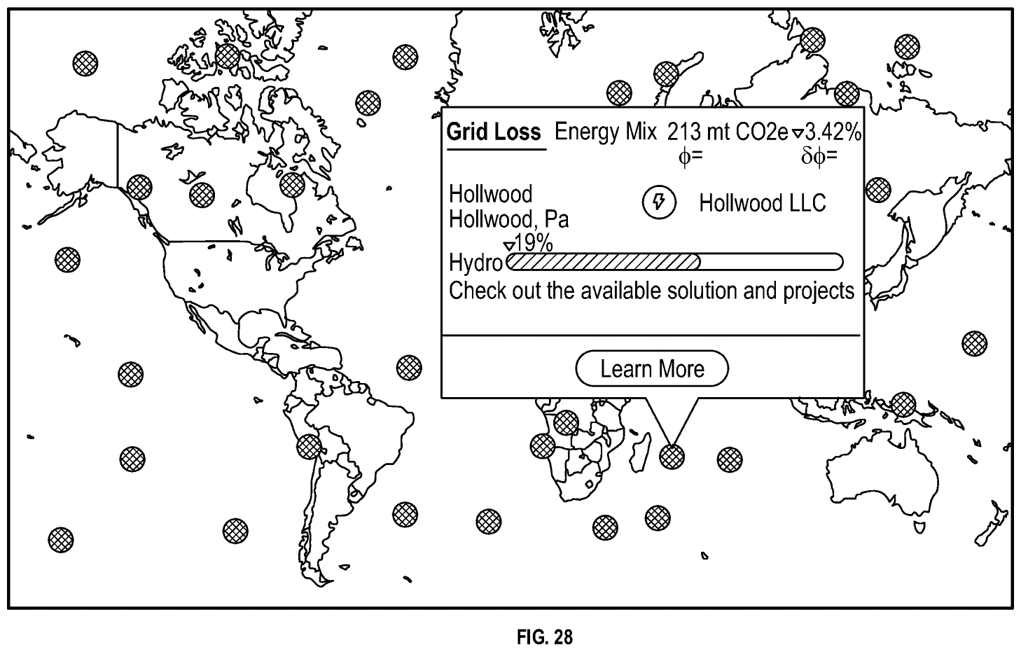

FIG. 28 depicts the R^{th} level plant, as well as energy source, efficiency and emissions data on can be shown on any topographical map, given known location in any given region p, and time t. Similar to earlier shown tabular (11) format of storing geospatial information at the R^{th} level, where R is a powerplant, computing emissions from different energy sources and aggregating to the regional p^{th} level in time t.

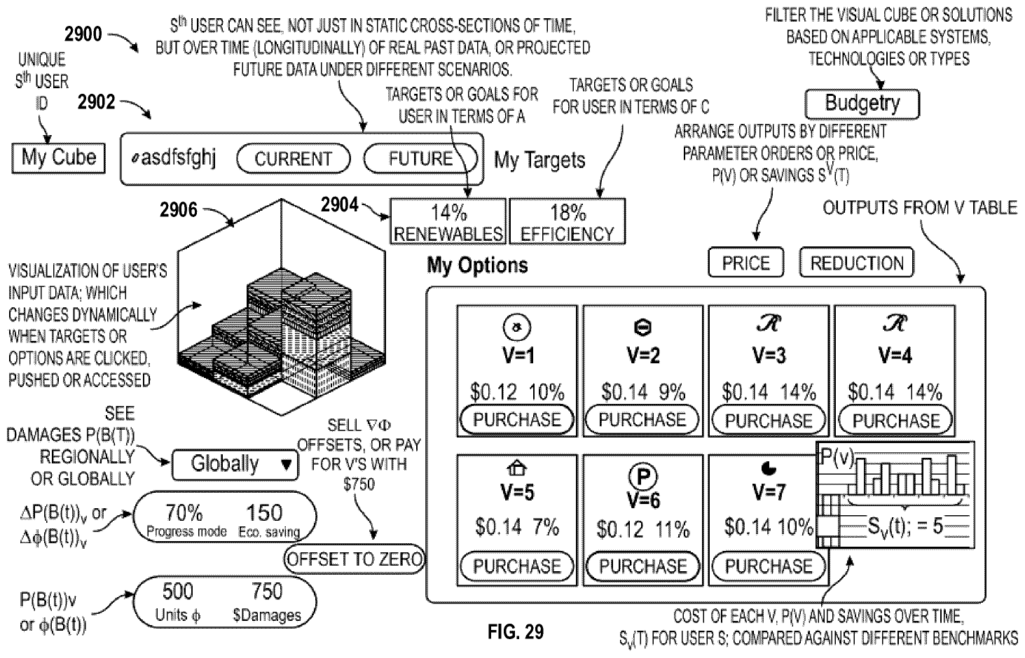

FIG. 29 presents a cost and savings user input 2900 that allows the user to input changes and dynamically visualize the past, present, and future changes to the allocation and costs. Visually, each of the changes to dials are reflected real-time on the interface via at least one of color, texture, and shape changes in the cube, (e.g. becoming more colorful as more progress is made). Additionally, the progress can be tracked numerically at numerical button 2902, and/or absolute Φ tracked at absolute button 2904. If the user is unable to buy solutions from the indicated v⁽ⁱ⁾, they could also offset the Φ amount, such as communicating with a higher-order entity with the purchasing power to buy solutions that colors the user's cube, or reduces their Φ. For example, this could be portions of a municipal bond or climate/green bond, that increases Δp^{T}(A) and reduces Δp^{T}(B) that is only possible after pooling offset resources from multiple users, or securitized and transacted as a tradable instrument. Further, all progress may be tracked for all customizable conditions past, present, and future at selection block 2906. An embodiment of such an interface is succinctly shown in FIG. 29.

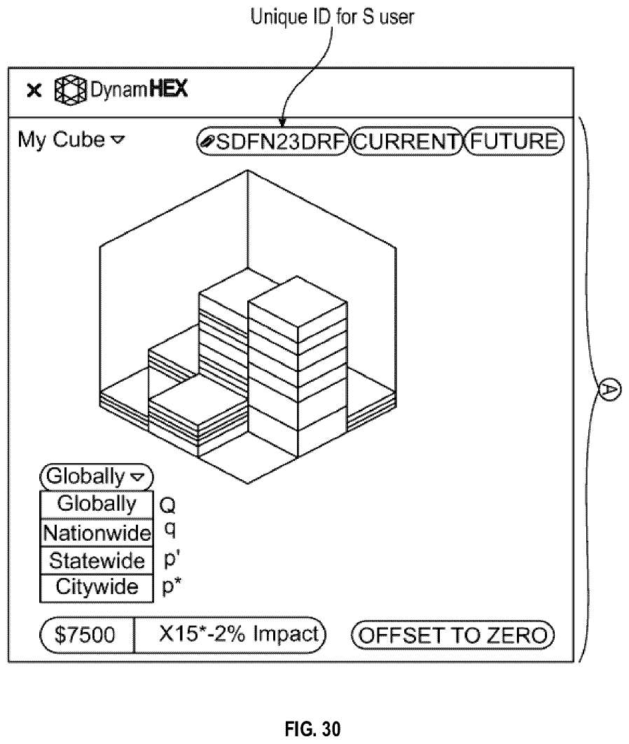

FIG. 30 depicts Any given user S can see the transformed visualization (200) of the cube and cubelets showing energy source consumption in each of the asset, R's (e.g., facility, home/building, vehicle, solution, load, etc.) owned by the user, S, with S-level unique code identifier, with the ability to aggregate based on locations of the asset(s)—city P*, state P′, national q or global Q, based on relational queries identified earlier.

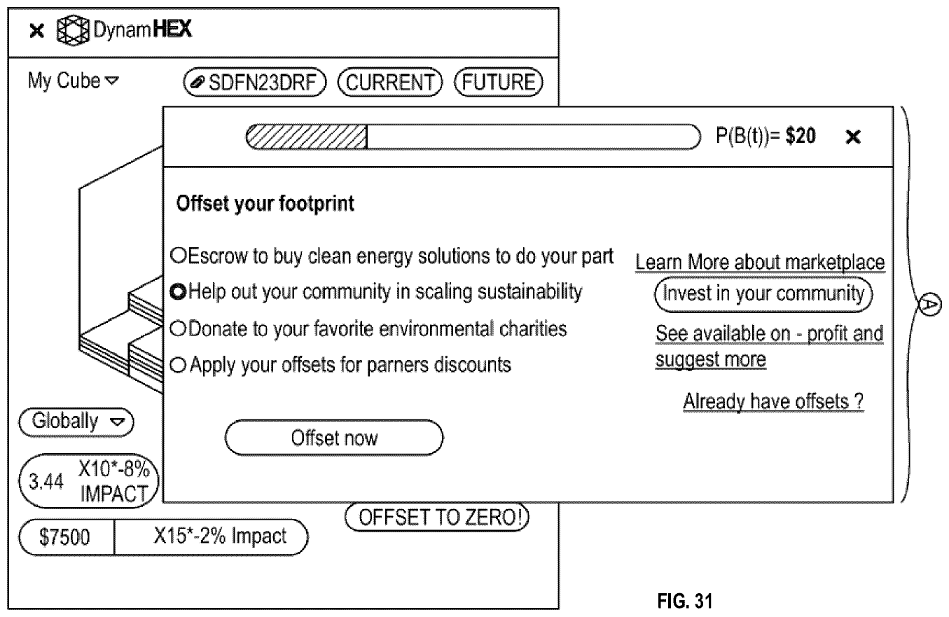

FIG. 31 depicts a user interface presenting data such that each user can understand the emissions Φ given their energy source visualization, and chose to either escrow the monetary amount, P(Φ) or P(B) in any given t in any currency to either (i) purchase relevant v solutions knowing the P(v) of each v solution, (ii) invest P(Φ) amount in community-level projects, either as a trackable donation or purchasing a security in an investment project, such as green bonds, (iii) make charitable donations of P(Φ) to other S entities, through unique alphanumeric IDs or (iv) buy carbon offsets or renewable energy credits in the amount of P(Φ) and get a discount code (another unique alphanumeric ID) from participating retailers.

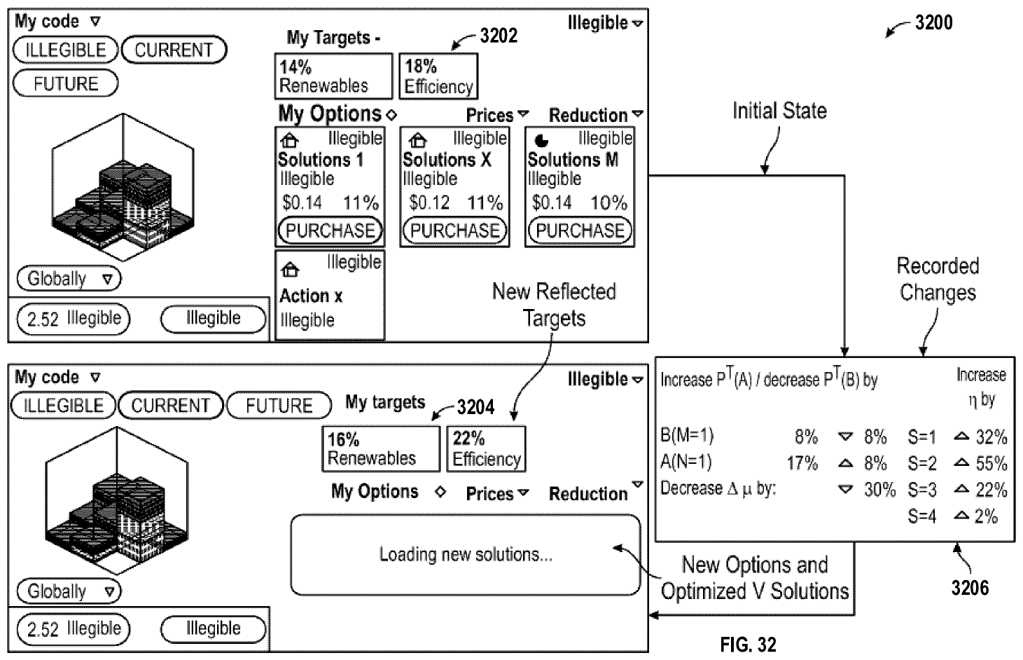

FIG. 32 depicts an exemplary user interface generally referenced by the numeral 3000. The targets 3202 for each user could be edited or updated by the user or by other entities with the ability, ownership or legal/regulatory authority to change to new or different targets. For example, FIG. 32 shows what happens when a user or other authorized entity increases Δp(A) by 2 percentage points, from 14% to 16%; and decrease Δp(B) by 4 percentage points from 18% to 22%; the individual user's interface can be dynamically automatically updated to reflect new goals, and each solution table can be similarly automatically updated to match new goals. The recorded changes are presented in box 3206.

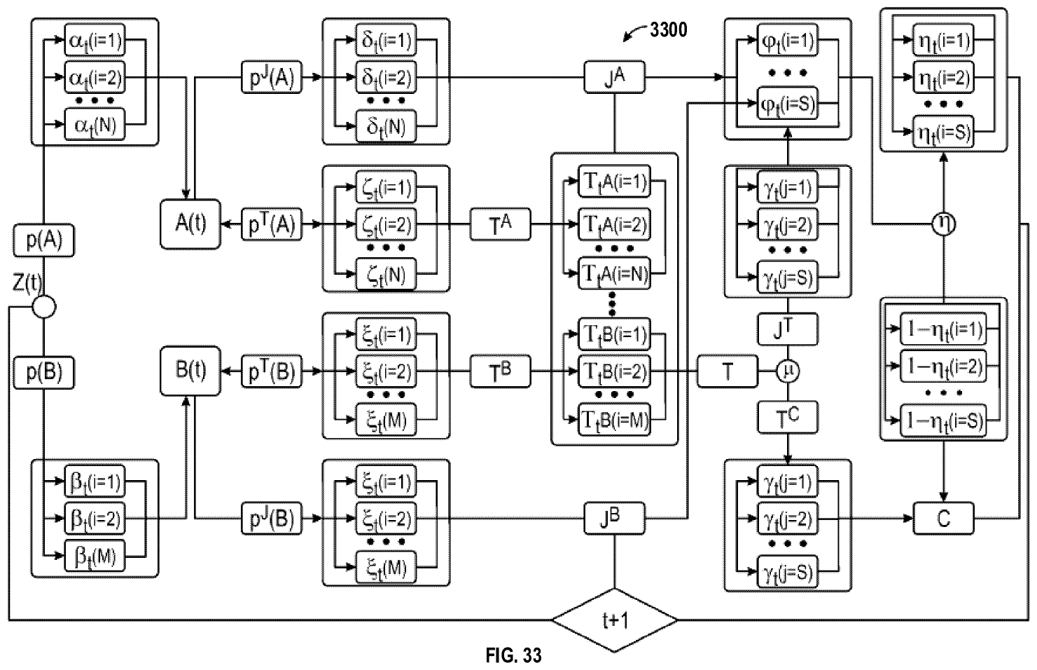

Turning now to FIG. 33, an alternative optimization algorithm is depicted and generally referenced by the numeral 3300. Starting from the previous optimization algorithm discussed above and ending at the starting point iteration of FIG. 11, then moving to an iterative process shown in FIG. 33 and described below, the system may then be generalized to a system such that A and B split into N and M sub-types A⁽¹⁾, . . . , A^{(N)} and B⁽¹⁾, . . . , B^{(M)}, such that

$$A = {\sum }_{i = 1}^{N} {A}^{( i )} and B = {\sum }_{i = 1}^{M} {B}^{( i )} .$$

### Further,

S consumption stages J⁽¹⁾, . . . , J^{(S)}, such that

$$J = {\sum }_{i = 1}^{S} {J}^{( i )} ,$$

T^{C} splits S stages, say T^{C}^{⁽¹⁾}, T^{C}^{^{(S)}} such that

$${T}^{C} = {\sum }_{i = 1}^{S} {T}^{{C}^{( i )}} ,$$

S actual-used portion E⁽¹⁾, . . . , E^{(S)}, such that

$$E = {\sum }_{i = 1}^{S} {E}^{( i )} ,$$

S wasted portion C⁽¹⁾, . . . , C^{(S)}, such that

$$C = {\sum }_{i = 1}^{S} {C}^{( i )} ,$$

The optimization problem comprises simultaneously maximizing the inflow from benign sources A⁽¹⁾, . . . , A^{(N)} and the outflow of utilized energy E⁽¹⁾, . . . , E^{(N)} and simultaneously minimizing the inflow from harmful sources B⁽¹⁾, . . . , B^{(M)} and the outflow of wasted energy C⁽¹⁾, . . . , C^{(N)} where A, E, B, and C are evaluated at each time (t). After k+1 iterations of the system, the program ends when the optimal solution is achieved. FIG. 31 depicts the flow process for achieving the optimal solution.

The inflow sources A and B depend on portion factors p(A) and p(B) such that p(A)+p(B)=1. Accordingly, p(A) comprises N components p(A(1)), . . . , p(A^{(N)}) and p(B) comprises M components p(B⁽¹⁾), . . . , p(B^{(M)}) such that

$$p ( A ) = {\sum }_{i = 1}^{N} p ( {A}^{( i )} ) and p ( B ) = {\sum }_{i = 1}^{M} p ( {B}^{( i )} ) .$$

Therefore, there exists N+M constants α⁽¹⁾, . . . , α^{(N)}, β⁽¹⁾, . . . , β^{(M)}, such that

$${A}^{( i )} = {\sum }_{i = 1}^{N} {α}^{( i )} p ( {A}^{( i )} ) Z and {B}^{( i )} = {\sum }_{i = 1}^{N} {β}^{( i )} p ( {B}^{( i )} ) Z .$$

$$p ( A ) + p ( B ) = {α}^{( 1 )} p ( A ) + … + {α}^{( N )} p ( A ) + {β}^{( 1 )} p ( B ) + … + {β}^{( M )} p ( B ) = 1$$

In order to maximize all quantities A⁽¹⁾, . . . , A^{(N)} and simultaneously minimize all quantities B⁽¹⁾, . . . , B^{(M)}, each component α⁽¹⁾p(A) should be maximized and each component β⁽¹⁾p(B) should be minimized. Because

$${\sum }_{i = 1}^{N} {α}^{( i )} = 1 and {\sum }_{i = 1}^{N} {β}^{( i )} = 1$$

the total quantity p(A) should be maximized and the total quantity p(B) should be minimized.

As described above, the flows go to the transformation step T, portions of which are represented by

$$T = {\sum }_{i = 1}^{N} {T}^{{A}^{( i )}} + {\sum }_{i = 1}^{N} {T}^{{B}^{( i )}} .$$

Accordingly, the proportion factors of the flow p^{T}(A) and p^{T}(B) split into p^{T}(A⁽¹⁾), . . . , p^{T}(A^{(N)}) and p^{T}(B⁽¹⁾), . . . , p^{T}(B^{(M)}) where p^{T}(A⁽ⁱ⁾)=ζ⁽ⁱ⁾p^{T}(A) and p^{T}(B⁽ⁱ⁾)=ζ⁽ⁱ⁾p^{T}(B) at every time (t) and for N+M proportion factors ζ⁽¹⁾, . . . , ζ^{(N)} and ζ⁽¹⁾, . . . , ζ^{(N)} such that

$${\sum }_{i = 1}^{N} {ζ}^{( i )} = 1 and {\sum }_{i = 1}^{N} {ξ}^{( i )} = 1 .$$

Therefore, T^{A}=ζ⁽ⁱ⁾p^{T}(A)T and T^{B}=ζ⁽ⁱ⁾p^{T}(B)T. Therefore,

$${p}^{T} ( A ) + {p}^{T} ( B ) = {ζ}^{( 1 )} {p}^{T} ( A ) + … + {ζ}^{( N )} {p}^{T} ( A ) + {ζ}^{( 1 )} {p}^{T} ( B ) + … + {ζ}^{( M )} {p}^{T} ( B ) = 1$$

Therefore, the transformation portions should be maximized and minimized accordingly. Specifically, the transformation portion of the inflow from benign sources p^{T}(A) should be maximized and the transformation portion of the inflow from harmful sources p^{T}(B) should be minimized.

At transformation step T at time (t) the inflow from benign sources and the inflow from harmful sources is mixed, then separated again into S components T⁽¹⁾, . . . , T^{(S)}, where total transition is

$$T = {\sum }_{j = 1}^{S} {T}^{( j )} .$$

Therefore, each T⁽ⁱ⁾ is a portion of T represented by proportion factors γ⁽¹⁾, . . . , γ^{(S)}. So, the total ideal transformation step may be represented by:

$$T = {γ}^{( j )} ( {\sum }_{i = 1}^{N} {T}^{{A}^{( i )}} + {\sum }_{i = 1}^{N} {T}^{{B}^{( i )}} ) = {\sum }_{i = 1}^{N} {γ}^{( j )} {ζ}^{( i )} {p}^{T} ( A ) T + {\sum }_{i = 1}^{M} {γ}^{( j )} {ξ}^{( i )} {p}^{T} ( B ) T$$

Further, the transformation step T has a transformation efficiency factor represented by μ(t), where it separates a wasted portion T^{C}(t)=μ(t)T, to C. The used portion J^{T} is consumed along with the direct flow A from benign sources and the direct flow B from harmful sources called J^{A} and J^{B} respectively which are dependent on the portion factors p^{J}(A) and p^{J}(B). The total used flow may be represented by J=J^{A}+J^{B}+J^{T}.

There exists S efficiency components μ⁽¹⁾, . . . , μ^{(S)} with corresponding proportion factors Ξ⁽¹⁾, . . . , Ξ^{(S)} where

$${\sum }_{j = 1}^{S} {Ξ}^{( j )} = 1 ,$$

such that the total eniciency factor is represented by

$$μ ( t ) = {\sum }_{j = 1}^{S} {Ξ}^{( j )} μ ( t ) .$$

For all j=1, . . . , S, the transformation loss is:

$${T}^{{C}^{( j )}} = {μ}^{( j )} T = {Ξ}^{( j )} ( t ) {γ}^{( j )} ( {\sum }_{i = 1}^{N} {p}^{T} ( A ) T ) + {Ξ}^{( j )} ( t ) {γ}^{( j )} ( {\sum }_{i = 1}^{M} {p}^{T} ( B ) T )$$

$$and$$

$${J}^{T ( j )} = ( 1 - {μ}^{( j )} ) T = ( 1 - {Ξ}^{( j )} μ ( t ) ) {γ}^{( j )} ( {\sum }_{i = 1}^{N} {p}^{T} ( A ) T ) + ( 1 - {Ξ}^{( j )} μ ( t ) ) {γ}^{( j )} ( {\sum }_{i = 1}^{M} {p}^{T} ( B ) T )$$

In order to maximize the inflow from benign sources A⁽¹⁾, . . . , A^{(j)} and the outflow of utilized energy E⁽¹⁾, . . . , E^{(j)} and minimize the inflow from harmful resources B⁽¹⁾, . . . , B^{(j)} and the outflow of wasted energy C⁽¹⁾, . . . , C^{(j)} each parameters μ⁽¹⁾, . . . , μ^{(j)} should be minimized.

Further, J^{T}^{^{(j)}} may be written as,

$${T}^{{C}^{( j )}} = {T}^{A {C}^{( j )}} + {T}^{B {C}^{( j )}} = {\sum }_{i = 1}^{N} {μ}^{( j )} ( t ) {γ}^{( j )} {ζ}^{( i )} {p}^{T} ( A ) T + {\sum }_{i = 1}^{M} {μ}^{( j )} ( t ) {γ}^{( j )} {ξ}^{( i )} {p}^{T} ( B ) T$$

The proportion factors of J^{A} and J^{B}, p^{J}(A) and p^{J}(B) may be split into N and M components respectively, so there exists δ⁽¹⁾, . . . , δ^{(N)} and ∈⁽¹⁾, . . . , ∈^{(M)} such that

$${\sum }_{i = 1}^{N} {δ}^{( i )} = 1 and {\sum }_{i = 1}^{N} {∈}^{( i )} = 1$$

and δ⁽¹⁾p^{J}(A)=p^{J}(A⁽ⁱ⁾) for every i=1, . . . , N and ∈⁽ⁱ⁾p^{J}(B⁽ⁱ⁾)=(B⁽¹⁾) for every i=1, . . . , M. Therefore,

$${p}^{J} ( A ) + {p}^{J} ( B ) = {δ}^{( 1 )} {p}^{J} ( A ) + … + {∈}^{( N )} {p}^{J} ( A ) + {∈}^{( 1 )} {p}^{T} ( B ) + … + {∈}^{( M )} {p}^{J} ( B ) = 1$$

### Consequently,

$${J}^{{A}^{( i )}} = ( Z - T ) {p}^{J} ( {A}^{( i )} ) = ( Z - T ) {δ}^{( i )} {p}^{J} ( A ) for all i = 1 , … , N .$$

$${J}^{{B}^{( i )}} = ( Z - T ) {p}^{J} ( {B}^{( i )} ) = ( Z - T ) {∈}^{( i )} {p}^{J} ( B ) for all i = 1 , … , M .$$

Because the consumption stage is represented by J=J^{A}+J^{B}+J^{T}, then

$$J = ( {\sum }_{i = 1}^{N} ( Z - T ) {δ}^{( i )} {p}^{J} ( A ) ) + ( {\sum }_{i = 1}^{M} ( Z - T ) {∈}^{( i )} {p}^{J} ( B ) ) + ( {\sum }_{i = 1}^{S} {γ}^{( i )} ( 1 - {μ}^{( i )} ( t ) ) T ) .$$

Further, J can be written as the sum of S components J⁽¹⁾, . . . ,J^{(S)}, with proportion factors Φ⁽¹⁾, . . . , Φ^{(S)}. As such, any k-th component can be written as,

$${J}^{( k )} = {Φ}^{( k )} J = {Φ}^{( k )} [ ( {\sum }_{i = 1}^{N} ( Z - T ) {δ}^{( i )} {p}^{J} ( A ) ) + ( {\sum }_{i = 1}^{M} ( Z - T ) {∈}^{( i )} {p}^{J} ( B ) ) + ( {\sum }_{i = 1}^{S} {γ}^{( i )} ( 1 - {μ}^{( i )} ( t ) ) T ) ]$$

Further still, the consumption stage J comprises a consumption efficiency factor η(t), where the actual used portion E is separated from the remaining wasted portion C. There are S portion factors θ⁽¹⁾, . . . , θ^{(S)}, such that

$${\sum }_{j = 1}^{S} {η}^{( j )} ( t ) = {\sum }_{j = 1}^{S} {θ}^{( j )} η ( t ) .$$

Throughout the example, S is used as an arbitrary index to denote the number of J's. In earlier derivations, the system considered 4 J's, such as (1) residential homes, (2) commercial, (3) industrial businesses, and (4) transportation, as shown in FIGS. 2 and 4, but S could also represent, beyond Js each constituent or disaggregated R's, across Xⱼ and Gⱼ, but also aggregated locations p's, to show the energy flow and subsequent optimization in any given time. J variable could thus be replaced by other such variables, do derive energy flow, and related maximization and minimization of assets, systems, or regions from microseconds to year-long time intervals.

In conclusion, the following series of equations are provided.

$$Z = E + C$$

$$E = {\sum }_{k = 1}^{S} {E}^{( k )} = {\sum }_{k = 1}^{S} {η}^{( k )} ( t ) J = {\sum }_{k = 1}^{S} {θ}^{( k )} η ( t ) J$$

$$C = {\sum }_{k = 1}^{S} {C}^{( k )} = {\sum }_{k = 1}^{N} ( ( 1 - {η}^{( k )} ( t ) ) J + {T}^{{C}^{( k )}} )$$

Therefore, to maximize the outflow of utilized energy E, consumption efficiency factor η^{(k)}(t) should be maximized.

The optimization solution shown above may be visualized in any of the visualization methods provided in regards to the above-described optimization and visualization embodiments. Further, any combination of the visualizations of the optimization problems may be displayed. In some embodiments, the optimization methods may be displayed together.

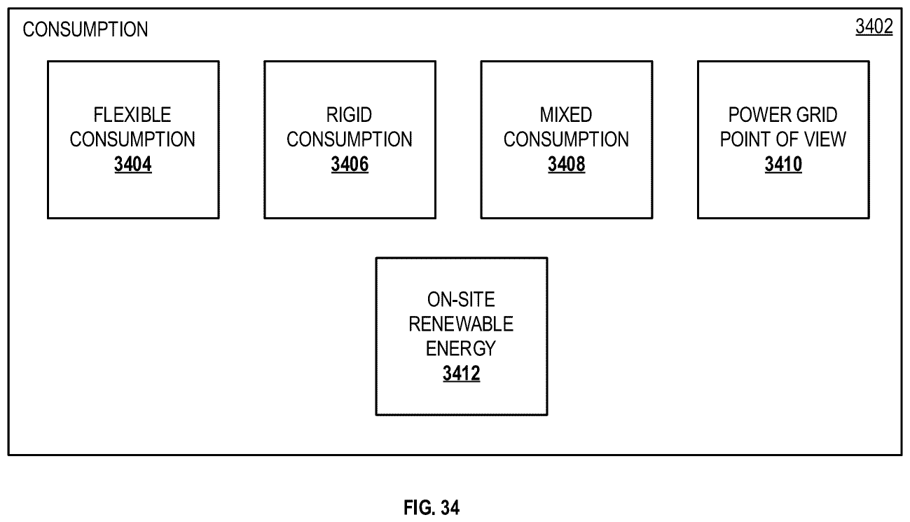

FIG. 34 shows example components of consumption 3402 (e.g., consumption data). As an example, a process may be implemented to maximize A energy (e.g., renewable energy) based on the throughput flow p(A) associated with flow type J^{A} and minimize B energy (e.g., non-renewable energy) based on the throughput flow p(B) associated with flow type J^{B}, with the ultimate outcome to minimize Φ emissions (e.g., ΔΦ) over time T. For example, a generalized down-selection process may be implemented that lets the j^{th} consumers of E energy, to access vs based on cost and time restrictions. β may represent a climate return-on-investment, which may include Φ emissions reduced per dollar spent, as well as a γ, a time-dependency. As an example, two sources of energy may be implemented, a renewable energy source and a non-renewable energy source. Since the renewable source may not usually meet the demand, the non-renewable source may need to be implemented, which may contribute to carbon emissions. Thus, energy consumption may be modified in order to minimize emissions. Thus, consumption may be analyzed and broken into one or more components comprising flexible consumption 3404, rigid consumption 3406, mixed consumption 3408, a power grid's point of view 3410, and an on-site renewable energy source 3412.

One or more variables may comprise one or more of the following:

T=24 hours or whatever is the time period we are working over.

E(t)=rate of energy consumption at time t.

E_{A}=total energy required in [0, T].

E_{A}(t)=renewable energy supply rate at time t.

E_{B}=total non-renewable energy supply in [0, T].

E_{B}(t)=non-renewable energy supply rate at time t.

Γ_{A} and Γ_{B} are emission factors. For renewable energy IA =0.

ϕ(t)=rate of emission at time t. ϕ(t)=Γ_{B}E_{B}(t) as Γ_{A}=0.

$$Φ ( s ) = {\int }_{0}^{s} ϕ ( t ) ( dt ) ,$$

total emissions until time s.

Φ=Φ(T)=Γ_{B}·E_{B}, that is the total emissions over the time period T.

$$α ( t ) = \frac{{E}_{A} ( t )}{E ( t )} ,$$

which comprises a discrepancy ratio that indicates how much energy demand at any instant can be met using renewable sources.

In addition, one or more assumptions may be made:

Minimize Φ.

The e total renewable energy supply is less than the total energy required (e.g., E_{A}<E)

E_{B}(t) may denote the non-renewable energy consumption at time t since non-renewable energy supply is unconstrained.

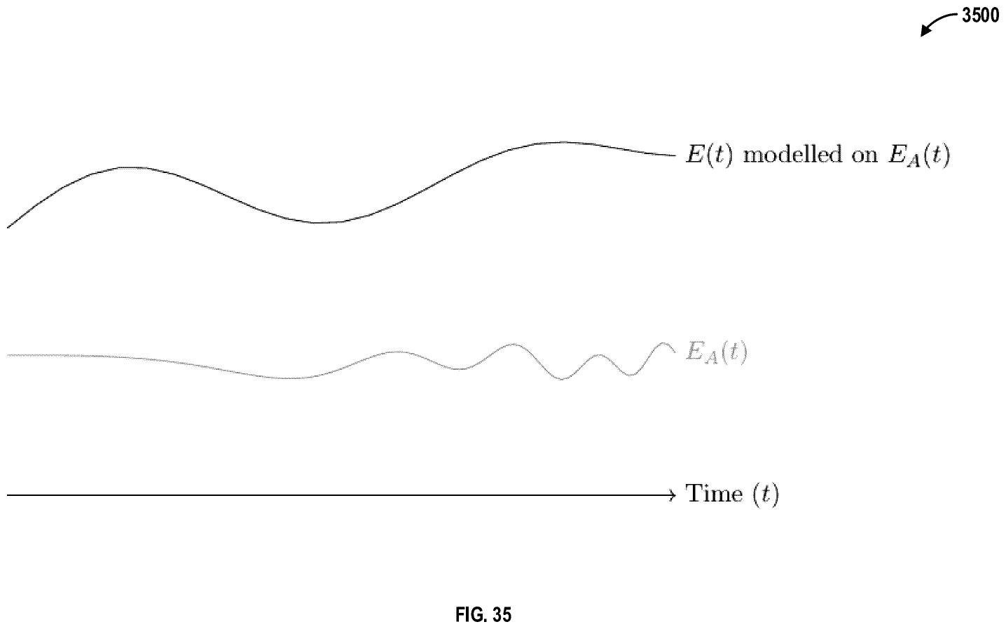

Regarding flexible consumption 3404, it may be assumed that the renewable energy supply (e.g., E_{A}(t)) is known and that demand is completely flexible (e.g., complete control over energy consumption pattern), as shown in FIG. 35. For minimum Φ, a constant discrepancy ratio may be provided at all times such that α(t)=α, and thus, E_{A}(t)=α·E(t). Thus, consumption may be proportionately changed in line with the available supply of renewable energy. For example, Φ=Γ_{B}E_{B} =(1−α)Γ_{B}E. For example, the closer α is to 1, emissions decrease. As shown in FIG. 35, the total energy E(t) may be modulated based on an available E_{A}(t). As an example, to minimize Φ, the flexibility in demand E(t) may be utilized to use as much of E_{A} as possible. For example, if E_{A}(t) is higher than E(t), excess E_{A} may be stored such that when a trend of increasing emissions reverses, E(t) may be use the stored EA instead of using E_{B}.

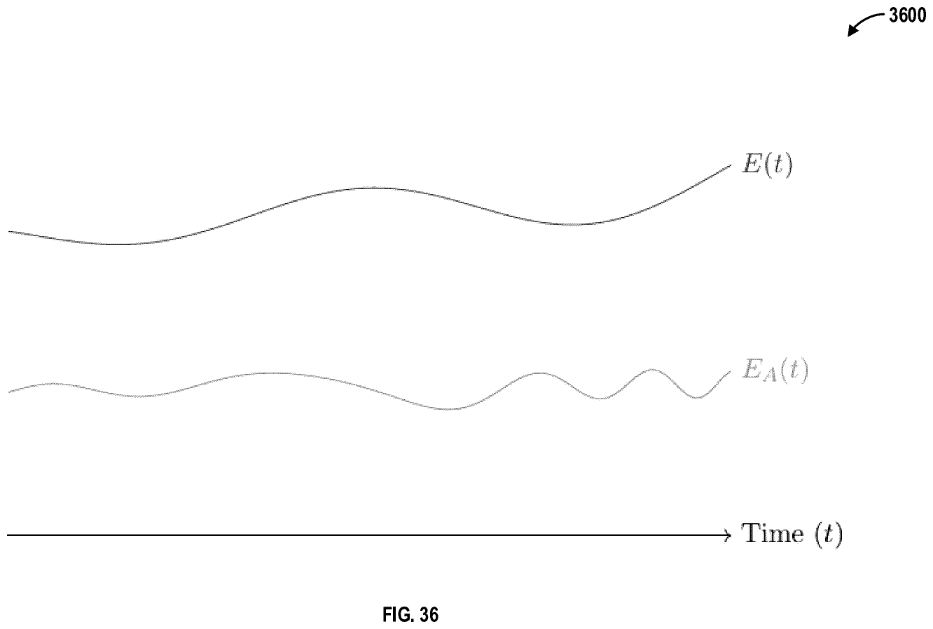

Regarding rigid consumption 3406, it may be assumed that the renewable energy supply (e.g., E_{A}(t)) is known and that demand is completely rigid (e.g., no control over energy consumption pattern), as shown in FIG. 36. Thus, ϕ(t)=Γ_{B}E_{B}(t)=Γ_{B}[E(t)−E_{A}(t)]=Γ_{B}E(t)[1−α(t)] and Φ=Γ_{B}E_{B}. In an example, if E_{A}(t) it is out of sync with the demand E(t), emissions may still be high even if the total renewable energy supply EA is close to E. Thus, excess energy may be stored in one or more batteries when α(t)<1.

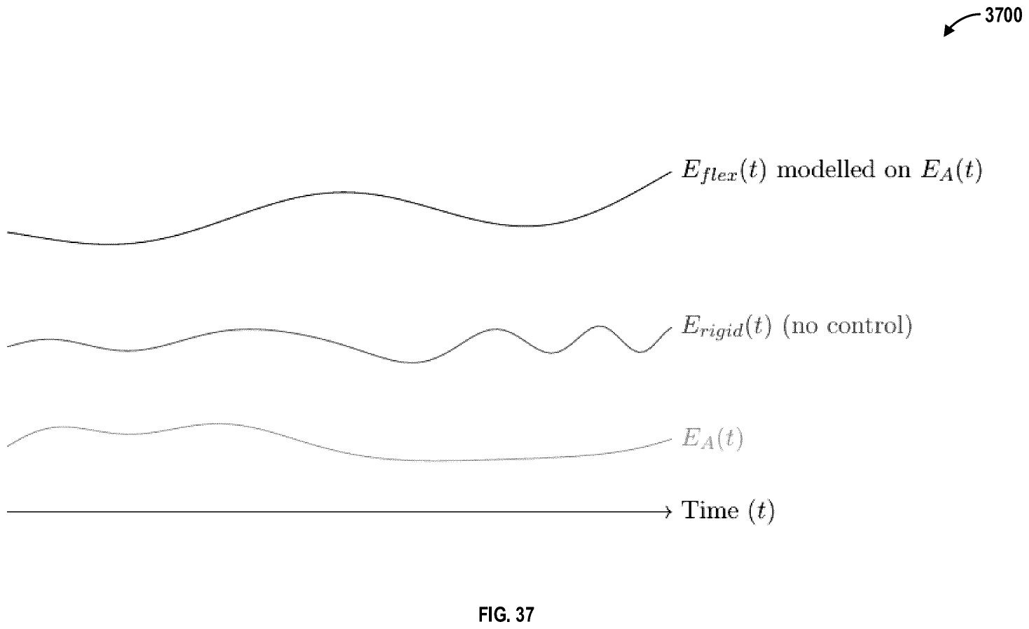

Regarding rigid consumption 3408, it may be assumed that the renewable energy supply (e.g., E_{A}(t)) is known and that demand is only partially flexible, as shown in FIG. 37. For example, E_{flex} may be proportion to the renewable energy supply (e.g.,

E_{flex}(t)∝E_{A}(t)). For example, depending on whether E_{flex}(t)≤E_{A}(t), any necessary supply may be met by E_{B}(t). However, if E_{A}(t)>E(t), that is α(t)>1, may cause a trigger to charge one or more batteries. In an example, when the total E_{A} over a time period is more than the energy demand E over the time period (e.g.,

$${\int }_{{t}_{1}}^{{t}_{2}} {E}_{A} ( t ) dt > {\int }_{{t}_{1}}^{{t}_{2}} E ( t ) dt ) ,$$

the one or more batteries may be triggered to charge. As an example, given an entity's known E (e.g., flex, rigid or a combination of both), since E_{flex} cannot be controlled, E_{A} scenario and modulates may be monitored, and since E_{rigid} is un-changeable, the entity may be at the mercy of A/B at any given time.

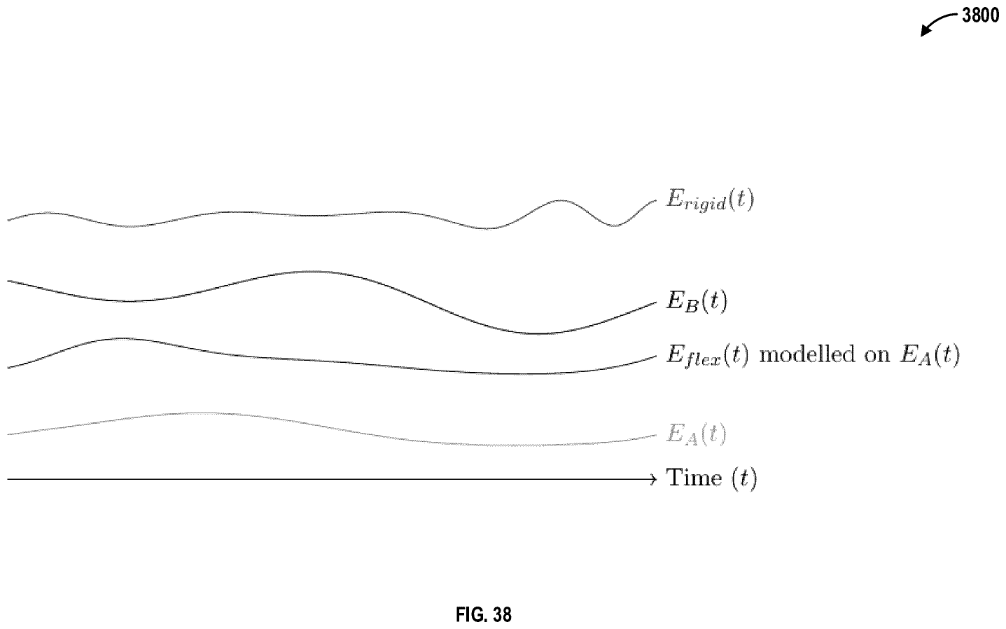

Regarding the point of view from the power grid 3410, it may be assumed that the renewable energy supply (e.g., E_{A}(t)) is known and that demand is only partially flexible, as shown in FIG. 38. For example, E^{B}(t)=E^{rigid}(t)+E^{flex}(t)(1−α), where

$$α = \frac{{E}_{A} ( t )}{{E}_{flex} ( t )} .$$

As an example, as shown in FIG. 38, E_{rigid} and E_{flex} may comprise two components, and at any given time, the E_{B} and E_{A} may comprise known distributions, so the entity can maximize A (and minimize Φ) by filling E_{A} to be on E_{flex}, and storing overages to meet E_{rigid} or dispatch from batteries to meet E_{flex} (minimized) while dispatching all available E_{A} to E_{rigid} in order to fill E_{rigid} with E_{B}.

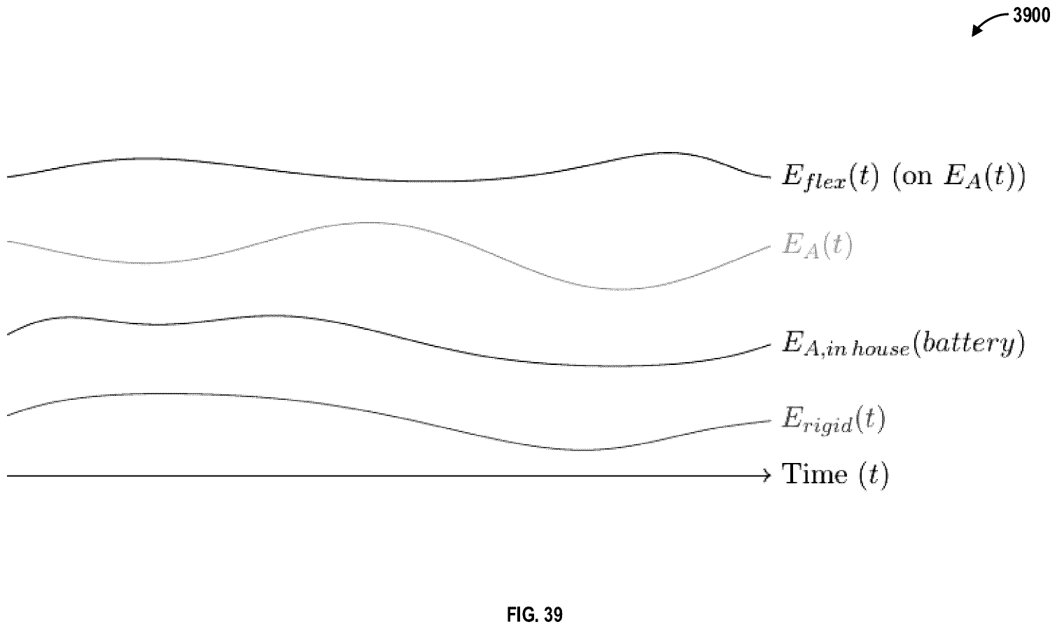

Regarding the on-site renewable energy source 3412, it may be assumed that E_{rigid}(t) is known, that the renewable energy supply (e.g., E_{A}(t)) is known, and that demand is only partially flexible, as shown in FIG. 39. For example, E_{rigid}(t) may be used to model the on-site renewable energy E_{A,on-site}(t) (e.g., using batteries for storing excess E_{A}). As an example, on-site renewable energy is usually small compared to grid supply, and thus, E_{flex}(t) may be modeled on E_{A,grid}, wherein E_{A}, on-site is comparable to E_{A,grid}. For example, E_{flex}(t)∝E_{A,total}=E_{A,on-site}+E_{A,grid}. As an example, for small E_{rigid} and high E_{flex}, E_{A,on-site} may be utilized to satiate rigid component while ramping down E_{flex} to maximize E_{A}.

Thus, one or more triggers may be used to charge or discharge the one or more batteries. For example, α(t)≥1 may trigger the one or more batteries to be charged and α(t)<0.9 may trigger the one or more batteries to discharge, wherein the one or more batteries may idle if 0.9≤α(t)≤1. In example, instead of using the point-wise values of α, an average α value may be calculated on anticipated demand. For example, [0,T] may be divided into four blocks of time. For example, for the first block,

$${α}_{1} = \frac{renewable energy supply expected in [ 0 , \frac{T}{4} ]}{total energy demand expected in [ 0 , \frac{T}{4} ]}$$

and similarly α₂, α₃, and α₄. Thus, for

$$[ 0 , \frac{T}{4} ] , {α}_{1} \geq 1$$

may trigger the one or more batteries to be charged and α₁<0.9 may trigger the one or more batteries to discharge, wherein the one or more batteries may idle if 0.9≤α₁≤1, and similarly for α₂, α₃, and α₄. As an example, if an on-site renewable energy source is present, the on-site renewable energy may be used proportionally to meet rigid energy demand E_{rigid}(t). However, if not, the flexible energy demand E_{flex}(t) may be distributed in proportion to the renewable energy supply E_{A}(t). The remaining demand deficit may be met by using the non-renewable supply E_{B}(t).

As an example, given one or more restrictions on budget and energy supply schemes, a consumption schemed may be implemented to lower emissions. P′ I may denote the total budget for the energy consumption in the time period [0, T]. In addition, P_{A}(t) may denote the price for the unit of renewable (A) and P_{B}(t) may denote the non-renewable (B) energy at time t. Thus, the total price for energy consumption in time period [0, T] may be computed as:

$$P := {\int }_{0}^{T} {P}_{A} ( t ) {e}_{A} ( t ) dt + {\int }_{0}^{T} {P}_{B} ( t ) {e}_{B} ( t ) dt , \qquad ( 42 )$$

where e_{A}(t) denotes a rate of consumption of renewable (A) and e_{B}(t) denotes rate of consumption of non-renewable (B) energies at time t. There is a constraint on the total price, expressed as P≤P′, where P′ is some fixed amount. It is assumed that supply schemes of renewable (A) and non-renewable (B) energies, denoted by E_{A}(t) and E_{B}(t) respectively, are a priori given. Furthermore, at any given moment of time t, at least E_{rigid}(t) of energy has to be consumed and over the time period [0, T] at least

$${E}_{flex} + {\int }_{0}^{T} {E}_{rigid} ( t ) dt$$

of energy has to be consumed. For example, these conditions may be expressed as

$${e}_{A} ( t ) + {e}_{B} ( t ) \geq {E}_{rigid} ( t ) , \qquad ( 43 )$$

$${\int }_{0}^{T} {e}_{A} ( t ) + {e}_{B} ( t ) dt \geq {E}_{flex} + {\int }_{0}^{T} {E}_{rigid} ( t ) dt$$

Under the constraint P≤P′ on total price and the constraints (43) on the energy consumption, total emissions may be minimized. For example:

$$Φ := {\int }_{0}^{T} ϕ ( t ) dt + {\int }_{0}^{T} {Γ}_{{B}^{e} B} ( t ) dt \qquad ( 44 )$$

where Γ_{B} denotes the emission factor of the non-renewable energy and ϕ(t)=Γ_{B}_{^{e}}_{B}(t) is the emission scheme (e.g., the emission factor Γ_{A} of the renewable energy is zero). Since the emission factor Γ_{B} is constant in time, the task is equivalent to solving the following optimization problem:

$${\int }_{0}^{T} {e}_{B} ( t ) dt \to min \qquad ( 45 )$$

$${\int }_{0}^{T} {P}_{A} ( t ) {e}_{A} ( t ) + {P}_{B} ( t ) {e}_{B} ( t ) dt \leq {P}^{′} ,$$

$$so that {e}_{A} ( t ) + {e}_{B} ( t ) \geq {E}_{rigid} ( t ) ,$$

$${\int }_{0}^{T} {e}_{A} ( t ) + {e}_{B} ( t ) dt \geq {E}_{flex} + {\int }_{0}^{T} {E}_{rigid} ( t ) dt .$$

Thus, consumption of non-renewable energy may be minimized while keeping expenses under control and fulfilling (flexible and rigid) consumption constraints.

In an example, t=k with k=0, 1, 2, . . . , T. Thus, problem (45) may be re-written as:

$${\sum }_{k = 0}^{T} {e}_{B} [ k ] \to min \qquad ( 46 )$$

$${\sum }_{k = 0}^{T} {P}_{A} [ k ] {e}_{A} [ k ] + {P}_{B} [ k ] {e}_{B} [ k ] \leq {P}^{′} ,$$

$$so that {e}_{A} [ k ] + {e}_{B} [ k ] \geq {E}_{rigid} [ k ] ,$$

$${\sum }_{k = 0}^{T} {e}_{A} [ k ] + {e}_{B} [ k ] \geq {E}_{flex} + {\sum }_{k = 0}^{T} {E}_{rigid} [ k ] ,$$

where naturally f[k]:=f(k) for any function f: [0, T]→R. The general optimization problem (45) becomes a linear program (46), which can be solved efficiently via, e.g., a constraint minimization function. In an example, the expenses may be minimized subject to a constraint in order to meet an emissions reduction. For example, budget constraints may be considered for meeting emissions reductions. The target function

$${\sum }_{k = 0}^{T} {e}_{B} [ k ]$$

is linear in the vector e_{B}=(e_{B}[0], e_{B}[1], . . . , e_{B}[T]) that encodes the consumption scheme of the non-renewable energy, while the constraints are linear in both e_{A}=(e_{A}[0], e_{A}[1], . . . , e_{A}[T]) and e_{B}=(e_{B}[0], e_{B}[1], . . . , e_{B}[T]), since P′, E_{flex} and E_{rigid}=(E_{rigid}[0], E_{rigid}[1], . . . , E_{rigid}[T]) are a priori fixed.

In an example, one or more entities (e.g., businesses, organizations, etc.) consuming E_{A} or E_{B} across time T may implement one or more solutions v's (e.g., implementations associated with one or more energy sources) for modifying an amount of energy consumption, for each entity, from non-renewable energy sources to renewable energy sources (e.g., a power grid, one or more batteries, one or more solar panels, one or more computing devices configured to control energy consumption, etc.). For example, the one or more solutions v's for modifying the amount of energy consumption, for each entity, from non-renewable energy sources to renewable energy sources may be associated with potential implementations associated with each energy source of one or more energy sources. The potential implementations associated with each energy source may comprise one or more of upgrades to the energy source in a power system or additions of the energy source to a power consumption system. The one or more energy sources may comprise one or more of a power grid, one or more batteries, one or more wind turbines, one or more boilers, one or more solar panels, or a device controlling consumption.

As an example, an S-curve does not need to be considered because: (1) the entity is concerned about the decrease as a result using one or more solutions v's; and (2) information from the S-curve is already being used by another entity in a form of the pCROI coefficient β used to rank the one or more solutions v's because in the calculation of the pCROI coefficient B, the information from the S-curve may be used. In addition, a γ coefficient may be calculated that can be used to rank products, used for the one or more solutions v's, on the basis for emission reduction in fastest time in contrast to the pCROI coefficient's β's ranking of products, used for the one or more solutions v's, on basis of emission reduction potential per dollar spent

$$( e . g . , \frac{ΔΦ}{Pv} ) .$$

For example, β may comprise an emission reduction potential per investment associated with a number of potential implementations associated with each energy source to be implemented in a time period. For example, y may comprise an emission reduction potential per time interval associated with a number of potential implementations associated with each energy source to be implemented in a time period.

The pCROI coefficient β is a measure of effectiveness of a solution v via investments or purchases made into the solution v in reducing/curbing emissions. Thus,

$$β = \frac{emission reduction potential}{initial investment ( {I}_{v} )} .$$

The γ coefficient is a measure of how quickly one or more products, used for the one or more solutions v′s. Thus,

$$γ = \frac{emission reduction potential}{T}$$

The mission reduction potential may be the total amount of reduction in emissions that the solution v (or ΔΦ) can bring about.

One or more variables may comprise one or more of the following:
t may denote year, wherein t<T, wherein T is a large year horizon.
Φ_{B}(t)=emissions without using a solution v
M is the maximum number of solutions v (e.g., potential implementations) that can be deployed over the time horizon T.
ΔΦ^{M}(t)=Φ_{B}(t)−Φ_{A}(t) is an emission reduction via a solution v for fixed value of M.
rᵥ(t) is the number of v being used in the year t.
sᵥ(t) is the number of v sold in the year t.
t_{1/2} is the half-life or the time it will take to sell a total of M/2 products.
k is the slope and measures how swiftly the v are adopted.
δᵥ(t) is the estimated reduction due to a single solution v sold in the year t, wherein δᵥ(t) may decrease with t.

As an example, an adoption of a solution v may be estimated by one or more S-curves. Thus,

$${r}_{v} ( t ) = \frac{M}{1 + {e}^{- k ( t - {t}_{1 / 2} )}}$$

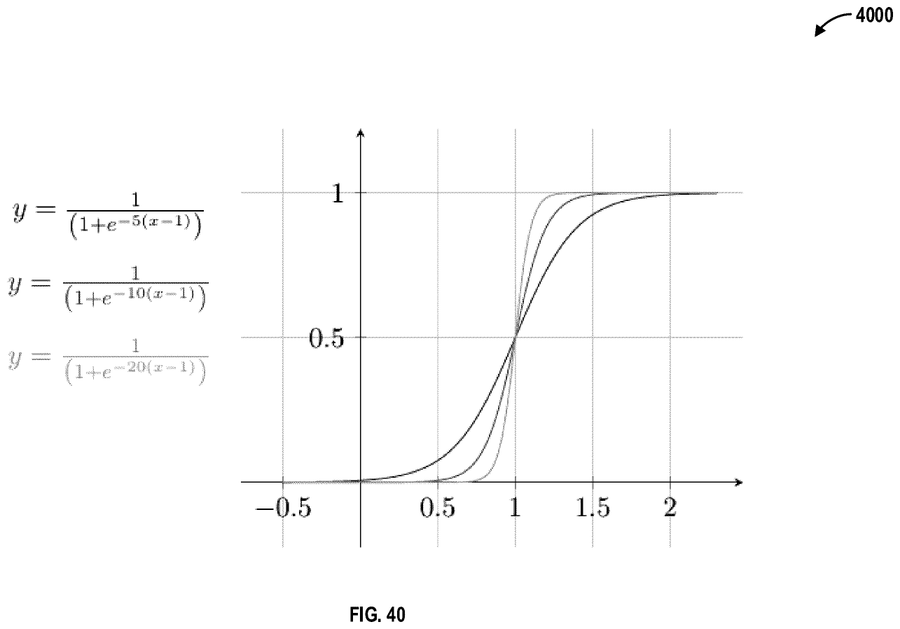

FIG. 40 shows example S-curves with different values of k but fixed t_{1/2}=1, M=1. As shown in FIG. 40, solution v marginally increases when going from t→t+1. For example,

$${s}_{v} ( t + 1 ) = {{r}_{v} ( t + 1 )}_{t} - {r}_{v} ( t ) \approx k \cdot \frac{{e}^{- k ( t - {t}_{1 / 2} )}}{M} \cdot {{r}_{v} ( t )}^{2} ,$$

wherein k measures how swiftly a solution v is adopted. Thus, a reduction in emission in year t by using solution v may comprise sᵥ(t)·δᵥ(t), and thus, the total reduction in emissions by year T may comprise

$${Δ}^{M} Φ ( T ) = {\sum }_{t = 0}^{T} {s}_{v} ( t ) \cdot {δ}_{v} ( t ) = {\sum }_{t = 0}^{T} {δ}_{v} ( t ) \cdot k \cdot \frac{{e}^{- k ( t - {t}_{1 / 2} )}}{M} \cdot {{r}_{v} ( t )}^{2} ,$$

wherein the above equation may be simplified as

$${Δ}^{M} Φ ( T ) = {\sum }_{t = 0}^{T} {δ}_{v} ( t ) \cdot k \cdot {e}^{- k ( t - {t}_{1 / 2} )} \cdot \frac{M}{{[ 1 + {e}^{- k ( t - {t}_{1 / 2} )} ]}^{2}} ,$$

the γ coefficient for the solution v is

$$γ ( v ) = \frac{{Δ}^{M} Φ ( T )}{T} = \frac{1}{T} \cdot {\sum }_{t = 0}^{T} {δ}_{v} ( t ) \cdot k \cdot {e}^{- k ( t - {t}_{1 / 2} )} \cdot \frac{M}{{[ 1 + {e}^{- k ( t - {t}_{1 / 2} )} ]}^{2}} ,$$

and for an initial investment of Iᵥ the pCROI β coefficient is

$$β = \frac{1}{{I}_{v}} \cdot {\sum }_{t = 0}^{T} {δ}_{v} ( t ) \cdot k \cdot {e}^{- k ( t - {t}_{1 / 2} )} \cdot \frac{M}{{[ 1 + {e}^{- k ( t - {t}_{1 / 2} )} ]}^{2}}$$

As an example, each solution v may be ranked based on β or γ. For example, each solution will have two ranks, one on the basis of B and the other on the basis of γ. The one or more solutions v's may be sorted based on the rank of each solution v. In an example, highest ranked solution may be implemented. In another example, a highest ranked number of solutions (e.g., the top 5, 10, 15, 20, etc.) may be implemented.

In order to reduce emissions, several alternative resources (e.g., sources of energy) may be increasingly being utilized, such as wind, solar, etc., which produce smaller amounts of emissions (e.g., low, or zero, emissions). For example, to reduce emissions, an entity may implement a process to maximize A energy (e.g., renewable energy) based on the throughput flow p(A) associated with flow type J^{A} and minimize B energy (e.g., non-renewable energy) based on the throughput flow p(B) associated with flow type J^{B}, with the ultimate outcome to minimize Φ emissions (e.g., ΔΦ) over time T. However, entities balance costs (e.g., P(v), or PV) and difficulties associated with implementing these alternative resources. As an example, one or more types of entities may comprise U producers, P government, J consumers and V number of climate solutions. In an example, the U producers, P government, J consumers and/or V number of climate solutions may be associated with one or more assets (e.g., facility, home/building, vehicle, solution, load, etc.).

The behavior of typical representative entities may be modeled in order to determine the likelihood of one or more entities adopting one or more low-, or zero-, emission solutions based on prior observations, literatures, and/or studies. For example, a formula may be utilized for the probability function of total emissions (e.g., from all entities in a certain group), such as a discrete probabilistic model that is associated with parameters indicating that every entity implements low-, and/or zero-, emission solutions. As an example, the probability may decrease to zero exponentially fast as the number of entities needing to implement low-, and/or zero-, emission solutions increases. In an example, it may be assumed that different customers of one or more entities take solutions independently, and thus, the probability of a customer j of an entity taking solution k may equal

$${π}_{k}^{j}$$

with

$$0 \leq {π}_{k}^{j} \leq 1 .$$

As such, for any customer j of an entity, a sum that aggregates over a set of solutions V (e.g., a customer of an entity randomly implements one of the V number of solutions) may be expressed as

$${\sum }_{k} {π}_{k}^{j} = 1 .$$

Thus, if given n customers j₁, . . . , jₙ that take solutions k₁, . . . , kₙ, the probability of one or more underlying events may equal

$${π}_{{k}_{1}}^{{j}_{1}} , ... , {π}_{{k}_{n}}^{{j}_{n}} .$$

In order to consider the probability of climate change, it may be assumed that there are V₊<V number of solutions that result in a positive impact of mitigating emissions causing climate change (e.g., reducing emissions by at least a given amount for each customer of an entity implementing any of the V₊solutions resulting in a relatively small amount of emissions). Thus, the probability that a customer j of an entity adopts a positive solution (e.g., low-, or zero-, emissions) may be represented as

$${π}_{+}^{j} = {\sum }_{{k}_{+}} {π}_{{k}_{+}}^{j} \leq 1 ,$$

wherein the summation is aggregated over the set of V₊positive solutions. As an example, if there are n customers j₁, . . . , jₙ with probabilities that satisfy

$${π}_{+}^{{j}_{i}} \leq p , i = 1 , ... , n .$$

for some p<1, then the probability of positive impact on climate change from n customers may equal

$${π}_{+}^{{j}_{1}} , ... , {π}_{+}^{{j}_{n}} \leq {p}^{n} .$$

As an example, as n increases, the probability decreases because pⁿ→0 as n→∞. As an example, if p=1/X, then

$${π}_{+}^{{j}_{1}} ... {π}_{+}^{{j}_{n}} \leq \frac{1}{{X}^{n}} .$$

For example, the discrete model may indicate that the probability of positive impact on climate change globally is very small as it tends to zero as the number of customers of one or more entities that implement low-, or zero-, emission solutions increases.

A continuous model may be utilized for determining/estimating the probability of climate change. For example, the continuous model may be determined based on extending the discrete model to incorporate the amount of emissions caused by implementing different solutions. For example, at a given reference time moment to, a customer j of an entity emits Φ^{j}(t₀) units, wherein a discrete random variable δΦ^{j} may be determined. For example, δΦ^{j} may indicate emissions caused by customers' behavior, wherein the value

$$δ {Φ}_{k}^{j}$$

is associated with the probability

$${π}_{k}^{j} .$$

For example, the emissions of customer j that implemented solution k may be determined based on

$${Φ}_{k}^{j} = {Φ}^{j} ( {t}_{0} ) + δ {Φ}_{k}^{j} and {Φ}^{j} = {Φ}^{j} ( {t}_{0} ) + δ {Φ}^{j} .$$

In an example, the average emissions of an entity j may be determined based on a given customer j that can implement a single solution at a time and based on the random variable δΦ^{j} associated with

$$\{ {Φ}_{k}^{j} : k = 1 , ... , V \} ,$$

which may be expressed as

$$𝔼 ( {Φ}^{j} ) = {\sum }_{k = 1}^{V} {Φ}_{k}^{j} \cdot {π}_{k}^{j} = {Φ}^{j} ( {t}_{0} ) + 𝔼 ( δ {Φ}^{j} ) = {Φ}^{j} ( {t}_{0} ) + {\sum }_{k = 1}^{V} δ {Φ}_{k}^{j} \cdot {π}_{k}^{j} .$$

As an example, the total emissions from all entities and assets (e.g., facility, home/building, vehicle, solution, load, etc.) of the entities may be expressed as

$$Φ = {\sum }_{j = 1}^{J} {Φ}^{j} ,$$

which may comprise a random variable. As such, given one or more entities' independent behaviors, the expected total emissions may be expressed as

$$𝔼 ( Φ ) = {\sum }_{j = 1}^{J} {\sum }_{k = 1}^{V} {Φ}_{k}^{j} \cdot {π}_{k}^{j} = {\sum }_{j = 1}^{J} {Φ}^{j} ( {t}_{0} ) + {\sum }_{j = 1}^{J} {\sum }_{k = 1}^{V} δ {Φ}_{k}^{j} \cdot {π}_{k}^{j} ,$$

wherein

$${\sum }_{j = 1}^{J} {Φ}^{j} ( {t}_{0} ) \text{=:} Φ ( {t}_{0} )$$

comprises total emissions at t₀.

To implement a mitigation plan associated with one or more solutions, the total emissions must be smaller than a critical value \hat{Φ}>0 or the total reduction δΦ:=Φ−Φ(t₀) must be smaller than a critical reduction amount δ\hat{Φ}:=\hat{Φ}−Φ(t₀)<0. As an example, all quantities Φ^{j}=Φ^{j}(t), Φ=Φ(t), δΦⱼ=δΦ^{j}(t), δΦ=δΦ(t), \hat{Φ}^{j}=\hat{Φ}^{j}(t), \hat{Φ}=\hat{Φ}(t), δ\hat{Φ}^{j}=δ\hat{Φ}^{j}(t), and δ\hat{Φ}=δ\hat{Φ}(t) are time-dependent. Thus, the probability of Φ<\hat{Φ} may be represented as

$$P ( Φ < \hat{Φ} ) = {\int }_{{Φ}^{{j}_{1}} = 0}^{\hat{Φ}} ( {\sum }_{j = 2}^{J} {Φ}^{j} < \hat{Φ} - {Φ}^{{j}_{1}} ) d {Φ}^{{j}_{1}} = {\int }_{{Φ}^{{j}_{1}} = 0}^{\hat{Φ}} {\int }_{{Φ}^{{j}_{2}} = 0}^{\hat{Φ} - {Φ}^{{j}_{1}}} … {\int }_{{Φ}^{{j}_{J - 1}} = 0}^{\hat{Φ} - {\sum }_{j = 1}^{J - 2} {Φ}^{j}} ( {Φ}^{{j}_{J}} < \hat{Φ} - {\sum }_{j = 1}^{J - 1} {Φ}^{j} ) d {Φ}^{{j}_{J - 1}} … d {Φ}^{{j}_{2}} d {Φ}^{{j}_{1}} ,$$

wherein dΦ^{j} comprises the probability distribution of the random variable Φ^{j}, and wherein the probability of Φ may be determined by the values

$${Φ}_{k}^{j} and {π}_{k}^{j}$$

for k=1, . . . , V. In an example, for an entity j, a closed form expression for the probability for the entity's emissions being smaller than the critical value Φ may be expressed as

$$ℙ ( {Φ}^{j} < \hat{Φ} ) = {\sum }_{k = 1}^{V} 𝒳 ( {Φ}_{k}^{j} < \hat{Φ} ) {π}_{k}^{j} ,$$

wherein

$$𝒳 ( A ) = \{ \begin{matrix}1 , if A occurs , \\ 0 , otherwise ,\end{matrix}$$

comprises an indicator function of the probabilistic event A. The probability of the entity j′s reduction being smaller than δ\hat{Φ} may be expressed as

$$( {δΦ}^{j} < δ \hat{Φ} ) = {\sum }_{k = 1}^{V} 𝒳 ( {δΦ}_{k}^{j} < δ \hat{Φ} ) {π}_{k}^{j} .$$

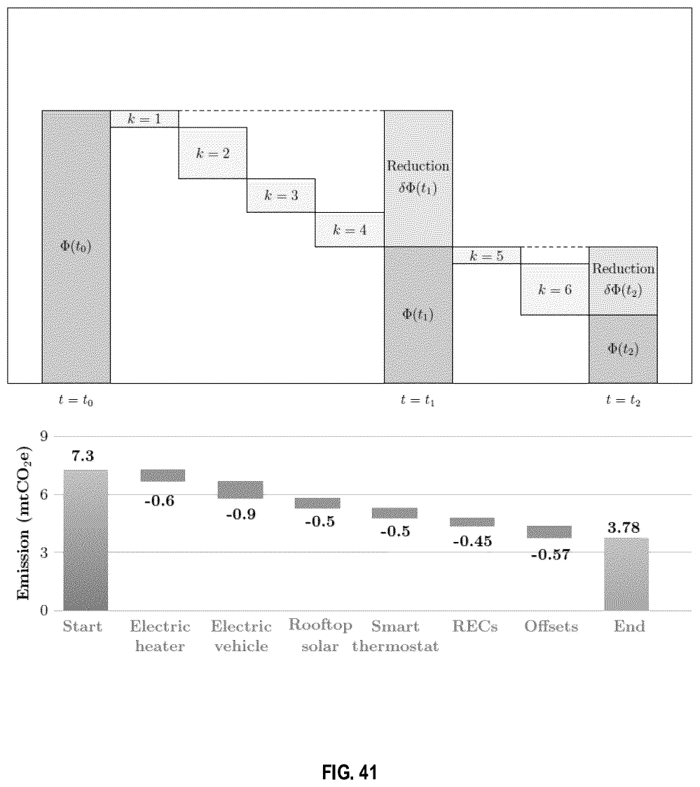

As an example, the probability formula of the entity j being smaller than δ\hat{Φ} may be utilized to calculate the probability of reducing emissions to an arbitrary value, using an a priori set, \hat{Φ}, when taking into account the probability distributions of one or more individual entities' behaviors and their statistical independence. In comparison with the discrete model, the continuous model may model more complicated events that incorporate subtleties of different customers' behaviors. In addition, the continuous model does not know positive solutions (e.g., low-, or zero-, emission solutions), or negative solutions, from the point of view of emissions reductions. As shown in FIG. 41, implementations of different low-, or zero-, emission solutions may result in the mitigation of emissions over time.

An empirical probability distribution model may be utilized for determining/estimating the probability of climate change. For example, the empirical probability distribution model may be determined based on one or more individual entities' behaviors in the past. For example, a number of individual entities that implemented solutions with regard to the individual entities' belongings (e.g., solutions v₁ and v₂ are applied to asset r). As an example, it may be assumed that how an asset/item of each kind (e.g., car of a given model, house/apartment, plant, etc.) was implementing solution schemes in a given past time period is known. For example, given N many houses at a location, Nₖ number of households applied a k-th solution. Thus, the empirical probability of applying the k-th solution by a household may be estimated to be πₖ:=Nₖ/N. Given an individual j and the individual j's asset r (e.g., facility, home/building, vehicle, solution, load, etc.) the prediction may be based on applying the solution k to r with the probability πₖ. In an example, a dependence of individual assets with a database of assets in a given geographical region may be considered. As an example, each individual may possess property, and thus, solutions may be applied to individual belongings. In another example, the same property items may be considered as copies of a type of item (e.g., a house at a given location may be one of many houses and may be considered together with all other houses at a given location when determining the behavior of emission reduction and solution implementation). In order to facilitate book keeping of property items and keep track of which solutions are applied to which items, a property matrix P^{j} associated with every individual j may be considered. As an example, each row of the property matrix may be indexed by all possible property types (e.g., in a given geographical region) and each column of the property matrix may be indexed by all possible solutions that can be applied. In an example, if a given solution k cannot be applied to a given property item r, then the corresponding entry of the property matrix is zero (e.g.,

$${P}_{r k}^{j} = 0 ,$$

wherein it can be assumed that an individual can own at most one copy of each item type such as a house, a car of each fuel type, etc.). For example, each customer j may be associated with a vector O^{j} of ownership. For example,

$${O}_{r}^{j} = 1$$

if the entries of the matrix are labeled r, and

$${O}_{r}^{j} = 0$$

if an individual j owns the item r. Based on O^{j}, the rth row of P^{j} may be filled with zeros if

$${O}_{r}^{j} = 0$$

(e.g., if j does not own r, then there are no solutions to be applied to r by j). In order to calculate the total reduction of the jth individual, all rows and columns may be summed, which may be expressed as

$$the total reduction of j = {\sum }_{r} {\sum }_{k} δ {Φ}_{r k}^{j} {P}_{r k}^{j} .$$

If a k^{th} solution v is not applied to the item r, then there is no contribution. As an example, matrices P^{j} may be introduced with global indices to facilitate counting the number of the individual entities that apply solutions to property items. The empirical probability of applying solution k to r as πᵣₖ=Nᵣₖ/Nᵣ may be determined based on

$${N}_{r} = {\sum }_{j} {O}_{r}^{j} ,$$

the total number of items r (in a given region), wherein the number of individuals that applied the solution k to the item r may be expressed as

$${N}_{r k} = {\sum }_{j} {O}_{r}^{j} \cdot {P}_{rk}^{j} ,$$

wherein

$${P}_{r k}^{j} = 0$$

as soon as

$${O}_{r}^{j} = 0.$$

As an example, the number N_{r,{k}_{¹}_{, . . . ,k}_{^{s}}_{}} of individuals that applied solutions k₁, . . . , kₛ to the item r may be expressed as

$${N}_{r , \{ {k}_{1} , … , {k}_{s} \}} = {\sum }_{j} {O}_{r}^{j} \cdot {P}_{r {k}_{1}}^{j} \cdot … \cdot {P}_{r {k}_{s}}^{j} ,$$

wherein the product

$${P}_{{rk}_{1}}^{j} \cdot ... \cdot {P}_{{rk}_{s}}^{j}$$

equals 1 it all factors in the product equal 1. As such, the behavior of individuals and a dependence/correlation between different actions may be predicted. For example, comparing values π_{r,{k}_{¹}_{,k}_{²}_{}} with a fixed value k₁ (e.g., r is a house and k₁ is an installation of solar panels) and varying k₂, another solution to be employed with regard to efficiency upgrades of houses (at a location) may be determined.

The number of individuals that applied k₁, . . . , kₛ, wherein there are no other solutions to r, may be expressed as

$${\tilde{N}}_{r , \{ {k}_{1} , … , {k}_{s} \}} = {\sum }_{j} {O}_{r}^{j} \cdot {P}_{{rk}_{1}}^{j} \cdot ... \cdot {P}_{{rk}_{s}}^{j} \cdot {\prod }_{k \neq {k}_{1} , … , {k}_{s}} ( 1 - {P}_{rk}^{j} ) .$$

In an example, by adding the product

$${\prod }_{k \neq {k}_{1} , … , {k}_{s}} ( 1 - {P}_{rk}^{j} )$$

to the equation N_{r,{k}_{¹}_{, . . . ,k}_{^{s}}_{}} if a further solution k (e.g., beyond k₁, . . . , kₛ) is applied to r by the individual j (e.g.,

$${P}_{rk}^{j} = 1 ,$$

or equivalently

$$1 - {P}_{rk}^{j} = 0 ) ,$$

the whole product in Ñ_{r,{k}_{¹}_{, . . . ,k}_{^{s}}_{}} vanishes. The value \tilde{π}_{r,{k}_{¹}_{, . . . ,k}_{^{s}}_{}}=Ñ_{r,{k}_{¹}_{, . . . ,k}_{^{s}}_{}}/Nᵣ may be utilized to calculate the probability of applying k₁, . . . , kₛ to r. As an example, \tilde{π}_{r,{k}_{¹}_{, . . . ,k}_{^{s}}_{}}may be ensured to form a partition of 1 based on the Lemma expressed as

$${\sum }_{k ⊆ V} {\tilde{π}}_{r , k} = 1 ,$$

wherein the summation is over all subsets of k of the set of solutions V. In an example., Ñ_{r,k}, k⊆V, sum up to Nᵣ, the number of individuals owning the item r. For example, given an individual j the set of solutions k it applies to r is uniquely assigned to it. In addition, Jₖ, the set of individuals that own r, may be applied to solutions from k. Thus, Jₖ, k⊆V, form a partition of the set of Nᵣ number of individuals owning r.

In an example, if there are only two solutions k=1 and k=2 that can be applied to r, then \tilde{π}ᵣ₁:=\tilde{π}_{r,{1}}, and \tilde{π}_{r,{2}}, respectively, is the fraction of individuals that own r and applied only solutions k=1 or k=2, respectively. In addition, \tilde{π}_{r,{1,2}}may comprise the fraction of those individuals that own r and applied both solutions. Based on the Lemma, the fraction of individuals that own r and are not applying any solutions may comprise 1−\tilde{π}ᵣ₁−\tilde{π}ᵣ₂−\tilde{π}_{r,{1,2}.}

In an example, an individual customer j must reduce their emission by δ\hat{Φ}(j)=S(j)·δ\hat{Φ}, wherein δ\hat{Φ}may comprise the total reduction to be achieved and S(j)=Φ₀(j)/Φ₀ may represent the fraction of emissions from j. Thus, the amount of reduction for an asset r=1, . . . , rⱼ may be expressed as

$$δ \hat{Φ} ( j , r ) = {S}_{j} ( r ) \cdot δ \hat{Φ} ( j ) = \frac{{Φ}_{0} ( j , r )}{{Φ}_{0} ( j )} \cdot \frac{{Φ}_{0} ( j )}{{Φ}_{0}} \cdot δ \hat{Φ} = S ( j , r ) \cdot δΦ ,$$

wherein Sⱼ(r)=Φ₀(j,r)/Φ₀(j) may comprise the share of emissions from the asset r in the total emissions of the customer j. As an example, an entity (e.g., company) with various assets contributing to its total emissions may have S portions of annual emissions that may be represented as a function of total asset count, wherein unique types of resource are consumed.

Either the share of δ\hat{Φ}(j) proportional to Sⱼ(r) or the total emission reduction δ\hat{Φ} proportional to S(j,r) may be utilized to calculate the emissions reduction quota for (j,r). As an example, it may be assumed that a customer j can only apply solutions v from the subset V(j r)⊆V of solutions in order to achieve the target δ\hat{Φ}(j,r). In addition, it may be assumed that the set V(j,r) has at least one element. For example, the desired emission reduction for the asset r of the customer j may be achieved based on at least one solution v∈V. As such, the number of ways Nⱼ a customer j can meet its reduction goal may be expressed as

$${N}_{j} = {\prod }_{r = 1}^{{r}_{j}} \vert V ( j , r ) \vert ,$$

wherein |V(j,r)| represents the number of events in the set V(j, r). For example the number implementations (e.g., options) of emissions reduction may be multiplied for different assets of a given customer. For example, each implementation (e.g., option) of a solution v∈V (j,r) may be associated with a price P(j, r|v), which may be proportional to the reduction quota, which may be expressed as

$$P ( j , r \vert v ) = δ \hat{Φ} ( j , r ) \cdot P ( v ) ,$$

wherein P(v) is the price associated with using the solution v for reducing the emission by one unit (e.g. 1 metric ton of CO₂). Thus, in order to save on costs of emission reduction, for each asset r=1, . . . , rⱼ, the solution v∈V(j,r) with the smallest P(v) may be selected. As such, the lowest price for the emission reduction for an individual customer j may be expressed as

$${P}_{min} ( j ) = {\sum }_{r = 1}^{{r}_{j}} {min}_{v ∈ V ( j , r )} P ( v ) .$$

As an example, a target emission of a given j, r (and possibly of E) may be treated as a function δ\hat{Φ}(j,r). The number of combinations of solutions in V(j, r) to achieve the desired reduction may be determined based on each solution i=1, . . . ,|V(j,r)| having a capacity

$${v}_{i}^{max} - 1.$$

In an example, δ\hat{Φ}(j,r) may be achieved based on at least one combination of solutions in V(j, r), wherein δᵢ may represent the emission reduction achieved with one application of the solution i, wherein

$${\sum }_{i = 1}^{\vert V ( j , r ) \vert} {δ}_{i} ( {v}_{i}^{max} - 1 ) \geq δ \hat{Φ} ( j , r ) .$$

Thus, the combinations of solutions may be expressed as

$$P := \{ v = {( {v}_{i} )}_{i = 1}^{\vert V ( j , r ) \vert} ∈ {\vert V ( j , r ) \vert}^{} : 0 \leq {v}_{i} < {v}_{i}^{max} , {\sum }_{i = 1}^{\vert V ( j , r ) \vert} {δ}_{i} {v}_{i} \geq δ \hat{Φ} ( j , r ) \} ,$$

wherein the first condition may indicate that each solution is non-negative and cannot exceed the maximum capacity, while the second condition may guarantee that the desired reduction quota is achieved.

Based on changing the coordinates via

$${v}_{i} {v}_{i}^{max} - {v}_{i} = 1 , … , \vert V ( j , r ) \vert ,$$

the inequality

$${\sum }_{i = 1}^{\vert V ( j , r ) \vert} {δ}_{i} {v}_{i} \geq δ \hat{Φ} ( j , r )$$

may be expressed as

$${\sum }_{i = 1}^{\vert V ( j , r ) \vert} {δ}_{i} {v}_{i} \leq {\sum }_{i = 1}^{\vert V ( j , r ) \vert} {δ}_{i} {v}_{i}^{m ax} - {δ}_{i} {v}_{i} .$$

As an example, the condition

$${v}_{i} < {v}_{i}^{m ax}$$

may become into vᵢ>0. As such, the remaining condition 0≤vᵢ may be omitted, wherein the estimate may be expressed as

$$\vert P ∩ {ℤ}_{\geq 0}^{\vert V ( j , r ) \vert} \vert \leq \{ v ∈ {ℤ}_{> 0}^{\vert V ( j , r ) \vert} : {\sum }_{i = 1}^{\vert V ( j , r ) \vert} {δ}_{i} {v}_{i} \leq {\sum }_{i = 1}^{\vert V ( j , r ) \vert} {δ}_{i} {v}_{i}^{max} - δ \hat{Φ} ( j , r ) \} .$$

As such, the new inequality may be expressed as

$${\sum }_{i = 1}^{\vert V ( j , r ) \vert} {( \frac{{\sum }_{l = 1}^{\vert V ( j , r ) \vert} {δ}_{l} {v}_{l}^{ma x} - δ \hat{Φ} ( j , r )}{{δ}_{i}} )}^{- 1} {v}_{i} \leq 1 .$$

Thus, the estimate may be updated to be expressed as

$$\vert P ⋂ {ℤ}_{\geq 0}^{\vert V ( j , r ) \vert} \vert \leq \frac{1}{\vert V ( j , r ) \vert !} {\prod }_{i = 1}^{\vert V ( j , r ) \vert} ( \frac{{\sum }_{l = 1}^{\vert V ( j , r ) \vert} {δ}_{l} {v}_{l}^{m ax} - δ \hat{Φ} ( j , r )}{{δ}_{i}} - 1 ) ,$$

wherein |V(j,r)|!=|V(j,r)|·(|V(j,r)|−1) ·. . . ·2 ·1 is the fractional function |V(j,r)|. The obtained estimate may be determined based on assuming that all solutions have the same reduction potential δᵢ=1, i=1, . . . , |V(j,r)|, wherein the difference between the maximal possible reduction (given solutions in V(j,r) with capacities) and the desired reduction δ\hat{Φ}(j,r) may be determined based on

$$C := {\sum }_{l = 1}^{\vert V ( j , r ) \vert} {δ}_{l} {v}_{l}^{m ax} - δ \hat{Φ} ( j , r ) = {\sum }_{l = 1}^{\vert V ( j , r ) \vert} {v}_{l}^{m ax} - δ \hat{Φ} ( j , r ) .$$

Thus, the estimate may be updated to be expressed as

$$\vert P ⋂ {ℤ}_{\geq 0}^{\vert V ( j , r ) \vert} \vert \leq \frac{{( C - 1 )}^{\vert V ( j , r ) \vert}}{\vert V ( j , r ) \vert !} .$$

In an example, the number of different combinations of solutions to achieve the emission reduction greater than or equal to δ\hat{Φ}(j,r) may be upper-bounded by the |V(j,r)|-th power of the gap

$$\frac{C - 1}{\vert V ( j , r ) \vert} .$$

As an example, based on 5 solutions and a gap C=11, at most, 10⁵/5!≈833 combinations of solutions may be implemented.

In an example, a finite set V of solutions may be considered, wherein a plurality of solutions to an entity (j, r, E) may be calibrated based on prescribing

$$0 \leq {v}_{m ax}^{i} , i = 1 , … , \vert V \vert .$$

As an example, by default, all

$${v}_{m ax}^{i}$$

may comprise non-negative integer numbers. If

$${v}_{ma x}^{i}$$

is zero, the associated solution may be discarded from a set of actual/active solutions available to an associated asset/customer. In addition, assets may be aggregated in order unite all solutions ˜(j, r, E) with a positive

$${v}_{m ax}^{i} .$$

A tensor (e.g., collection of matrices) may then be determined to encode which solutions and which quantity are available to a given individual asset.

In an example, budget constraints may be introduced into the problem, formulating the problem as an integer problem (e.g., constraint minimization function). As an example, it may be assumed that each solution v∈V(j,r) available to a given j individual and a given asset r has its price Pᵥ, wherein Pᵢ, i=1, . . . , |V(j,r)|, vᵢ represents an amount of the i-th solution that is applied. In addition, vᵢ comprises an integrate that satisfies

$$0 \leq {v}_{l} < {v}_{i}^{m ax} ,$$

wherein

$${v}_{i}^{ma x} - 1$$

may comprise the maximum capacity of the i-th solution. For example, if a solution is not measurable,

$${v}_{i}^{m ax} = 2 ,$$

wherein active vᵢ=1 or inactive vᵢ=0. Thus, minimizing the price subject to the construct associated with the combinations of solutions, the emission reduction may be:

$$min {\sum }_{i = 1}^{\vert V ( j , r ) \vert} {v}_{i} {P}_{i}$$

$$such that {\sum }_{i = 1}^{\vert V ( j , r ) \vert} {v}_{i} {δ}_{i} \geq δ \hat{Φ} ( j , r )$$

$$and 0 \leq {v}_{i} < {v}_{i}^{max} , i = 1 , … , \vert V ( j , r ) \vert .$$

Assuming that all solutions are not measurable, for example,

$${v}_{i}^{max} = 2 , i = 1 , … , \vert V ( j , r ) \vert ,$$

and switching to xᵢ=−vᵢ, i=1, . . . , |V(j,r)|, an equivalent problem may be:

$$max {\sum }_{i = 1}^{\vert V ( j , r ) \vert} {x}_{i} {P}_{i}$$

$$subject to {\sum }_{i = 1}^{\vert V ( j , r ) \vert} {x}_{i} {δ}_{i} \leq - δ \hat{Φ} ( j , r )$$

In an example,

$${v}_{i}^{max} = 2$$

for all i=1, . . . , |V(j,r)|. As such, each solution is either active or not active. It may be assumed that an optimal solution scheme (represented by vector

$$v = {( {v}_{i} )}_{i = 1}^{\vert V ( j , r ) \vert} )$$

has a sparse pattern, wherein only a few vᵢ are 1). For example, if there are at most s many non-zero vᵢ in v, then the total possibilities for v may be expressed as

$${\sum }_{l = 0}^{s} ( \begin{matrix}\vert V ( j , r ) \vert \\ l\end{matrix} ) ,$$

which may be compared with the total number of possible

$$v = {( {v}_{i} )}_{i = 1}^{\vert V ( j , r ) \vert} ,$$

expressed as

$${2}^{\vert V ( j , r ) \vert} = {\sum }_{l = 0}^{\vert V ( j , r ) \vert} ( \begin{matrix}\vert V ( j , r ) \vert \\ l\end{matrix} ) ,$$

wherein

$${\sum }_{i = 0}^{s} ( \begin{matrix}\vert V ( j , r ) \vert \\ l\end{matrix} ) \leq ( \begin{matrix}\vert V ( j , r ) \vert \\ s\end{matrix} ) \frac{\vert V ( j , r ) \vert - ( s - 1 )}{\vert V ( j , r ) \vert - ( 2 s - 1 )} \approx ( \begin{matrix}\vert V ( j , r ) \vert \\ s\end{matrix} ) for large \vert V ( j , r ) \vert .$$

As an example, when |V(j,r)| is large, the number of possibilities for v (provided that s components of this vector are non-zero) is bounded by a polynomial of degree s in |V(j,r)|, wherein the total number of v (with 0-1 entries) is exponential in |V(j r)|. For example, when s=2, the solution choices to test may be expressed as

$$\vert V ( j , r ) \vert + ( \begin{matrix}\vert V ( j , r ) \vert \\ 2\end{matrix} ) = \vert V ( j , r ) \vert + \frac{\vert V ( j , r ) \vert ( \vert V ( j , r ) \vert - 1 )}{2} = ( \begin{matrix}\vert V ( j , r ) \vert + 1 \\ 2\end{matrix} ) .$$

For example, s=2 indicates that at most 2 solutions may be combined for each asset.

As an example, the continuous model may be applied to the empirical probability distribution model resulting in a randomization of the integer optimization problem in order to enable probabilistic analysis. Given subset k⊆V, \tilde{π}_{i,k} may represent the empirical probability of applying solutions from k to the item i. Based on the Lemma, Σ_{k⊆v} \tilde{π}ᵢₖ=1. As such, a random variable xᵢ ∈{0,1}^{|V|} may be determined, wherein the random variable's state space may be the set of binary vectors of length |V| with marginal probabilities given by \tilde{π}_{i,k}, k⊆V. For a given subset of solutions k⊆V, the emission reduction caused by applying solutions from k to i∈R may be expressed as δΦ_{i,k}=Σ_{k∈k}δΦ_{i,k}. As an example, the correspondence δΦᵢ: k⊆V [symbol] δΦ_{i,k} can be regarded as a random function/variable that takes value δΦ_{i,k} with probability \tilde{π}_{i,k}. For example, the correspondence may comprise a random variable with a state space that is the set of binary vectors of length |V|.

The probability that upon applying a plurality of solutions to i∈R the emissions reduction does not exceed Φᵢ may be expressed as

$$( {δΦ}_{i} \leq {Φ}_{i} ) = {\sum }_{k ⊆ V} 𝒳 ( {δΦ}_{i , k} \leq {Φ}_{i} ) {\tilde{π}}_{i , k} , i = 1 , 2 , … , R ,$$

wherein χ(A) may comprise the indicator function of the probabilistic event A. Thus,

$${\sum }_{k = 1}^{V} {δΦ}_{ik} {x}_{ik} \geq {K}_{i} {Φ}_{i} , i = 1 , 2 , … , R ,$$

wherein K₁, . . . , K_{R} are fixed constraints [0, 1]. As such, the probability of validity may be calculated as

$$( {δΦ}_{i} \geq {K}_{i} {Φ}_{i} ) = {\sum }_{k ⊆ V} 𝒳 ( {δΦ}_{i , k} \geq {K}_{i} {Φ}_{i} ) {\tilde{π}}_{i , k} , i = 1 , 2 , … , R .$$

The above semi-explicit formula for P(Φ<\hat{Φ}) allows us to compute the probability of reducing emissions to an arbitrary value, using an a priori set, \hat{ }Φ, provided we are given probability distributions of individual entity behaviors and assuming their statistical independence. In comparison with the discrete model, the latter continuous one allows to model more complicated events incorporating subtleties of different customers' behaviors. It is also more realistic since one cannot a priori know good solutions from or bad one from the point of view of emissions reduction. As shown in FIG. 41, an implementation of different low-carbon solutions may result in a mitigation of emissions with time.

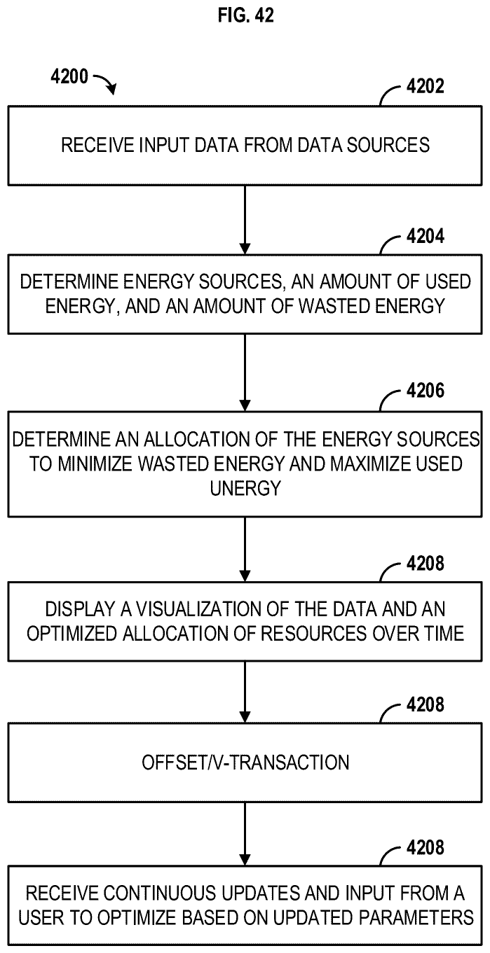

FIG. 42 depicts a flow chart of an example method 4200 showing an exemplary process for embodiments of the invention. Method 4200 may be implemented by a computing device (e.g., the computer 102, a server, a computing device, etc.). At step 4202, data from the data sources 138 are received. The received data may be indicative of the source of the generated energy and the amount of generated energy. The received data may also be indicative of an amount of energy consumed and wasted by each energy consumption method described above. For example, the energy source may be solar power and the energy consumption may be an office building or a residence. In another example, the energy source may be fossil fuels and the consumption may be transportation. Any energy source and energy consumption methods may be analyzed using the algorithms and displayed using the visualization described herein.

At step 4204, the energy that is used, wasted, and the sources and processes of using and wasting the energy are determined. In some embodiments, the energy used and wasted is determined for each energy consumption process such that the process efficiencies can be determined and compared based on each energy source. Further, process costs for both the economy and the environment may be determined. The environmental and economic cost of benign and harmful resources as well as wasted and used resources may be determined.

At step 4206, allocation of resources may be optimized based on the source of the energy and how the energy is being used and wasted. Determine the most optimal allocation of resources within a defined system to minimize the use of harmful resources and maximize the use of benign resources using the optimization algorithms described above. Further, the processes may be evaluated for find the most effective allocation of resources to limit waste and maximize benign resources. In some embodiments, the cost of the resources is taken into account and a weighted system process economic cost and environmental cost is determine. An allocation of resources maximizing benign resources and minimizing harmful resources may be determined. In some embodiments, wasted resources may be minimized and in some embodiments, monetary costs and savings may be minimized and maximized or otherwise weighted against along with the benign and harmful resources to provide environmental and economical solutions.

At step 4208, the visualization of the source data and optimized allocation of resources is displayed via the visualizations described above. The visualizations provide two-and three-dimensional data visualization via the visual three-dimensional cubes and two-dimensional maps described above. The user may customize any of the above-described visualizations to present customized past, present, and future visualizations based on the data sources, geospatial map information, transition processes, and the user input parameters.

At step 4210, the amount of P can be used to “purchase” items, v (representing reallocations and transformations of energy sources in different ways), thereby changing the system parameters in meeting the desired conditions (i.e., p(A) and p^{T}(A) goes to 1, which implies p(B) and p^{T}(B) goes to 0, and η goes to 1, such that μ goes to 0). The price to purchase may be maximized, the reduction of harmful inputs, may be minimized or any combination in between.

As described in reference to FIG. 31 above, each user can understand the emissions Φ given their energy source visualization, and chose to either escrow the monetary amount, P(Φ) or P(B) in any given t in any currency to either (i) purchase relevant v solutions knowing the P(v) of each v solution, (ii) invest P(Φ) amount in community-level projects, either as a trackable donation or purchasing a security in an investment project, such as green bonds, (iii) make charitable donations of P(Φ) to other S entities, through unique alphanumeric IDs or (iv) buy carbon offsets or renewable energy credits in the amount of P(Φ) and get a discount code (another unique alphanumeric ID) from participating retailers.

As shown in FIG. 31, the first option can be for an S user to offset $20 by using the system to match the $20 to a set of v's to “purchase” at least a portion, or a single v solution that their R, Q, Xⱼ matches that of the v. A v-card may be generated showing the monetary value, as well as savings Sv over time, including any δΦᵥ reduction; thereby optimizing the J^{A}, J^{B} and J^{T} parameters of the user S. The v solutions provider may want to verify and give discount to the S consumers who have completed offsets or gone carbon neutral by checking if their unique alphanumeric code has been already spent from their account or not, to limit double spending. If already spent, a message may reiterate the note: “Thanks for your previous impact, we have already applied your discount for v purchase (<unique code>)” If not spent, says “Thanks for your impact, enjoy <discount (80%) on v purchase>”

The second option allows S user to use the system to match the $20 to a set of v's to “purchase” at least a portion, or a single v “project” that their R, p matches that of the v. A v-card may be generated showing the monetary value of this investment, as well as savings Sv over time or interest rate, such as bond coupons, including with it any 50, reduction; thereby optimizing the J^{A}, J^{B} and J^{T} parameters of either the user or the region p. The v solutions provider may want to verify and give return on investments to the S consumers who have completed offsets or gone carbon neutral by checking if their unique alphanumeric code has been already spent from their account or not, to limit double spending. If already spent, a message may reiterate the note: “Thanks for your previous investment, we have already applied your impact funds to v project (<unique code>)” If not spent, says “Thanks for your impact, you now own minibond coupon <uniquecode>”

A third option can allow use of the system to match the $20 to a set of other S donations, to give away, at least a portion of their offset to another entity. A list may be generated showing the monetary value of this donation, as well as savings Sv over time of the receiving entity, including with it any δΦᵥ reduction; thereby optimizing the J^{A}, J^{B} and J^{T} parameters of the receiving user or entity. The donation receiver may want to verify through the system that the S consumers who have completed offsets or gone carbon neutral by checking if their unique alphanumeric code has been already spent from their account or not, to limit double spending in either other donations, v-purchases, bond investments or any other such system processes. If already spent, a message may reiterate the note: “Thanks for your previous donation, we have already applied your impact (<unique code>)” If not spent, says “Thanks for your impact <alphanumericode>”

A fourth option allows the S users to use the system to match the $20 to a combination of above processes, to get a discount code for any other entity who are not any of the above. A new alphanumeric code may be uniquely generated showing the monetary value of this donation, as well as savings S, through a discount percentage applied over time given by the retailer entity, including with it any δΦᵥ reduction; thereby optimizing the J^{A}, J^{B} and J^{T} parameters of the receiving user or entity. The discount provider may want to verify through the system that the S donation receiver/consumers who have completed offsets or gone carbon neutral by checking if their unique alphanumeric code has been already spent from their account or not, to limit double spending in either other donations, v-purchases, bond investments or any other such system processes. If already spent, a message may reiterate the note: “Thanks for your previous impact, we have already applied your discount (<unique code>)” If not spent, says “Thanks for your impact, enjoy <discount (40%) >”. Many such transactions between different entities, subsystems, components and variables described above could be facilitated through the step-wise optimization process.

At step 4212, the source data is continuously received, optimized, and visualized in real-time. In some embodiments, the information is processed and updated continuously, or dynamically, or at any desired period. The optimization algorithms and the data visualization processes may continually receive input data from the data sources and provide current data visualizations and optimized resource allocations.

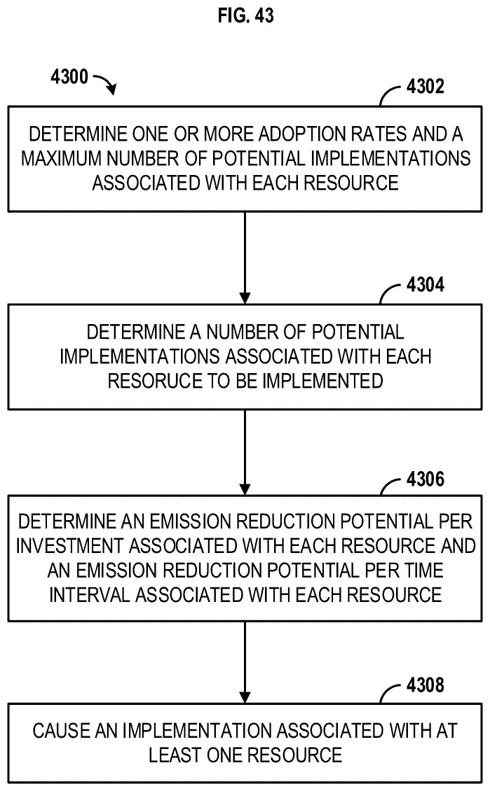

FIG. 43 depicts a flow chart of an example method 4300 showing an exemplary process for embodiments of the invention. Method 4300 may be implemented by a computing device (e.g., the computer 102, a server, a computing device, etc.). At step 4302, one or more adoption rates and a maximum number of potential implementations associated with each resource of one or more resources may be determined based on a target emission. For example, one or more adoption rates associated with one or more resources and a maximum number of potential implementations associated with each resource of the one or more resources may be determined based on a target emission. For example, a computing device (e.g., the computer 102, a server, a computing device, etc.) may determine the one or more adoption rates and the maximum number of potential implementations associated with each resource of the one or more resources based on the target emission. As an example, source data associated with the one or more energy sources may be received (e.g., received by the computing device). For example, the source data may comprise data indicative of the one or more adoption rates associated with the one or more resources and the maximum number of potential implementations associated with each resource. In an example, the source data may further comprise data indicative of an estimated emissions reduction per implementation associated with each resource. The one or more resources may comprise one or more of one or more energy resources or one or more non-energy resources. The one or more energy resources may comprise one or more of a power grid, one or more batteries, one or more wind turbines, one or more solar panels, one or more boilers, or a device controlling consumption. The potential implementations associated with each resource may comprise one or more of upgrades to a resource in a power system or one or more additions of the resource to a power system.

At step 4304, a number of potential implementations associate with each resource to be implemented may be determined. For example, a number of potential implementations associated with each resource to be implemented may be determined based on the one or more adoption rates associated with the one or more resources and the maximum number of potential implementations associated with each resource. For example, the computing device (e.g., the computer 102, a server, a computing device, etc.) may determine the number of potential implementations associated with each resource to be implemented based on the one or more adoption rates associated with the one or more resources and the maximum number of potential implementations associated with each resource.

At step 4306, an emission reduction potential per investment associated with each resource and an emission reduction potential per time interval associated with each resource may be determined. For example, an emission reduction potential per investment associated with each resource and an emission reduction potential per time interval associated with each resource may be determined based on the number of potential implementations associated with each resource. For example, the computing device (e.g., the computer 102, a server, a computing device, etc.) may determine the emission reduction potential per investment associated with each resource and the emission reduction potential per time interval associated with each resource based on the number of potential implementations associated with each resource.

As an example, the emission reduction potential per investment associated with each resource and the emission reduction potential per time interval associated with each resource may be determined based on an emissions reduction potential associated with the maximum number of potential implementations associated with each resource. For example, the emission reduction potential per investment associated with each resource and the emission reduction potential per time interval associated with each resource may be determined based on the estimated emissions reduction per implementation of each resource and based on the number of potential implementations of each resource to be implemented.

At step 4308, at least one resource may be implemented. For example, at least one resource of the one or more resources according to the number of potential implementations associated with the at least one resource may be implemented based on the emission reduction potential per investment associated with each resource and the emission reduction potential per time interval associated with each resource. For example, the computing device (e.g., the computer 102, a server, a computing device, etc.) may cause the implementation associated with the at least one resource of the one or more resources according to the number of potential implementations associated with the at least one resource based on the emission reduction potential per investment associated with each resource and the emission reduction potential per time interval associated with each resource. As an example, causing the implementation associated with the at least one resource according to the number of potential implementations associated with the at least one resource may comprise causing the determined number of potential implementations associated with the at least one energy source to be installed at one or more locations.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as contemplated.

The following function shows an example by receiving, as input, a generic set of parameters Vᵢ(t) and computes all the other quantities of the system corresponding to such Vᵢ(t). Every Vᵢ(t) comes with a received price, which for this example is generated randomly in the function.

$$V - EVALUATION \qquad Algorithm 1$$

$$Inputs$$

$$1 : T , Z , p ( {A}_{t - 1}^{( 1 )} ) , ... , p ( {A}_{t - 1}^{( N )} ) , p ( {B}_{t - 1}^{( 1 )} ) , ... , p ( {B}_{t - 1}^{( M )} )$$

$$2 : {p}^{T} ( {A}_{t - 1}^{( 1 )} ) , ... , {p}^{T} ( {A}_{t - 1}^{( N )} ) , {p}^{T} ( {B}_{t - 1}^{( 1 )} ) , ... , {p}^{T} ( {B}_{t - 1}^{( M )} )$$

$$3 : {p}^{J} ( {A}_{t - 1}^{( 1 )} ) , ... , {p}^{J} ( {A}_{t - 1}^{( N )} ) , {p}^{J} ( {B}_{t - 1}^{( 1 )} ) , ... , {p}^{J} ( {B}_{t - 1}^{( M )} )$$

$$4 : {η}^{( 1 )} ( t - 1 ) , ... , {η}^{( S )} ( t - 1 ) , {φ}^{( 1 )} , ( t - 1 ) , ... , {φ}^{( S )} ( t - 1 )$$

$$5 : {γ}^{( 1 )} ( t - 1 ) , ... , {γ}^{( S )} ( t - 1 ) , {μ}^{( 1 )} , ( t - 1 ) , ... , {μ}^{( S )} ( t - 1 )$$

$$6 : Δ p ( {A}_{t - 1}^{( 1 )} ) , ... , Δ p ( {A}_{t - 1}^{( N )} ) , Δ p ( {B}_{t - 1}^{( 1 )} ) , ... , Δ p ( {B}_{t - 1}^{( M )} )$$

$$7 : Δ {p}^{T} ( {A}_{t - 1}^{( 1 )} ) , ... , Δ {p}^{T} ( {A}_{t - 1}^{( N )} ) , Δ {p}^{T} ( {B}_{t - 1}^{( 1 )} ) , ... , Δ {p}^{T} ( {B}_{t - 1}^{( M )} )$$

$$8 : Δ {p}^{J} ( {A}_{t - 1}^{( 1 )} ) , ... , Δ {p}^{J} ( {A}_{t - 1}^{( N )} ) , Δ {p}^{J} ( {B}_{t - 1}^{( 1 )} ) , ... , Δ {p}^{J} ( {B}_{t - 1}^{( M )} )$$

$$9 : {Δη}^{( 1 )} ( t - 1 ) , ... , {Δη}^{( S )} ( t - 1 ) , {Δφ}^{( 1 )} ( t - 1 ) , ... , {Δφ}^{( S )} ( t - 1 )$$

$$10 : {Δγ}^{( 1 )} ( t - 1 ) , ... , {Δγ}^{( S )} ( t - 1 ) , {Δμ}^{( 1 )} ( t - 1 ) , ... , {Δμ}^{( S )} ( t - 1 )$$

$$Steps$$

$$1 : procedure V - EVALUATION ( Inputs )$$

$$2 : {A}_{t}^{( i )} ← p ( {A}_{t}^{( i )} ) * Z for i = 1 , … , N$$

$$3 : {A}_{t} ← {\sum }_{i}^{N} {A}_{t}^{( i )}$$

$$4 : {B}_{t}^{( i )} ← p ( {B}_{t}^{( i )} ) * Z for i = 1 , … , M$$

$$5 : {B}_{t} ← {\sum }_{i}^{M} {B}_{t}^{( i )}$$

$$6 : {p}^{T} ( {A}_{t}^{( i )} ) ← {p}^{T} ( {A}_{t - 1}^{( i )} ) + Δ {p}^{T} ( {A}_{t}^{( i )} ) for i = 1 , … , N$$

$$7 : {p}^{T} ( {B}_{t}^{( i )} ) ← {p}^{T} ( {B}_{t - 1}^{( i )} ) + Δ {p}^{T} ( {B}_{t}^{( i )} ) for i = 1 , … , M - 1$$

$$8 : {p}^{T} ( {B}_{t}^{( M )} ) ← 1 - ( {\sum }_{i}^{N} {p}^{T} ( {A}_{t}^{( i )} ) + {\sum }_{i}^{M - 1} {p}^{T} ( {B}_{t}^{( i )} ) )$$

$$9 : {T}_{t}^{{A}^{( i )}} ← T * {p}^{T} ( {A}_{t}^{( i )} ) for i = 1 , … , N$$

$$10 : {T}_{t}^{{B}^{( i )}} ← T * {p}^{T} ( {B}_{t}^{( i )} ) for i = 1 , … , M - 1$$

$$11 : {T}_{t}^{{B}^{( M )}} ← T * {p}^{T} ( {B}_{t}^{( M )} )$$

$$12 : {p}^{J} ( {A}_{t}^{( i )} ) ← {p}^{J} ( {A}_{t - 1}^{( i )} ) + Δ {p}^{J} ( {A}_{t}^{( i )} ) for i = 1 , … , N$$

$$13 : {p}^{J} ( {B}_{t}^{( i )} ) ← {p}^{J} ( {B}_{t - 1}^{( i )} ) + Δ {p}^{J} ( {B}_{t}^{( i )} ) for i = 1 , … , M - 1$$

$$14 : {p}^{J} ( {B}_{t}^{( M )} ) ← 1 - ( {\sum }_{i}^{N} {p}^{J} ( {A}_{t}^{( i )} ) + {\sum }_{i}^{M - 1} {p}^{J} ( {B}_{t}^{( i )} ) )$$

$$15 : {J}^{{A}_{t}^{{A}_{i}}} ← ( Z - T ) * {p}^{J} ( {A}_{t}^{( i )} ) for i = 1 , … , N$$

$$16 : {J}^{{B}_{t}^{( i )}} ← ( Z - T ) * {p}^{J} ( {B}_{t}^{( i )} ) for i = 1 , … , M$$

$$17 : {J}^{{A}_{t}} ← {\sum }_{i}^{N} {J}^{{A}_{t}^{( i )}}$$

$$18 : {J}^{{B}_{t}} ← {\sum }_{i}^{M} {J}^{{B}_{t}^{( i )}}$$

$$19 : {γ}^{( i )} ( t ) ← {γ}^{( i )} ( t - 1 ) + {Δγ}^{( i )} ( t - 1 ) for i = 1 , … , S$$

$$20 : {T}_{t}^{( i )} ← T * {γ}^{( i )} ( t ) for i = 1 , … , S$$

$$21 : {μ}^{( i )} ( t ) ← {μ}^{( i )} ( t - 1 ) + {Δμ}^{( i )} ( t - 1 ) for i = 1 , … , S$$

$$22 : {T}_{t}^{{C}^{( i )}} ← {T}_{t}^{( i )} * {μ}^{( i )} ( t ) for i = 1 , … , S$$

$$23 : {T}_{t}^{C} ← {\sum }_{i} {T}_{t}^{{C}^{( i )}}$$

$$24 : {J}_{t}^{{T}^{T}} ← {T}_{t}^{( i )} * ( 1 - {μ}^{( i )} ( t ) ) for i = 1 , … S$$

$$25 : {J}_{t} ← {J}^{{A}_{t}} + {J}^{{B}_{t}} + {J}_{t}^{T}$$

$$26 : {η}^{( i )} ( t ) ← {η}^{( i )} ( t - 1 ) + {Δη}^{( i )} ( t - 1 )$$

$$27 : η ( t ) ← {\sum }_{i} {η}^{( i )} ( t )$$

$$28 : {E}_{t}^{( i )} ← {η}^{( i )} ( t ) * {J}_{t}$$

$$29 : {C}_{t}^{( i )} ← ( 1 - {η}^{( i )} ( t ) ) * {J}_{t}^{( i )} + {T}^{{C}^{( i )}}$$

$$30 : {T}_{t}^{BC} ← {T}_{t}^{C} * {p}^{T} ( {B}_{t} )$$

$$31 : {J}^{BCN} ( t ) ← ( 1 - η ( t ) ) * {J}_{t}^{{B}_{t}}$$

$$32 : {J}^{BN} ( t ) ← η ( t ) * {J}_{t}^{B}$$

$$33 : Φ ( {B}_{t} ) ← m * ( {T}^{BC} ( t ) + {T}^{BCN} ( t ) + {T}^{BN} ( t ) + {J}^{BCN} ( t ) + {J}^{BN} ( t ) ) where m = 2$$

$$34 : Φ ( {B}_{t} ) ← \sum Φ ( {B}_{t} )$$

$$35 : P ( {v}_{t} ) ← Input pricing ( cost , and savings )$$

$$36 : P ( {B}_{t} ) ← n * Φ ( {B}_{t} ) where n = 1.5$$

$$37 : P ( {v}_{i}^{B} ( t ) ) ← P ( {B}_{t} ) - P ( {v}_{i} ( t ) )$$

$$38 : {T}^{BC} ( t ) , {J}^{BCN} ( t ) , {J}^{BN} ( t ) , Φ ( {B}_{t} ) , P ( {v}_{i} ( t ) ) , P ( {B}_{t} ) , P ( {v}_{i}^{B} ( t ) ) ]$$

$$39 : {v}_{t} ← List ( p ( {A}_{t}^{( 1 )} ) , ... , p ( {A}_{t}^{( N )} ) , p ( {B}_{t}^{( 1 )} ) , ... , p ( {B}_{t}^{( M )} )$$

$$40 : {p}^{T} ( {A}_{t}^{( 1 )} ) , ... , {p}^{T} ( {A}_{t}^{( N )} ) , {p}^{T} ( {B}_{t}^{( 1 )} ) , ... , {p}^{T} ( {B}_{t}^{( M )} ) , \\ {p}^{J} ( {A}_{t}^{( 1 )} ) , ... , {p}^{J} ( {A}_{t}^{( N )} ) , {p}^{J} ( {B}_{t}^{( 1 )} ) , ... , {p}^{J} ( {B}_{t}^{( M )} ) , {η}^{( 1 )} ( t ) , ... , \\ {η}^{( S )} ( t ) , {φ}^{( 1 )} ( t ) , ... , {φ}^{( S )} ( t ) , {γ}^{( 1 )} ( t ) , ... , {γ}^{( S )} ( t ) , {μ}^{( 1 )} ( t ) , ... , {μ}^{( S )} ( t ) )$$

$$41 : return {v}_{i}$$

$$42 : end procedure$$

At t=0 we have the above set v0 of parameters and we aim to produce the set of “all” possible candidates vᵢ(1), . . . , vₜ(k) for t=1. We do so by trying “all” possible values for Δp(A), Δp^{T}(A), Δp^{J}(A), Δμ, Δη which we are going to add to the initial parameters obtaining the k new sets of parameters vᵢ(1), . . . , vₜ(k). All the combinations of the 3(N+M−1)+4S parameters can be obtained with a 3(N+M−1)+4S—dimensional grid, that is computed with 3(N+M−1)+4S nested for-loops. The smaller each for-loop step is, the longer it will take to process the algorithm. The following function takes as input the set of parameters chosen for step t=n and returns a table with “all” the possible candidates for the following iteration t=n+1:

Algorithm 2 TABLE OF CANDIDATES v's

Inputs
1: Parameters of the system at time t − 1, changes of parameters at time t, steps
for the for-loops
Steps
1: procedure candidates (Inputs)
2: $block of N + M - 1 nested for - loops for parameters {p}_{i} ( {A}_{t}^{( 1 )} ) , … , {p}_{i} ( {A}_{t}^{( N )} ) , {p}_{i} ( {B}_{t}^{( 1 )} ) , … , {p}_{i} ( {B}_{t}^{( M - 1 )} ) do :$
3: $block of N + M - 1 nested for - loops for parameters {p}_{i}^{J} ( {A}_{t}^{( 1 )} ) , … , {p}_{i}^{J} ( {A}_{t}^{( N )} ) , {p}_{i}^{J} ( {B}_{t}^{( 1 )} ) , … , {p}_{i}^{J} ( {B}_{t}^{( M - 1 )} ) do :$
4: $block of N + M - 1 nested for - loops for parameters {p}_{i}^{T} ( {A}_{t}^{( 1 )} ) , … , {p}_{i}^{J} ( {A}_{t}^{( N )} ) ,$
5: $block of S nested for - loops for parameters {η}_{i}^{( 1 )} ( t ) , … , {η}_{i}^{( S )} ( t ) do :$
6: $block of S nested for - loops for parameters {φ}_{i}^{( 1 )} ( t ) , … , {φ}_{i}^{( S )} ( t ) do :$
7: $block of S nested for - loops for parameters {γ}_{i}^{( 1 )} ( t ) , … , {γ}_{i}^{( S )} ( t ) do :$
5: $block of S nested for - loops for parameters {μ}_{i}^{( 1 )} ( t ) , … , {μ}_{i}^{( S )} ( t ) do :$
9: $New Candidate ← v - evaluation ( T , Z , p ( {A}_{t - 1}^{( 1 )} ) , {p}^{T} ( {A}_{t - 1}^{( 1 )} ) , {p}^{J} ( {A}_{t - 1}^{( 1 )} ) , {η}^{( 1 )} ( t - 1 ) ,$
${μ}^{( 1 )} ( t - 1 ) , Δ p ( {A}_{t}^{( 1 )} ) , Δ {p}^{T} ( {A}_{t}^{( 1 )} ) , Δ {p}^{J} ( {A}_{t}^{( 1 )} ) , Δ {η}^{( 1 )} ( t 1 ) , Δ {μ}^{( 1 )} ( t 1 ) )$
10: end block
11: end block
12: end block
13: end block
14: end block
15: end block
16: end block
17: end procedure

At every iteration t, the choice of a candidate from the table can be made by placing some conditions on the values of the table in such a way that the system reaches the optimal condition as quickly as possible. For example, if for every iteration t we have the constrains:

$$- P ( B ( t ) ) \geq P ( v ( t ) )$$

$$- \vert Φ B ( t ) - Φ ( B ( t - 1 ) \vert is maximized$$

We can also input a given ΔΦ(t), implying Φ to be reduced between two time periods, be it, the current time period and next, or two discrete time periods. Here we may generate the v's, and we want to be able to return a subset of them representing the lowest number of v's that can achieve the ΔΦ(t) reduction specified. Similarly, for the similar given ΔΦ reduction input, the system can also return the smallest summation of P(v) of those v's. The user could specify the lowest sum of P(v) in currency, OR the lowest number (i.e. count) of v's; and they may or may not be unique. Like ΔΦ, the input could be of any parameter, such as Δp(A), Δp^{T}(A), Δp^{J}(A), . . . . Δμ, Δη, etc.

Given the initial set of parameters above, we can produce several possible sets of parameters. For example, for each v in the table, we can derive its time-based savings in currency, say ΔSᵥ(t), or the payback period in time units, the return on investment (ROI) based on ΔSᵥ(t) and P(v), the Internal rate of return (IRR) or calculate net-present value (NPV) etc. of each individual or collective sets of v's.

The next function deletes the candidates that do not satisfy the first condition, then sort the table by Φ, obtaining several good choices for v. Among the good candidates we choose the one with greatest E, and smallest B.

Algorithm 3 PICK CANDIDATE

Inputs
1: Parameters of the system at time t − 1, changes of parameters at time t,
steps for the for-loops
Outputs
1: vᵢ(t) from the table of possible vᵢ(t)'s at time t that satisfies some condi-
tions.
2: $Keep only candidates Φ ( {v}_{i} ( t ) ) of table such that P ( {v}_{i}^{B} ( t ) ) \geq 0$
3: Order the table by increasing Φ(vᵢ(t)), then by decreasing Eₜ, then by
increasing Bₜ
4: chosen ← first row of the table
5: return chosen
6: end procedure
The next function puts together the collection of vᵢ's chosen from the first
to the last iteration.

Algorithm 4 OPTIMIZATION

Inputs
1: Parameters of the system at time t − 1, changes of parameters at time t,
initial parameters p(A₀), p^{J} (A₀), p^{T} (A₀), η(0), μ(0).
Outputs
1: Solution to the Optimization Problem
Steps
1: procedure Solution (Inputs)
2: New Candidate ← v-evaluation (T, Z, p(A₀), p^{T}(A₀), p^{J}(A₀), η(0), μ(0),
Δρ(Aₜ) = 0, Δp^{T} (Aₜ) = 0, Δp^{J} (Aₜ) = 0, Δη(t) = 0, Δμ(t) = 0)
3: sol ← table of candidate v's (T, Z, p(A₀), p^{T} (A₀), p^{J} (A₀), η(0), μ(0),
Δp(Aₜ) = 0, Δp^{T} (Aₜ) = 0, Δp^{J} (Aₜ) = 0, Δη(t) = 0, Δμ(t) = 0, steps for the
for-loops)
4: while condition do
5: Decrease steps for the for-loops
6: $sol ← table of candidate ( T , Z , p ( {A}_{t - 1}^{( i )} ) , {p}^{T} ( {A}_{t - 1}^{( i )} ) , {p}^{J} ( {A}_{t - 1}^{( i )} ) , {η}^{( i )} ( t - 1 ) ,$
${μ}^{( i )} ( t - 1 ) , Δ p ( {A}_{t}^{( i )} ) , Δ {p}^{T} ( {A}_{t}^{( i )} ) , Δ {p}^{J} ( {A}_{t}^{( i )} ) , Δ {η}^{( i )} ( t 1 ) , Δ {μ}^{( i )} ( t 1 ) )$
7: if Number of rows of sol = 0 then
8: condition = FALSE
9: else
10: $Update parameters p ( {A}_{t - 1}^{( i )} ) , {p}^{T} ( {A}_{t - 1}^{( i )} ) , {p}^{J} ( {A}_{t - 1}^{( i )} ) , {η}^{( i )} ( t - 1 ) , {μ}^{( i )} ( t - 1 )$
11: Final solution ← List (Final solution, sol)
12: end if
13: end while
14: return Final solution
15: end procedure

Having thus described various embodiments of the invention, what is claimed as new and desired to be protected by Letters Patent includes the following:

While the methods and systems have been described in connection with specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
determining, by a computing device, based on a target emission, one or more adoption rates associated with one or more resources and a maximum number of potential implementations associated with each resource of the one or more resources;
determining, based on the one or more adoption rates associated with the one or more resources and the maximum number of potential implementations associated with each resource, a number of potential implementations associated with each resource to be implemented;
determining, based on the number of potential implementations associated with each resource, an emission reduction potential per investment associated with each resource and an emission reduction potential per time interval associated with each resource; and
causing, based on the emission reduction potential per investment associated with each resource and the emission reduction potential per time interval associated with each resource, an implementation associated with at least one resource of the one or more resources according to the number of potential implementations associated with the at least one resource.

2. The method of claim 1, further comprising receiving source data comprising data indicative of the one or more adoption rates associated with the one or more resources and the maximum number of potential implementations associated with each resource.

3. The method of claim 2, wherein the source data further comprises data indicative of an estimated emissions reduction per implementation associated with each resource.

4. The method of claim 3, wherein determining, based on the number of potential implementations of each resource to be implemented, the emission reduction potential per investment associated with each resource and the emission reduction potential per time interval associated with each resource comprises:
determining, based on the estimated emissions reduction per implementation of each resource and based on the number of potential implementations of each resource to be implemented, an emissions reduction potential associated with the maximum number of potential implementations associated with each resource; and
determining, based on the emissions reduction potential associated with the maximum number of potential implementations of each resource, the emission reduction potential per investment associated with each resource and the emission reduction potential per time interval associated with each resource.

5. The method of claim 1, wherein the one or more resources comprise one or more of one or more energy resources or one or more non-energy resources.

6. The method of claim 5, wherein the one or more energy resources comprise one or more of a power grid, one or more batteries, one or more wind turbines, one or more solar panels, one or more boilers, or a device controlling consumption.

7. The method of claim 1, wherein the potential implementations associated with each resource comprise one or more of upgrades to a resource in a power system or one or more additions of the resource to a power system.

8. An apparatus comprising:
one or more processors; and
a memory storing processor-executable instructions that, when executed by the one or more processors, cause the apparatus to:
determine, based on a target emission, one or more adoption rates associated with one or more resources and a maximum number of potential implementations associated with each resource of the one or more resources;
determine, based on the one or more adoption rates associated with the one or more resources and the maximum number of potential implementations associated with each resource, a number of potential implementations associated with each resource to be implemented;
determine, based on the number of potential implementations associated with each resource, an emission reduction potential per investment associated with each resource and an emission reduction potential per time interval associated with each resource; and
cause, based on the emission reduction potential per investment associated with each resource and the emission reduction potential per time interval associated with each resource, an implementation associated with at least one resource of the one or more resources according to the number of potential implementations associated with the at least one resource.

9. The apparatus of claim 8, wherein the processor-executable instructions, when executed by the one or more processors, further cause the apparatus to receive source data comprising data indicative of the one or more adoption rates associated with the one or more resources and the maximum number of potential implementations associated with each resource.

10. The apparatus of claim 9, wherein the source data further comprises data indicative of an estimated emissions reduction per implementation associated with each resource.

11. The apparatus of claim 10, wherein the processor-executable instructions that, when executed by the one or more processors, cause the apparatus to determine, based on the number of potential implementations of each resource to be implemented, the emission reduction potential per investment associated with each resource and the emission reduction potential per time interval associated with each resource, further cause the apparatus to:
determine, based on the estimated emissions reduction per implementation of each resource and based on the number of potential implementations of each resource to be implemented, an emissions reduction potential associated with the maximum number of potential implementations associated with each resource; and
determine, based on the emissions reduction potential associated with the maximum number of potential implementations of each resource, the emission reduction potential per investment associated with each resource and the emission reduction potential per time interval associated with each resource.

12. The apparatus of claim 8, wherein the one or more resources comprise one or more of one or more energy resources or one or more non-energy resources.

13. The apparatus of claim 12, wherein the one or more energy resources comprise one or more of a power grid, one or more batteries, one or more wind turbines, one or more solar panels, one or more boilers, or a device controlling consumption.

14. The apparatus of claim 8, wherein the potential implementations associated with each resource comprise one or more of upgrades to a resource in a power system or one or more additions of the resource to a power system.

15. One or more non-transitory computer-readable media storing processor-executable instructions that, when executed by at least one processor cause the at least one processor to:
determine, by a computing device, based on a target emission, one or more adoption rates associated with one or more resources and a maximum number of potential implementations associated with each resource of the one or more resources;
determine, based on the one or more adoption rates associated with the one or more resources and the maximum number of potential implementations associated with each resource, a number of potential implementations associated with each resource to be implemented;
determine, based on the number of potential implementations associated with each resource, an emission reduction potential per investment associated with each resource and an emission reduction potential per time interval associated with each resource; and
cause, based on the emission reduction potential per investment associated with each resource and the emission reduction potential per time interval associated with each resource, an implementation associated with at least one resource of the one or more resources according to the number of potential implementations associated with the at least one resource.

16. The non-transitory computer-readable media of claim 15, wherein the processor-executable instructions, when executed by the at least one processor, further cause the at least one processor to receive source data comprising data indicative of the one or more adoption rates associated with the one or more resources and the maximum number of potential implementations associated with each resource.

17. The non-transitory computer-readable media of claim 16, wherein the source data further comprises data indicative of an estimated emissions reduction per implementation associated with each resource.

18. The non-transitory computer-readable media of claim 17, wherein the processor-executable instructions that, when executed by the at least one processor, cause the at least one processor to determine, based on the number of potential implementations of each resource to be implemented, the emission reduction potential per investment associated with each resource and the emission reduction potential per time interval associated with each resource, further cause the at least one processor to:
determine, based on the estimated emissions reduction per implementation of each resource and based on the number of potential implementations of each resource to be implemented, an emissions reduction potential associated with the maximum number of potential implementations associated with each resource; and
determine, based on the emissions reduction potential associated with the maximum number of potential implementations of each resource, the emission reduction potential per investment associated with each resource and the emission reduction potential per time interval associated with each resource.

19. The non-transitory computer-readable media of claim 15, wherein the one or more resources comprise one or more of one or more energy resources or one or more non-energy resources, wherein the one or more energy resources comprise one or more of a power grid, one or more batteries, one or more wind turbines, one or more solar panels, one or more boilers, or a device controlling consumption.

20. The non-transitory computer-readable media of claim 15, wherein the potential implementations associated with each resource comprise one or more of upgrades to a resource in a power system or one or more additions of the resource to a power system.
